(19) United States
(12) Patent Application Publication
(10) Pub. No.: US 2008/0002561 A1
(43) Pub. Date: Jan. 3, 2008

(54) INFORMATION RECORDING MEDIUM AND DISC APPARATUS

(76) Inventors: Masaaki MATSUMARU, Funabashi-shi (JP); Ryosuke YAMAMOTO, Yokohama-shi (JP); Hideo ANDO, Hino-shi (JP); Naomasa NAKAMURA, Yokohama-shi (JP); Koji TAKAZAWA, Tokyo (JP); Kazuyo UMEZAWA, Yokohama-shi (JP); Seiji MORITA, Yokohama-shi (JP); Noritake OOMACHI, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/767,885

(22) Filed: Jun. 25, 2007

(30) Foreign Application Priority Data
Jun. 30, 2006 (JP) 2006-182460

(51) Int. Cl. G11B 7/24

(52) U.S. Cl. 369/275.4

(57) ABSTRACT

According to one embodiment, in an information recording medium in which letting H1 (nm) a groove depth of a first substrate on which a first recording layer is formed, H2 (nm) a groove depth of a second substrate on which a second recording layer is formed, H11 (nm) a thickness of a first dye layer at a land area, H12 (nm) a thickness of the first dye layer at a groove bottom area, H21 (nm) a thickness of a second dye layer at a land area, and H22 (nm) a thickness of the second dye layer at a groove bottom area, the groove depth H1 of the first substrate and the groove depth H2 of the second substrate satisfy |H11−H12|=α, |H21−H22|=β, λ/8n≦H1−α≦λ/3n, and λ/8n≦H2−β≦λ/3n.

### CROSS-REFERENCE TO RELATED APPLICATIONS

This application is based upon and claims the benefit of priority from Japanese Patent Application No. 2006-182460, filed Jun. 30, 2006, the entire contents of which are incorporated herein by reference.

### BACKGROUND

1. Field

One embodiment of the present invention relates to an information recording medium such as a multi-layer optical disc capable of recording/playback of information on a plurality of recording films from the light incidence surface side.

2. Description of the Related Art

As optical discs used as information recording media, those of the DVD standard, which allow recording of video and music contents, are popularly used, and read-only optical discs, write-once optical discs capable of information recording only once, rewritable optical discs represented by an external memory of a computer, recording/playback video, and the like, and so forth are available. Of the optical discs capable of recording, the write-once optical discs using organic dyes in recording layers are most popular because of their low manufacturing cost. In write-once optical discs using organic dyes in recording layers, a recording area (track) defined by a groove is irradiated with a laser beam to heat a resin substrate to its glass transition point Tg or higher, thereby causing a thermal decomposition of an organic dye film in the groove and producing a negative pressure. Consequently, the resin substrate deforms in the groove to form a recording mark.

For the next-generation optical discs which achieve high-density, high-performance recording/playback compared to the existing optical discs, a blue laser beam having a wavelength of about 405 nm is used as a recording/playback laser beam. The existing optical discs which perform recording/playback using an infrared laser beam or red laser beam use organic dye materials having absorption peaks at wavelengths shorter than the wavelengths (780 and 650 nm) of the recording/playback laser beams. Accordingly, the existing optical discs realize so-called H (High)-to-L (Low) characteristics by which the light reflectance of a recording mark formed by irradiation with a laser beam is lower than that before the laser beam irradiation. By contrast, when performing recording/playback using a blue laser beam, an organic dye material having an absorption peak at a wavelength shorter than the wavelength (405 nm) of the recording/playback laser beam is inferior not only in stability to ultraviolet radiation or the like but also in stability to heat. This poses the problems of the low contrast and resolution of a recording mark. Jpn. Pat. Appln. KOKAI Publication No. 2005-297407 discloses an organic dye material which has an absorption peak of an organic dye compound contained in a recording layer at a wavelength longer than that of a write beam. Upon using this material, an optical disc has so-called L (Low)-to-H (High) characteristics by which the light reflectance of a recording mark becomes higher than that before laser beam irradiation.

The multi-layer structures of information recording media have been studied to further increase the recording capacity. The multi-layer structures are disclosed in The Jpn. Pat. Appln. KOKAI Publication No. 2000-322770 (the first publication of a double-layer RAM by Matsushita). In both the DVD and HD DVD, multi-layer discs having two or more layers suffer deterioration of playback signal quality due to spherical aberrations and leak of a signal from a non-playback layer.

The deterioration factors will be described below.

First, the influence of spherical aberration will be described below. As disclosed in, e.g., Jpn. Pat. Appln. KOKAI Publication Nos. 2005-267849, 2005-100647, 2004-355785, and 2004-87043, the recording/playback optical systems of the above-described DVD and HD DVD are optimally designed to record and play back information on an information recording layer through a 0.6-mm thick substrate. With this structure, it is known that when the value of a distance to the information recording layer is shifted from the optimal value, a beam spot deforms and becomes large due to the influence of the spherical aberration, thus degrading the recording/playback signal quality.

Also, signal leakage (inter-layer crosstalk) from a non-playback layer occurs while playing back information on the information recording layer, thus degrading the recording/playback signal quality. To suppress this leakage, an intermediate layer must have a sufficient thickness. However, when the intermediate layer has a sufficient thickness, the value of the distance to the information recording layer largely shifts from the optimal value, thereby increasing the influence of the spherical aberration. Hence, a read-only DVD (DVD-ROM) is designed to reduce the influence of the spherical aberration at an intermediate position between layers arranged on the front and back sides viewed from the laser beam incidence surface.

The organic dye material is liquid, and forms an information recording layer by coating. In a conventional DVD, the information recording layer thickness in a groove is equal to that of a land. However, in order to attain still higher-density recording, since the track pitch decreases and the groove width becomes smaller, the information recording layer thickness in a groove and that outside the groove have a difference. Therefore, even using a substrate with a groove depth which is designed as is conventionally done, a stable signal cannot be obtained, and signal quality tends to deteriorate, thus posing a new problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic sectional view for explaining an example of the arrangement of a double-layer optical disc according to the first embodiment of the present invention;

FIG. 2 is a schematic sectional view for explaining an example of the arrangement of a double-layer optical disc to which an embodiment of the present invention can be applied;

FIG. 3 is a schematic sectional view for explaining an example of the arrangement of a double-layer optical disc according to the second embodiment of the present invention;

FIG. 4 is a graph representing the measurement results of an on-track level of a playback signal;

FIG. 5 is a graph representing the measurement results of a push-pull signal amplitude;

FIG. 6 is a graph representing the measurement results of SbER;

FIG. 7 is a graph representing the measurement results of an on-track level of a playback signal;

FIG. 8 is a graph representing the measurement results of a push-pull signal amplitude;

FIG. 9 is a graph representing the measurement results of SbER;

FIG. 10 is a graph representing the measurement results of an on-track level of a playback signal;

FIG. 11 is a graph representing the measurement results of a push-pull signal amplitude;

FIG. 12 is a graph representing the measurement results of SbER;

FIG. 13 shows the data structure in an RMD duplication zone RDZ and recording location management zone RMZ in the write-once information storage medium;

FIG. 14 is a block diagram for explaining the structure of one embodiment of an information recording/playback apparatus according to the present invention;

FIG. 15 shows the structure of a border area in the write-once information storage medium;

FIG. 16 shows another structure of a border area in the write-once information storage medium;

FIG. 17 shows the data structure in a control data zone CDZ and R-physical information zone RIZ;

FIG. 18 is an explanatory view of 180° phase modulation in wobble modulation and the NRZ method;

FIGS. 19A, 19B, and 19C are characteristic explanatory views of the shape and dimensions of a recording film;

FIG. 20 is an explanatory view of the wobble address format in the write-once information storage medium;

FIGS. 21A, 21B, 21C, and 21D are comparative explanatory views of wobble sync patterns and the positional relationship in wobble data units;

FIGS. 22A, 22B, 22C, and 22D are explanatory views about the data structure in wobble address information in the write-once information storage medium;

FIG. 23 is a sectional view of a single-sided, double-layer disc according to the second embodiment of the present invention;

FIG. 24 shows the structure of a lead-in area;

FIG. 25 shows the layout of an RMD duplication zone in the data lead-in area;

FIG. 26 shows the data structure of a recording location management zone (L-RMD) in the data lead-in area;

FIG. 27 shows the structure of a PS block of an R-physical format information zone (R-PFIZ) in the data lead-in area;

FIG. 28 shows the configurations of a middle area before and after extension;

FIG. 29 shows the configuration of the middle area before extension;

FIG. 30 shows the configuration of the middle area after extension;

FIG. 31 shows the structure of a lead-out area;

FIG. 32 is an explanatory view of the specification of an optical disc of a B-format;

FIG. 33 shows the configuration of a picket code (error correction block) in the B-format;

FIG. 34 is an explanatory view of a wobble address in the B-format;

FIG. 35 shows the detailed structure of a wobble address by combining the MSK and STW schemes;

FIG. 36 shows an ADIP unit which is a unit of a group of 56 wobbles and expresses 1 bit “0” or “1”;

FIG. 37 shows an ADIP word which includes 83 ADIP units and expresses one address;

FIG. 38 shows an ADIP word;

FIG. 39 shows 15 nibbles included in an ADIP word;

FIG. 40 shows the track structure of the B-format;

FIG. 41 shows the recording frame of the B-format;

FIGS. 42A and 42B show the structure of a recording unit block;

FIG. 43 shows the structure of a data run-in and data run-out;

FIG. 44 shows the data layout associated with a wobble address; and

FIGS. 45A and 45B are explanatory views of a guard 3 area allocated at the end of the data run-out area.

### DETAILED DESCRIPTION

Various embodiments according to the invention will be described hereinafter with reference to the accompanying drawings. In general, according to one embodiment of the invention, there is disclosed an information recording medium in which letting H1 (nm) be a groove depth of a first substrate on which a first recording layer is formed, H2 (nm) be a groove depth of a second substrate on which a second recording layer is formed, H11 (nm) be a thickness of a first dye layer at a land area, H12 (nm) be a thickness of the first dye layer at a groove bottom area, H21 (nm) be a thickness of a second dye layer at a land area, H22 (nm) be a thickness of the second dye layer at a groove bottom area, α be an absolute value of H11−H12, and β be an absolute value of H11−H12, the groove depth H1 of the first substrate and the groove depth H2 of the second substrate satisfy |H11−H12|=α, |H21−H22|=β, λ/8n≦H1−α≦λ/3n, and λ/8n≦H2−β≦λ/3n.

In an information recording medium of the present invention, a data lead-in area, data area, and data lead-out area are allocated in turn from the inner periphery side, a recording management zone that records recording manage data is formed in the data lead-in area, an extended area of the recording management zone is formed in the data area, a recording management data duplication zone that manages the location of the extended area of the recording management zone is formed in the data lead-in area, and a laser beam used, and the relationship between the groove depths of substrates and the thicknesses of dye layers have the following characteristic features.

In the present invention, a laser beam used in recording/playback of information has a wavelength which falls within the range from 390 nm to 420 nm (both inclusive).

Furthermore, the information recording medium of the present invention has a first substrate, first recording layer, second recording layer, and second substrate, on each of which grooves and lands with a concentric or spiral shape are formed, in turn from the light incidence side. The first recording layer has a first dye layer and first reflecting layer from the light incidence side. The second recording layer has a second dye layer and second reflecting layer from the light incidence side. The first and second dye layers have light absorbance for the laser beam within the wavelength range. Let H1 (nm) be the groove depth of the first substrate on which the first recording layer is formed, H2 (nm) be the groove depth of the second substrate on which the second recording layer is formed, H11 (nm) be the thickness of the first dye layer at a land area, H12 (nm) be the thickness of the first dye layer at a groove bottom area, H21 (nm) be the thickness of the second recording layer at a land area, H22 (nm) be the thickness of the second recording layer at a groove bottom area, α be the absolute value of H11−H12, and β be the absolute value of H21−H22.

Then, the groove depth H1 of the first substrate and the groove depth H2 of the second substrate satisfy:

|H11−H12|=α. (1)

|H21−H22|=β. (2)

λ/8n≦H1−α≦λ/3n (3)

λ/8n≦H2−β≦λ/3n. (4)

(λ: the laser beam wavelength, n: the refractive index of the substrate)

Assume that the lands and grooves mean that the top area of a convex portion closer to the light incidence side is a land and a concave portion formed between neighboring lands is a groove, of concaves and convexes with a concentric or spiral shape, which are formed on the surface of the first substrate, first recording layer, second recording layer, second substrate, and the like.

As a result of examinations about differences α and β between the dye layer thicknesses at the lands and the groove bottom portions on the first and second recording layers so as to suppress deterioration of recording/playback signal quality due to leak of a signal from a non-playback layer on a write-once, double-layer optical disc using an organic dye material, the present inventors found that it is effective that depths obtained by subtracting the differences α and β between the information recording layer thicknesses from the depth H1 (nm) of the groove formed on the first recording layer and the depth H2 (nm) of the groove formed on the second recording layer fall within the range from λ/8n to λ/3n (λ: the laser beam wavelength, n: the refractive index of the substrate). According to the present invention, deterioration of recording/playback signal quality due to leak of a signal from a non-playback layer on the write-once, double-layer optical disc using an organic dye material is suppressed, thus allowing high-density recording.

One embodiment of the present invention will be described in detail hereinafter with reference to the accompanying drawings.

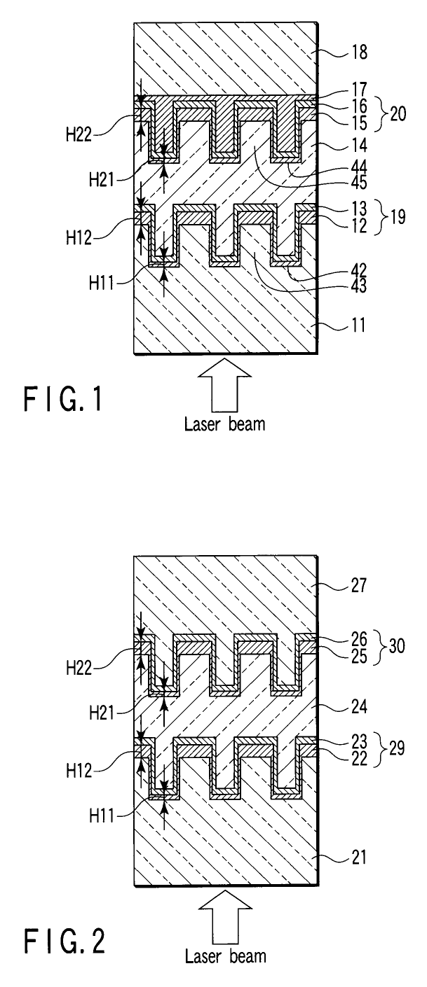

FIG. 1 is a schematic sectional view for explaining an example of the structure of a double-layer disc according to the first embodiment of the present invention.

FIG. 1 shows a state wherein information recording layers are formed on substrates, and both the substrates are adhered.

As shown in FIG. 1, on an optical disc of the present invention, a transparent substrate 11, first dye layer 12, first semitransparent reflecting layer 13, adhesive layer (intermediate layer) 14, second dye layer 15, second reflecting layer 16, second adhesive layer 17, and second transparent substrate 18 are formed in turn from the laser beam incoming side. On the transparent substrate 11 and adhesive layer 14, lands 42 and 44 and grooves 43 and 45 are formed to have a concentric or spiral shape as guide grooves for tracking of a laser beam used in recording/playback of information. The first dye layer 12 and first semitransparent reflecting layer 13, and the second dye layer 15 and second reflecting layer 16 respectively form a first recording layer 19 and second recording layer 20.

As the substrate 11 or 18, a polycarbonate (PC) substrate or glass substrate can be used. In FIG. 1, the depth of the guide groove formed on the first recording layer 19 is assumed to be H1 nm, and that of the guide groove formed on the second recording layer 20 is assumed to be H2 nm. On this optical disc, recording/playback of the first and second recording layers 19 and 20 is made by irradiating a laser beam focused by an objective lens from the transparent substrate 11 side.

FIG. 2 is a schematic sectional view for explaining an example of a double-layer optical disc to which the embodiment of the present invention can be applied. FIG. 2 shows a state wherein information recording layers are formed on substrates, and both the substrates are adhered. As shown in FIG. 2, on the optical disc of the present invention, a transparent substrate 21, first dye layer 22, first semitransparent reflecting layer 23, adhesive layer (intermediate layer) 24, second dye layer 25, second reflecting layer 26, and second transparent layer 27 are formed in turn from the laser beam incoming side. Guide grooves for tracking of a laser beam used in recording/playback of information are formed on the transparent substrates 21 and 27 to have a concentric or spiral shape. As the substrate 21 or 27, a polycarbonate (PC) substrate or glass substrate can be used. The first dye layer 22 and first semitransparent reflecting layer 23, and the second dye layer 25 and second reflecting layer 26 respectively form a first recording layer 29 and second recording layer 30.

In FIG. 2, the depth of the groove formed on the first recording layer 29 is assumed to be H1 nm, and that of the groove formed on the second recording layer 30 is assumed to be H2 nm. On this optical disc, recording/playback of the first and second recording layers is made by irradiating a laser beam focused by an objective lens from the transparent substrate 21 side.

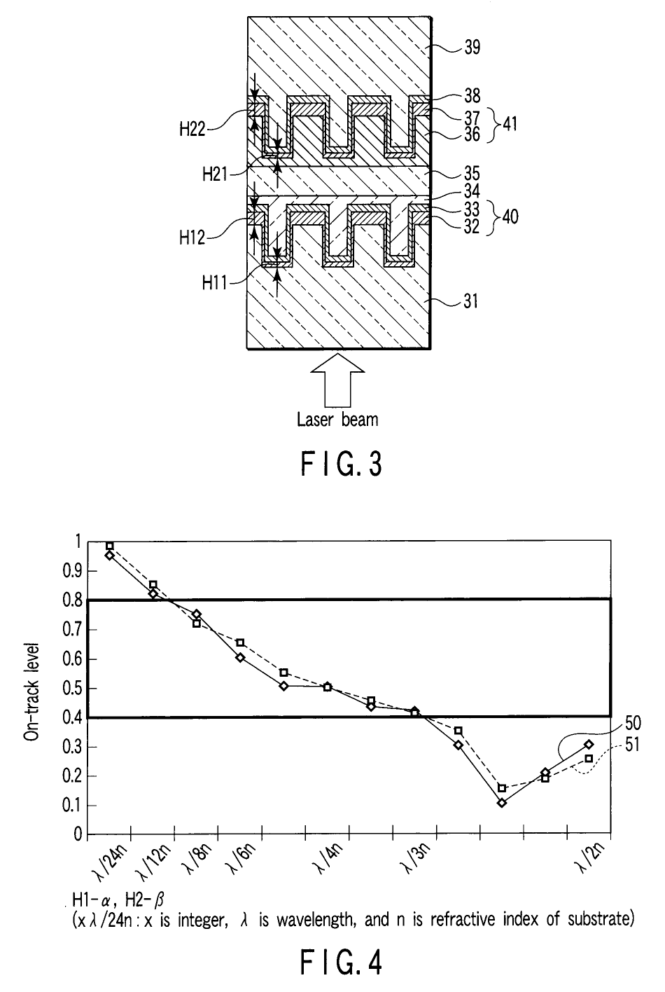

FIG. 3 is a schematic sectional view for explaining an example of the structure of a double-layer optical disc according to the third embodiment of the present invention.

FIG. 3 shows a state wherein information recording layers are formed on substrates, and both the substrates are adhered.

As shown in FIG. 3, on the optical disc of the present invention, a transparent substrate 31, first dye layer 32, first semitransparent reflecting layer 33, protection layer 34, adhesive layer 35, second dye layer 36, second reflecting layer 37, protection layer 38, and second transparent substrate 39 are formed in turn from the laser beam incoming side. The first dye layer 32 and first semitransparent reflecting layer 33, and the second dye layer 36 and second reflecting layer 37 respectively form a first recording layer 40 and second recording layer 41.

Guide grooves for tracking of a laser beam used in recording/playback of information are formed on the transparent substrates 31 and 39 to have a concentric or spiral shape. As the substrate 31 or 39, a polycarbonate (PC) substrate or glass substrate can be used.

In FIG. 3, the depth of the groove formed on the first dye layer 32 is assumed to be H1 nm, and that of the groove formed on the second recording layer 37 is assumed to be H2 nm. On this optical disc, recording/playback of the first and second recording layers is made by irradiating a laser beam focused by an objective lens from the transparent substrate 31 side.

As a dye material for a recording layer, which is used in the first dye layer and second dye layer, an organic dye material having a structure obtained by combining an organic metal complex part expressed by the following structural formula (5) and a dye material part (not shown) can be used.

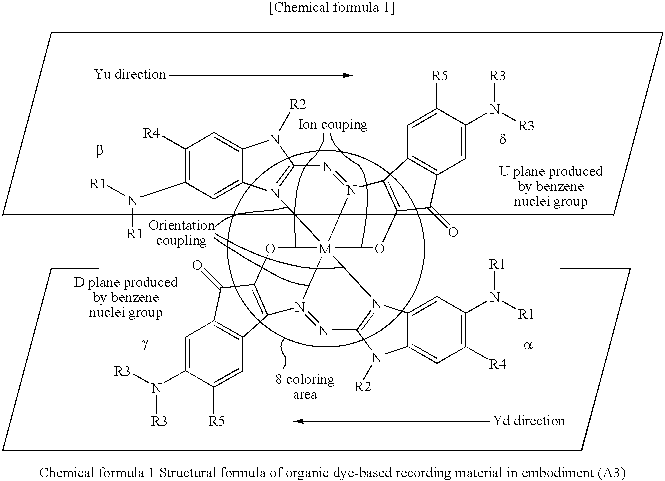

In formula (5), central metal M typically uses cobalt or nickel, and can also be selected from scandium, yttrium, titanium, zirconium, hafnium, vanadium, niobium, tantalum, chromium, molybdenum, tungsten, manganese, technetium, rhenium, iron, ruthenium, osmium, rhodium, iridium, palladium, platinum, copper, silver, gold, zinc, cadmium, mercury, and the like.

As the dye material part, a cyanine dye, styryl dye, monomethinecyanine dye, and azo dye can be used, although not shown.

As the reflecting film, a metal film containing Ag, Au, Cu, Al, Ti, and the like as main components can be used.

In the present invention, the recording/playback signal quality can be improved, and the specification of an H-format (to be described later) can be satisfied in such a manner that the wavelength of a laser beam used in recording/playback of information falls within the range from 390 nm to 420 nm (both inclusive), and as a result of examinations about the depths obtained by subtracting the differences between the land areas and groove bottom areas on the recording layers from the depths of first and second grooves on a write-once, double-layer optical disc using an organic dye material, the depths obtained by subtracting the differences α and β between the thicknesses at the land areas and groove bottom areas on the dye layers from the depth H1 (nm) of the groove on the first substrate on which the first recording layer is formed and the depth H2 (nm) of the groove on the second substrate on which the second recording layer is formed fall within the range from λ/8n to λ/3n (λ: the laser beam wavelength, n: the refractive index of the substrate).

According to one embodiment of the present invention, the thickness of the substrate to be used falls within the range from 580 μm to 600 μm (both inclusive).

According to one embodiment of the present invention, the adhesive layer is further included between the first and second recording layers, and the adhesive layer can have a thickness falling within the range from 20 μm to 35 μm (both inclusive).

If the thickness of the adhesive layer formed between the first and second recording layers is smaller than 20 μm, leak from a non-playback layer tends to worsen; if it is larger than 35 μm, the influence of spherical aberrations on the second layer tends to be stronger.

According to one embodiment of the present invention, the width of grooves formed on the first and second recording layers can fall within the range from 0.1 μm to 0.3 μm (both inclusive).

From the aspect of high-density recording, the effects of the present invention stand out when the grooves are thin in this manner.

Furthermore, according to one embodiment of the present invention, the reflectance from the second recording layer can be 0.8 times to 1.2 times that from the first recording layer.

Also, according to one embodiment of the present invention, the reflectance from the first recording layer and that from the second recording layer can fall within the range from 3% to 10% (both inclusive) with respect to the laser beam which has the wavelength falling within the range from 390 nm to 420 nm (both inclusive).

If the amount of reflected light is lower than 3%, the SN ratio tends to be insufficient on the recording/playback apparatus side. However, if the amount of reflected light exceeds 10%, the amount of light that the recording film can absorb decreases accordingly, and the recording sensitivity tends to drop.

According to another embodiment of the present invention, in order to allow recording on the two recording layers with nearly equal amounts of light, the reflectance can be set to be 10% or less on the optical disc in which the transmittance of the first recording layer falls within the range from 40% to 55%. If the reflectance difference between the playback layer and non-playback layer increases, since leak of a signal from a layer with a higher reflectance to that with a lower reflectance increases, the reflectance difference from the two recording layers can be set to be ±20% or less.

Moreover, according to one embodiment of the present invention, recording can be done on only the land area on the first and second recording layers.

A recording/playback apparatus which performs recording/playback on the write-once, double-layer information recording medium according to the present invention can have a mechanism for identifying the number of layers of an inserted optical disc, a mechanism for focusing on respective layers, and a mechanism for performing recording/playback on the focused information recording layers, in addition to the existing recording/playback apparatus.

Using the aforementioned disc structure and disc manufacturing method, material, and recording/playback apparatus, high playback signal quality can be obtained from the two recording layers on the recordable double-layer disc, thus improving the recording capacity.

The present invention will be described in more detail hereinafter by way of its embodiments.

As evaluation of the recording/playback characteristics, this embodiment uses the result of a Simulated bit Error Rate SbER (reference: Y. Nagai: Jpn. J. Appl. Phys. 42 (203) 971.). The definition and measurement method of the SbER are described in the book available from DVD Format/Logo Licensing: DVD Specifications for High Density Read-Only Disc PART 1 Physical Specifications Version 0.9, Annex H.

### FIRST EMBODIMENT

As shown in FIG. 1, this optical disc comprises a transparent resin substrate 11 which is formed into a disc shape using a synthetic resin material such as, e.g., polycarbonate (PC) or the like. On this transparent resin substrate 11, grooves 43 are formed to have a concentric or spiral shape, and lands 44 are formed between neighboring grooves 43. The transparent resin substrate 11 can be manufactured by injection molding using a stamper. A transparent resin substrate 18 is a dummy substrate on which no grooves having the concentric or spiral shape are formed.

An organic dye layer 12 and semitransparent reflecting layer (reflecting layer) 13 of a first recording layer (L0) are stacked in turn on a 0.59-mm thick transparent resin substrate 11 of polycarbonate or the like, and a photopolymer (2P resin) 14 is applied on the reflecting layer 13 by spin-coating. Then, an organic dye layer 15 and a reflecting film 16 of silver, a silver alloy, or the like of a second recording layer (L1) are stacked in turn on the photopolymer layer 14 by transcribing the groove shape of the second recording layer. Another 0.59-mm thick transparent resin substrate (or dummy substrate) 18 is adhered to the multi-layered structure of the recording layers L0 and L1 via a UV-curing resin (adhesive layer) 17. The thickness of the UV-curing resin layer is set to be 28 μm which is equal to that from the semitransparent reflecting layer (reflecting layer) 13 of the first recording layer (L0) to the organic dye layer 15 of the second recording layer (L1). The organic dye recording films (organic dye layers 12 and 15) have a two-layered structure which sandwiches the semitransparent reflecting layer 13 and intermediate layer 14. The total thickness of the adhered optical disc which is finished in this way is about 1.2 mm.

Spiral-shaped grooves having, e.g., a track pitch of 0.4 μm and a groove width of 0.20 μm are formed on the transparent resin substrate 11 based on the H-format to be described later, and the groove shape of the second recording layer (L1) is formed by transcription. This groove is wobbled, and address information is recorded on wobbles. As the organic dye, the one which had the differences α and β=20 μm between the groove depths and the thicknesses at the groove top and bottom portions on the recording layers was used. For this reason, in consideration of the groove depths and the differences α and β between the thicknesses at the land and groove bottom areas on the organic dye layers, a disc in which the depth obtained by subtracting the difference α between the thickness at the land area and that at the groove bottom portion on the first organic dye layer from the depth H1 of the first organic dye layer was increased in increments of λ/24n within the range from λ/24n to λ/2n nm (n is the refractive index) was fabricated. Also, a disc in which the depth obtained by subtracting the difference β between the thickness at the land area and that at the groove bottom portion on the second organic dye layer from the depth H2 of the second organic dye layer was increased in increments of λ/24n within the range from λ/24n to λ/2n nm (n is the refractive index) was fabricated. Then, the layers 12 and 15 containing an organic dye are formed on the transparent resin substrate 11 to fill its grooves.

As the organic dye which forms the organic dye layers 12 and 15, the one whose maximum absorption wavelength range shifts toward the longer wavelength side from the recording wavelength (e.g., 405 nm) can be used. Also, the organic dye layers are designed to have adequate light absorbance even in that long wavelength range (e.g., 450 nm to 600 nm) in place of extinction of absorbance in the recording wavelength range.

The organic dye (its practical example will be described later) becomes liquid by being dissolved in a solvent, and can be easily applied to the transparent resin substrate surface by spin-coating. In this case, by controlling the dilution ratio by the solvent and the rotational speed upon spin-coating, the film thickness can be managed with high precision.

Upon focusing or tracking on tracks before information recording with a recording laser beam, the light reflectance is low. After that, since a decomposition reaction of the dye occurs by the laser beam, and the light absorbance ratio lowers, the light reflectance of a recording mark portion rises. For this reason, so-called Low-to-High (L to H) characteristics are achieved such that the light reflectance of the recording mark portion formed by irradiation of the laser beam becomes higher than that before laser beam irradiation.

The metal complex part of the organic material for the recording layer is expressed by formula (5) above. In the formula, an illustrated circular surrounding area having central metal M of the azo metal complex as the center corresponds to a coloring area 8. When a laser beam passes through this coloring area 8, localized electrons within this coloring area resonate with a change in magnetic field of the laser beam, and absorb energy of the laser beam. A value obtained by converting the frequency of the change in magnetic field at which the localized electrons resonate most and easily absorb the energy into the wavelength of the laser beam is represented by a maximum absorbance wavelength λmax. The maximum absorbance wavelength λmax shifts toward the longer wavelength side with increasing length of the illustrated coloring area 8 (resonance range). By substituting atoms of central metal M, the localized range of localized electrons near central metal M, i.e., how central metal M can attract the localized electrons to the vicinity of the center, changes, and the value of the maximum absorbance wavelength λmax changes. For example, by selecting a material having λmax near 405 nm, an organic material which has sensitivity (light absorbance) at a wavelength of 405 nm can be obtained.

As a dye material for the recording layer (e.g., L0 or L1) having light absorbance at the wavelength of 405 nm, an organic dye material having a structure obtained by combining the organic metal complex part having the structural formula expressed by formula (5) and the dye material part (not shown) can be used. As the dye material part, a cyanine dye, styryl dye, monomethinecyanine dye, and azo dye can be used, although not shown. Signal evaluation was conducted for the above double-layer disc using an evaluation apparatus which mounted an optical head having a playback wavelength of 405 nm and NA: 0.65.

The on-track level, push-pull signal amplitude, and SbER as the recording/playback characteristics were evaluated under the condition that the disc was rotated at a linear velocity of 6.6 m/s, and the clock frequency was set to be 64.8 MHz.

FIGS. 4, 5, and 6 show the obtained results.

In FIG. 4, the horizontal axis plots the depth obtained by subtracting the difference between the dye layer thickness at a land and that at the groove bottom portion from each groove depth. The vertical axis plots the on-track level upon playback. A mirror part (total reflection level) was set to be 1. Graph 50 represents the measurement values of the first recording layer (L0), and graph 51 represents those of the second recording layer (L1). As indicated by the bold frame in FIG. 4, the on-track level must fall within the range from 0.4 to 0.8 (both inclusive) as the specification of the H-format to be described later, and ranges that meet this specification were λ/8n≦H1−α and H2−β≦λ/3n (λ: the laser beam wavelength, n: the refractive index of the substrate).

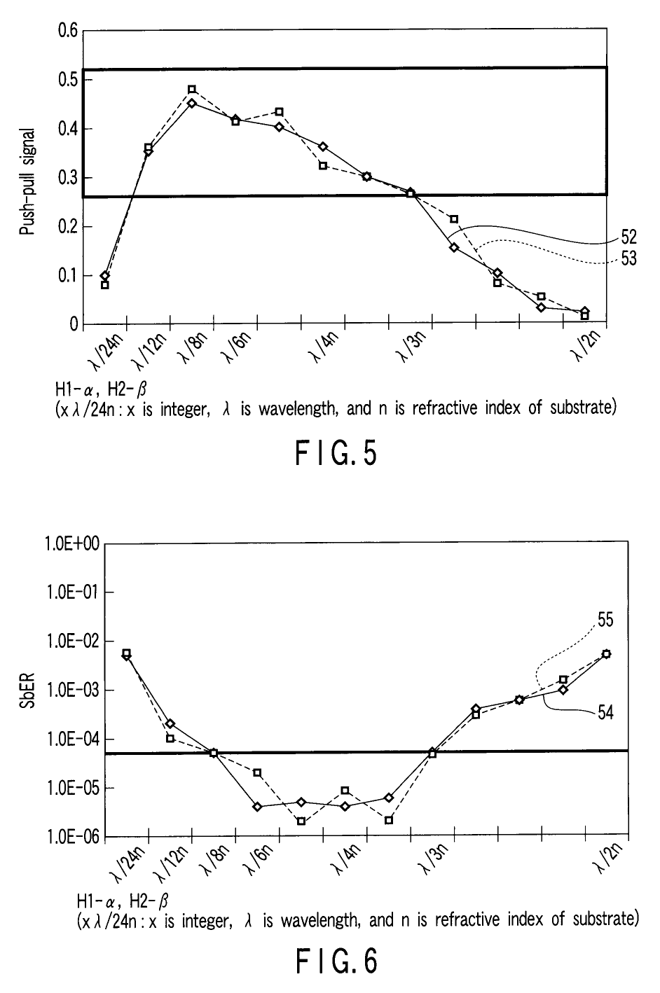

In FIG. 5, the horizontal axis plots the depth obtained by subtracting the difference between the dye layer thickness at a land and that at the groove bottom portion from each groove depth. The vertical axis plots the push-pull signal upon playback which is divided by the total reflection level. Graph 52 represents the measurement values of the first recording layer (L0), and graph 53 represents those of the second recording layer (L1). As indicated by the bold frame in FIG. 5, the push-pull signal must fall within the range from 0.26 to 0.52 (both inclusive) as the specification of the H-format to be described later, and ranges that meet this specification were λ/8n≦H1−α and H2−β≦λ/3n (λ: the laser beam wavelength, n: the refractive index of the substrate).

In FIG. 6, the horizontal axis plots the depth obtained by subtracting the difference between the dye layer thickness at a land and that at the groove bottom portion from each groove depth. The vertical axis plots the error rate SbER upon recording and playing back signals. Graph 54 represents the measurement values of the first recording layer (L0), and graph 55 represents those of the second recording layer (L1). As indicated by the bold frame in FIG. 6, the error rate SbER must be 5×10⁻⁵ or less as the specification of the H-format to be described later, and ranges that meet this specification were λ/8n≦H1−α and H2−β≦λ/3n (λ: the laser beam wavelength, n: the refractive index of the substrate).

With the aforementioned results, the specification can be sufficiently satisfied by setting the depths obtained by subtracting the differences between the dye layer thicknesses at the lands and those at the groove bottom portions from the groove depths to fall within the ranges λ/8n≦H1−α and H2−β≦λ/3n (λ: the laser beam wavelength, n: the refractive index of the substrate). For example, a disc which can sufficiently satisfy the specification can be manufactured even if it adopts a configuration in which the depths obtained by subtracting the differences between the dye layer thicknesses at the lands and those at the groove bottom portions from the groove depths are set to meet H1−α≦H2−β, H1−α=H2−β, and H2−β≦H1−α. Such disc can be stably controlled without posing any problem in terms of the system.

### SECOND EMBODIMENT

FIG. 2 is a schematic sectional view for explaining an example of the structure of an optical disc according to the second embodiment of the present invention. As shown in FIG. 2, this optical disc comprises transparent resin substrates 21 and 27, which are formed in a disc shape using a synthetic resin material such as, e.g., polycarbonate (PC) or the like. Grooves are formed on these transparent resin substrates 21 and 27 to have a concentric or spiral shape. These transparent resin substrates 21 and 27 can be manufactured by injection molding using a stamper.

An organic dye layer 22 and semitransparent reflecting layer (reflecting layer) 23 of a first recording layer (L0) are stacked in turn on a 0.59-mm thick transparent resin substrate 21 of polycarbonate or the like, and a photopolymer (2P resin) 24 is applied on the reflecting layer 23 by spin-coating. Next, a reflecting film 26 of silver, a silver alloy, or the like and an organic dye layer 25 of a second recording layer (L1) are stacked in turn on a 0.59-mm thick transparent resin substrate 27 of polycarbonate or the like. The disc of the second recording layer is set so that the semitransparent reflecting layer (reflecting layer) of the first recording layer (L0) faces the reflecting film of silver, a silver alloy, or the like of the second recording layer (L1), and two discs are adhered by UV-curing the photopolymer (2P resin) 24 applied to the first recording layer (L0) by spin-coating. The thickness of the UV-curing resin is set to be 28 μm which is equal to that from the semitransparent reflecting layer (reflecting layer) 23 of the first recording layer (L0) to the organic dye layer 25 of the second recording layer (L1). The organic dye recording films (organic dye layers 22 and 25) have a two-layered structure which sandwiches the semitransparent reflecting layer 23 and intermediate layer 24. The total thickness of the adhered optical disc which is finished in this way is about 1.2 mm.

Spiral-shaped grooves having, e.g., a track pitch of 0.4 μm and a groove width of 0.20 μm are formed on the transparent resin substrate 21 based on the H-format to be described later, and the groove shape of the second recording layer (L1) is formed by transcription. This groove is wobbled, and address information is recorded on wobbles. As the organic dye, the one which had the differences α and β=20 μm between the groove depths and the thicknesses at the groove top and bottom portions on the recording layers was used. For this reason, in consideration of the groove depths and the differences α and β between the thicknesses at the land and groove bottom portion areas on the organic dye layers, a disc in which the depth obtained by subtracting the difference α between the thickness at the land area and that at the groove bottom portion on the first organic dye layer from the depth H1 of the first organic dye layer was increased in increments of λ/24n within the range from λ/24n to λ/2n nm (n is the refractive index) was fabricated. Also, a disc in which the depth obtained by subtracting the difference β between the thickness at the land area and that at the groove bottom portion on the second organic dye layer from the depth H2 of the second organic dye layer was increased in increments of λ/24n within the range from λ/24n to λ/2n nm (n is the refractive index) was fabricated. Then, the recording layers 29 and 30 containing an organic dye are formed on the transparent resin substrate 21 to fill its grooves.

As the organic dye which forms the organic dye layers 22 and 25, the same material as in the first embodiment can be used, and can be applied and formed in the same manner as in the first embodiment.

Note that this embodiment realizes so-called Low-to-High (L to H) characteristics as in the first embodiment.

Signal evaluation was conducted for the above double-layer disc using an evaluation apparatus which mounted an optical head having a playback wavelength of 405 nm and NA: 0.65. The on-track level, push-pull signal amplitude, and SbER as the recording/playback characteristics were evaluated under the condition that the disc was rotated at a linear velocity of 6.6 m/s, and the clock frequency was set to be 64.8 MHz.

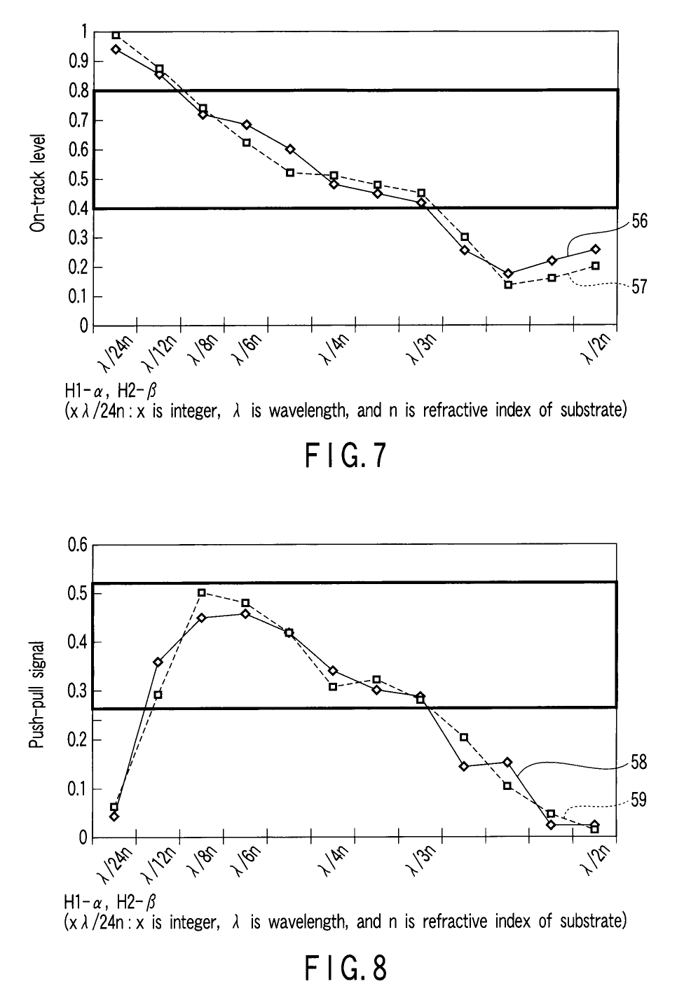

FIGS. 7, 8, and 9 show the obtained results.

In FIG. 7, the horizontal axis plots the depth obtained by subtracting the difference between the dye layer thickness at a land and that at the groove bottom portion from each groove depth. The vertical axis plots the on-track level upon playback. A mirror part (total reflection level) was set to be 1. Graph 56 represents the measurement values of the first recording layer (L0), and graph 57 represents those of the second recording layer (L1). As indicated by the bold frame in FIG. 7, the on-track level must fall within the range from 0.4 to 0.8 (both inclusive) as the specification of the H-format to be described later, and ranges that meet this specification were λ/8n≦H1−α and H2−β≦λ/3n (λ: the laser beam wavelength, n: the refractive index of the substrate).

In FIG. 8, the horizontal axis plots the depth obtained by subtracting the difference between the dye layer thickness at a land and that at the groove bottom portion from each groove depth. The vertical axis plots the push-pull signal upon playback which is divided by the total reflection level. Graph 58 represents the measurement values of the first recording layer (L0), and graph 59 represents those of the second recording layer (L1). As indicated by the bold frame in FIG. 8, the push-pull signal must fall within the range from 0.26 to 0.52 (both inclusive) as the specification of the H-format to be described later, and ranges that meet this specification were λ/8n≦H1−α and H2−β≦λ/3n (λ: the laser beam wavelength, n: the refractive index of the substrate).

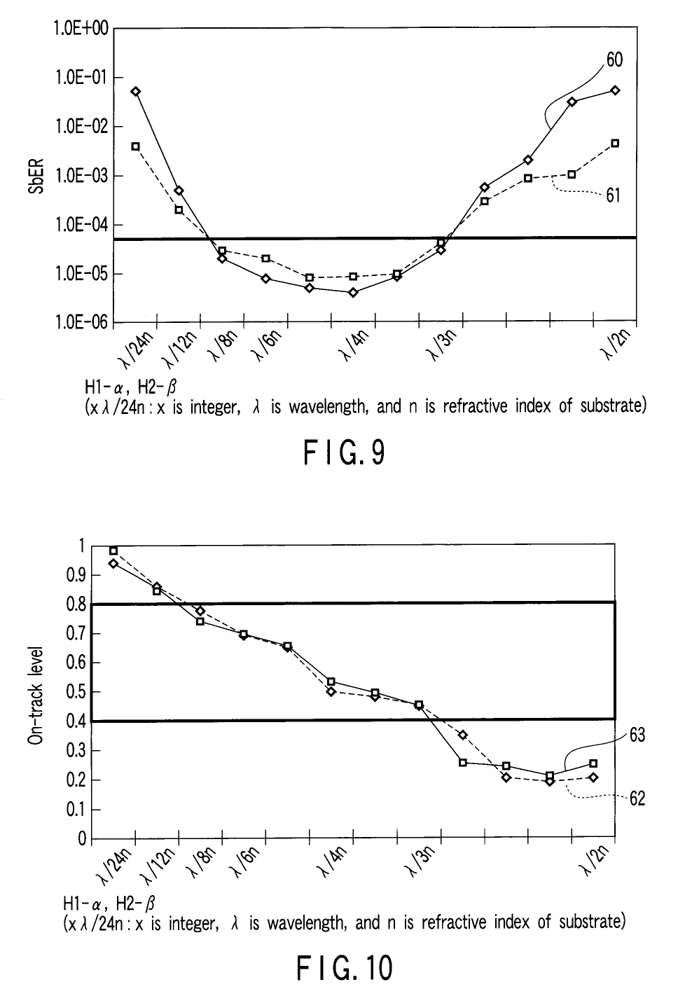

In FIG. 9, the horizontal axis plots the depth obtained by subtracting the difference between the dye layer thickness at a land and that at the groove bottom portion from each groove depth. The vertical axis plots the error rate SbER upon recording and playing back signals. Graph 60 represents the measurement values of the first recording layer (L0), and graph 61 represents those of the second recording layer (L1). As indicated by the bold frame in FIG. 9, the error rate SbER must be 5×10⁻⁵ or less as the specification of the H-format to be described later, and ranges that meet this specification were λ/8n≦H1−α and H2−β≦λ/3n (λ: the laser beam wavelength, n: the refractive index of the substrate).

With the aforementioned results, the specification can be sufficiently satisfied by setting the depths obtained by subtracting the differences between the dye layer thicknesses at the lands and those at the groove bottom portions from the groove depths to fall within the ranges λ/8n≦H1−α and H2−β≦λ/3n (λ: the laser beam wavelength, n: the refractive index of the substrate). For example, a disc which can sufficiently satisfy the specification can be manufactured even if it adopts a configuration in which the depths obtained by subtracting the differences between the dye layer thicknesses at the lands and those at the groove bottom portions from the groove depths are set to meet H1−α≦H2−β, H1−α=H2−β, and H2−β≦H1−α. Such disc can be stably controlled without posing any problem in terms of the system.

### THIRD EMBODIMENT

FIG. 3 is a schematic sectional view for explaining an example of the structure of an optical disc according to the third embodiment of the present invention.

As shown in FIG. 3, this optical disc comprises transparent resin substrates 31 and 39, which are formed in a disc shape using a synthetic resin material such as, e.g., polycarbonate (PC) or the like. Grooves are formed on these transparent resin substrates 31 and 39 to have a concentric or spiral shape. These transparent resin substrates 31 and 39 can be manufactured by injection molding using a stamper.

An organic dye layer 32 and semitransparent reflecting layer (reflecting layer) 33 of a first recording layer (L0) are stacked in turn on a 0.59-mm thick transparent resin substrate 31 of polycarbonate or the like, and a photopolymer (2P resin) 34 is applied by spin-coating and UV-cured on the reflecting layer 33. Next, a reflecting film 38 of silver, a silver alloy, or the like and an organic dye layer 37 of a second recording layer (L1) are stacked in turn on a 0.59-mm thick transparent resin substrate 39 of polycarbonate or the like, and a photopolymer (2P resin) 36 is applied by spin-coating and UV-cured on the organic dye layer 37. A photopolymer (2P resin) 35 is applied by spin-coating on the photopolymer (2P resin) 34 of the first recording layer (L0), which is applied by spin-coating and UV-cured. Discs of the first and second recording layers are set so that the semitransparent reflecting layer (reflecting layer) of the first recording layer (L0) faces the reflecting film of silver, a silver alloy, or the like of the second recording layer (L1), and these discs are adhered by UV-curing the photopolymer (2P resin) 35 applied to the first recording layer (L0) by spin-coating. The thickness of the UV-curing resin is set to be 28 μm which is equal to that from the semitransparent reflecting layer (reflecting layer) 33 of the first recording layer (L0) to the organic dye layer 37 of the second recording layer (L1). The organic dye recording films (organic dye layers 32 and 37) have a two-layered structure which sandwiches the semitransparent reflecting layer 23 and intermediate layer 24. The total thickness of the adhered optical disc which is finished in this way is about 1.2 mm.

Spiral-shaped grooves having, e.g., a track pitch of 0.4 μm and a groove width of 0.20 μm are formed on the transparent resin substrate 31 based on the H-format to be described later, and the groove shape of the second recording layer (L1) is formed by transcription. This groove is wobbled, and address information is recorded on wobbles.

As the organic dye, the one which had the differences α and β=20 μm between the guide groove depths and the thicknesses at the guide groove top and bottom portions on the recording layers was used. For this reason, in consideration of the guide groove depths and the differences α and β between the thicknesses at the guide groove top and bottom portions on the recording layers, a disc in which the depth obtained by subtracting the difference α between the thicknesses at the guide groove top and bottom portions on the recording layer from the depth H1 of a first guide groove was increased in increments of λ/24n within the range from λ/24n to λ/2n nm (n is the refractive index) was fabricated. Also, a disc in which the depth obtained by subtracting the difference P between the thicknesses at the guide groove top and bottom portions on the recording layer from the depth H2 of a second guide groove was increased in increments of λ/24n within the range from λ/24n to λ/2n nm (n is the refractive index) was fabricated. Then, the recording layers 40 and 41 containing an organic dye are formed on the transparent resin substrate 31 to fill its grooves.

As the organic dye which forms the organic dye layers 32 and 37, the same material as in the first embodiment can be used, and can be applied and formed in the same manner as in the first embodiment.

Note that this embodiment realizes so-called Low-to-High (L to H) characteristics as in the first embodiment.

Signal evaluation was conducted for the above double-layer disc using an evaluation apparatus which mounted an optical head having a playback wavelength of 405 nm and NA: 0.65. The on-track level, push-pull signal amplitude, and SbER as the recording/playback characteristics were evaluated under the condition that the disc was rotated at a linear velocity of 6.6 m/s, and the clock frequency was set to be 64.8 MHz.

FIGS. 10, 11, and 12 show the obtained results.

In FIG. 10, the horizontal axis plots the depth obtained by subtracting the difference between the dye layer thickness at a land and that at the groove bottom portion from each groove depth. The vertical axis plots the on-track level upon playback. A mirror part (total reflection level) was set to be 1. Graph 62 represents the measurement values of the first recording layer (L0), and graph 63 represents those of the second recording layer (L1). As indicated by the bold frame in FIG. 10, the on-track level must fall within the range from 0.4 to 0.8 (both inclusive) as the specification of the H-format to be described later, and ranges that meet this specification were λ/8n≦H1−α and H2−β≦λ/3n (λ: the laser beam wavelength, n: the refractive index of the substrate).

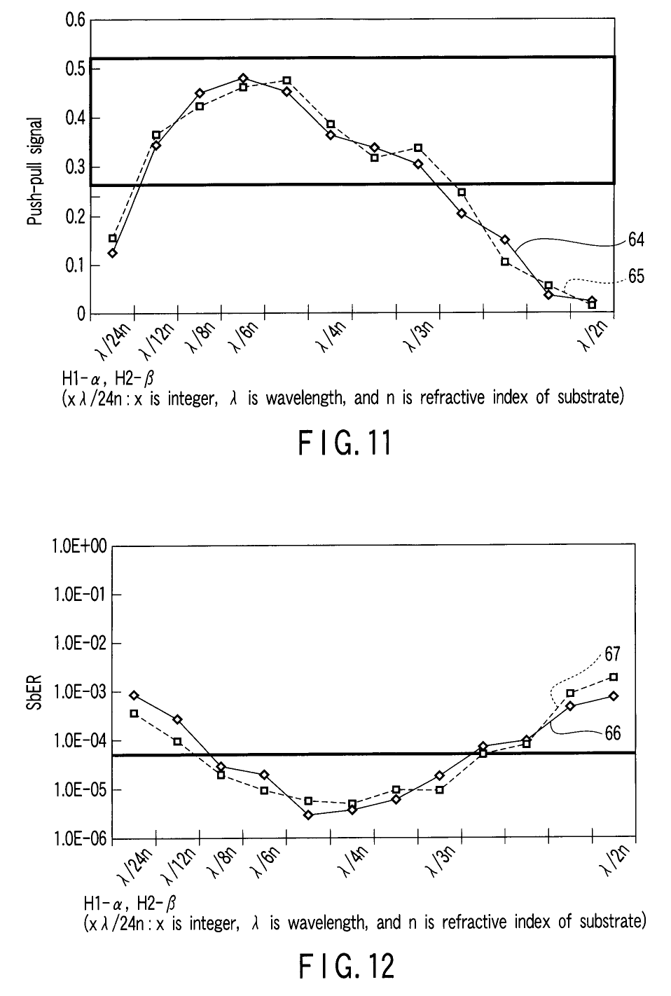

In FIG. 11, the horizontal axis plots the depth obtained by subtracting the difference between the dye layer thickness at a land and that at the groove bottom portion from each groove depth. The vertical axis plots the push-pull signal upon playback which is divided by the total reflection level. Graph 64 represents the measurement values of the first recording layer (L0), and graph 65 represents those of the second recording layer (L1). As indicated by the bold frame in FIG. 11, the push-pull signal must fall within the range from 0.26 to 0.52 (both inclusive) as the specification of the H-format to be described later, and ranges that meet this specification were λ/8n≦H1−α and H2−β≦λ/3n (λ: the laser beam wavelength, n: the refractive index of the substrate).

In FIG. 12, the horizontal axis plots the depth obtained by subtracting the difference between the dye layer thickness at a land and that at the groove bottom portion from each groove depth. The vertical axis plots the error rate SbER upon recording and playing back signals. Graph 66 represents the measurement values of the first recording layer (L0), and graph 67 represents those of the second recording layer (L1). As indicated by the bold frame in FIG. 12, the error rate SbER must be 5×10⁻⁵ or less as the specification of the H-format to be described later, and ranges that meet this specification were λ/8n≦H1−α and H2−β≦λ/3n (λ: the laser beam wavelength, n: the refractive index of the substrate).

With the aforementioned results, the specification can be sufficiently satisfied by setting the depths obtained by subtracting the differences between the dye layer thicknesses at the lands and those at the groove bottom portions from the groove depths to fall within the ranges λ/8n≦H1−α and H2−β≦λ/3n (λ: the laser beam wavelength, n: the refractive index of the substrate). For example, a disc which can sufficiently satisfy the specification can be manufactured even if it adopts a configuration in which the depths obtained by subtracting the differences between the dye layer thicknesses at the lands and those at the groove bottom portions from the groove depths are set to meet H1−α≦H2−β, H1−α=H2−β, and H2−β≦H1−α. Such disc can be stably controlled without posing any problem in terms of the system.

In the above embodiments, the experiments were conducted by applying the H-format to be described later. However, the format of the substrate is not limited to such specific format and, for example, a B-format to be described later may be used.

Examples of the standards that can be applied to the disc of the present invention will be described below.

§H-Format

The first next generation optical disc: HD DVD system (to be referred to as an H-format hereinafter) used in the present invention will be described below.

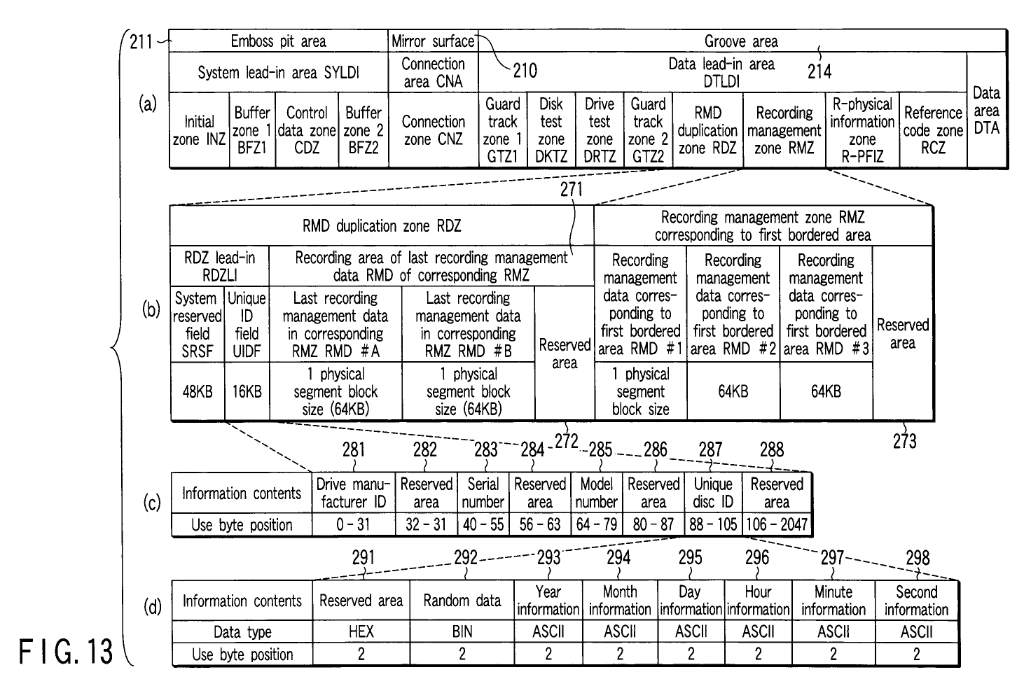

Upon using an “L→H” recording film, a method of forming an embossed pit area 211 as in a system lead-in area SYLDI, as shown in FIG. 13-(a), as the practical contents of a fine uneven shape to be formed in advance in a burst cutting area BCA is available. As another embodiment, a method of forming a groove area 214 or land and groove areas as in a data lead-in area DTLDI and data area DTA is also available. In an embodiment in which the system lead-in area SYLDI and burst cutting area BCA are separately allocated, if the interior of the burst cutting area BCA and the embossed pit area 211 overlap each other, noise components from data formed in the burst cutting area BCA to a playback signal increase due to an unnecessary interference.

Upon forming the groove area 214 or land and groove areas in place of the embossed pit area 211 as an embodiment of the fine uneven shape in the burst cutting area BCA, noise components from data in the burst cutting area BCA to a playback signal due to an unnecessary interference decrease, thus improving the quality of a playback signal.

When the track pitch of the groove area 214 or land and group areas formed in the burst cutting area BCA is adjusted to that of the system lead-in area SYLDI, an effect of improving the manufacturability of information storage media is expected. That is, embossed pits in the system lead-in area are formed by setting a constant motor speed of an exposure unit of a master copy recording apparatus upon manufacturing a master copy of an information storage medium. At this time, by adjusting the track pitch of the groove area 214 or land and groove areas to be formed in the burst cutting area BCA to that of embossed pits in the system lead-in area SYLDI, the motor speed can be successively kept constant between the burst cutting area BCA and system lead-in area SYLDI. Hence, since the speed of the feed motor need not be changed halfway through, a pitch nonuniformity hardly occurs, and the manufacturability of information storage media can be improved.

The recording capacity of a rewritable information storage medium is increased by reducing the track pitch and line density (data bit length) compared to a read-only or write-once information storage medium. As will be described later, a rewritable information storage medium adopts land-groove recording to eliminate the influence of a crosstalk between neighboring tracks, thus reducing the track pitch. All of a read-only information storage medium, write-once information storage medium, and rewritable information storage medium are characterized in that the data bit length and track pitch (corresponding to the recording density) of the system lead-in/system lead-out areas SYLDI/SYLDO are set to be larger than those of data lead-in/data lead-out areas DTLDI/DTLDO (to reduce the recording density).

By approaching the data bit length and track pitch of the system lead-in/system lead-out areas SYLDI/SYLDO to the values of the lead-in area of the existing DVD, compatibility to the existing DVD is assured.

In this embodiment as well, the emboss step in the system lead-in/system lead-out areas SYLDI/SYLDO of the write-once information storage medium is set to be shallow as in the existing DVD-R. This provides an effect of reducing the depth of pre-grooves of the write-once information storage medium and enhancing the degree of modulation of a playback signal from recording marks to be formed on the pre-grooves by additional recording. Conversely, as its counteraction, the following problem is posed. That is, the degree of modulation of a playback signal from the system lead-in/system lead-out areas SYLDI/SYLDO becomes small. To solve this problem, by setting the coarse data bit length (and track pitch) of the system lead-in/system lead-out areas SYLDI/SYLDO to separate (greatly reduce) the repetition frequency of pits and spaces at the narrowest position from the optical cutoff frequency of the MTF (Modulation Transfer Function) of a playback objective lens, the playback signal amplitude from the system lead-in/system lead-out areas SYLDI/SYLDO is raised, thus stabilizing playback.

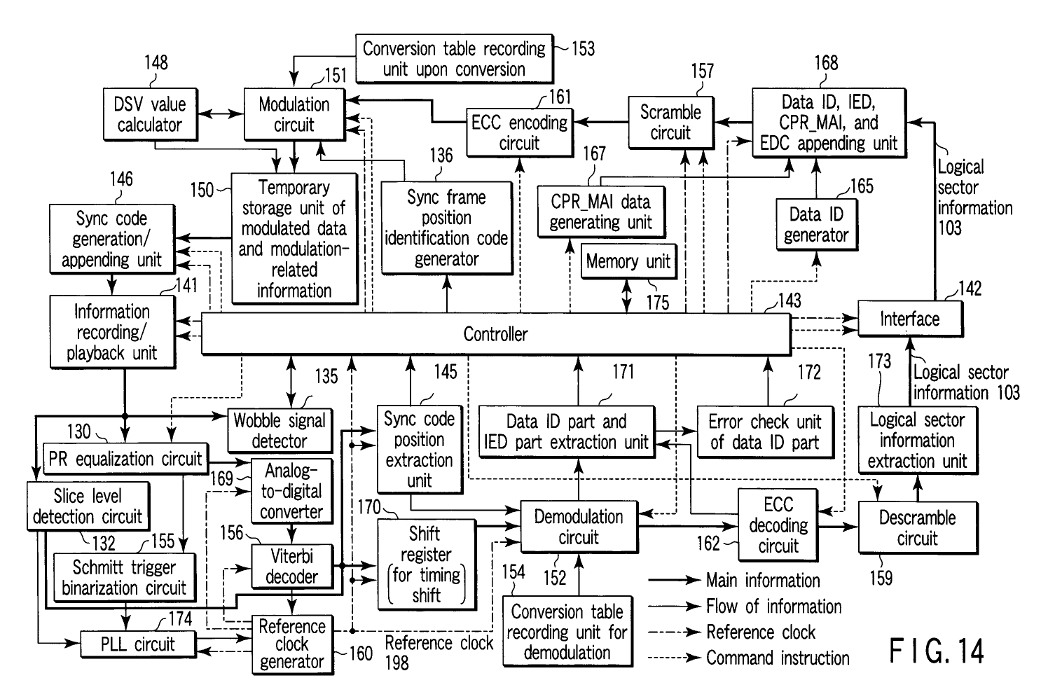

As shown in FIG. 13-(a), an initial zone INZ indicates the start position of the system lead-in area SYLDI. As significant information recorded in the initial zone INZ, a plurality of pieces of data ID (Identification Data) information each including information of a physical sector number PSN (or physical segment number PSN) or logical sector number are discretely allocated. One physical sector records information of a data frame structure including a data ID, IED (ID Error Detection code), main data that records user information, and EDC (Error Detection Code). Also, the initial zone INZ records the information of the data frame structure. However, since all pieces of information of main data that records user information are set to be “00h”, significant information in the initial zone INZ is only the aforementioned data ID information. The current position can be detected from the information of the physical sector number or logical sector number recorded in this zone. That is, when an information recording/playback unit 141 in FIG. 14 starts information playback from an information storage medium, it extracts information of the physical sector number or logical sector number recorded in the data ID information to confirm the current position in the information storage medium, and then moves to a control data zone CDZ.

Each of a buffer zone 1 BFZ1 and buffer zone 2 BFZ2 includes 32 ECC blocks. Since one ECC block is made up of 32 physical sectors, the 32 ECC blocks amount to 1024 physical sectors. In the buffer zone 1 BFZ1 and buffer zone 2 BFZ2, all pieces of information of main data are set to be “00h” as in the initial zone INZ.

A connection zone CNZ which exists in a connection area CNA is used to physically separate the system lead-in area SYLDI and data lead-in area DTLDI, and has a mirror surface on which none of embossed pits and pre-grooves are formed.

A reference code zone RCZ of the read-only information storage medium or write-once information storage medium is used to adjust a playback circuit of a playback apparatus, and records information of the aforementioned data frame structure. The length of a reference code amounts to one ECC block (=32 sectors). The reference code zone RCZ of the read-only information storage medium and write-once information storage medium can be allocated in the neighborhood of the data area DTA. In the structure of the existing DVD-ROM disc or existing DVD-R disc, the control data zone is allocated between the reference code zone and data area, and the reference code zone and data area are distant from each other. When the reference code zone and data area are distant from each other, the following problem is posed. That is, the tilt amount, light reflectance, or the recording sensitivity of the recording film of the information recording medium (in case of the write-once information storage medium) changes slightly, and even when a circuit constant of a playback apparatus is adjusted at the position of the reference code zone, an optimal circuit constant on the data area deviates. To solve this problem, when the reference code zone RCZ is allocated in the neighborhood of the data area DTA, if the circuit constant of the information is optimized in the information playback apparatus, the optimal state is also maintained with the same circuit constant in neighboring data area DTA. In order to accurately play back a signal at an arbitrary location in the data area DTA, signal playback at the target position can be accurately made via steps of:

(1) optimizing the circuit constant of the information playback apparatus in the reference code zone RCZ;

→(2) optimizing the circuit constant of the information playback apparatus again while playing back information in the data area DTA closest to the reference code zone RCZ;

→(3) optimizing the circuit constant once again while playing back information at an intermediate position between the target position in the data area DTA and the position optimized in (2); and

→(4) playing back a signal after movement to the target position.

Guard track zones 1 GTZ1 and 2 GTZ2 which exist in the write-once information storage medium or rewritable information storage medium are used to specify the start boundary position of the data lead-in area DTLDI and those of a disc test zone DKTZ and drive test zone DRTZ, and are specified to inhibit recording by recording mark formation on these zones. Since the guard track zone 1 GTZ1 and guard track zone 2 GTZ2 exist in the data lead-in area DTLDI, a pre-groove area (in the write-once information storage medium) or groove and land areas (in the rewritable information storage medium) are formed in advance in these zones. Since wobble addresses are recorded in advance in the pre-groove area or in the groove and land areas, the current position in the information storage medium is determined using this wobble address.

The disc test zone DKTZ is assured to conduct a quality test (evaluation) by the manufacturer of information storage media.

The drive test zone DRTZ is assured as a zone used to make a trial write before information is recorded on an information storage medium by the information recording/playback apparatus. The information recording/playback apparatus makes a trial write in this zone in advance to detect an optimal recording condition (write strategy), and then can record information in the data area DTA under that optimal recording condition.

Information in a disc identification zone DIZ in the rewritable information storage medium is an optional information recording zone, and can additionally record a drive description including one set of manufacturer name information of the recording/playback apparatus, additional information associated with it, and an area which can be uniquely recorded by the manufacturer for each set.

A defect management zone 1 DMA1 and defect management zone 2 DMA2 in the rewritable information storage medium are zones that record defect management information in the data area DTA, and record substitute location information and the like upon occurrence of defect locations. In addition to the DMA1 and DMA2, DMA management information (DMA Manager1) can be handled together as a defect management zone.

In the write-once information storage medium, an RMD duplication zone RDZ, recording management zone RMZ, and R-physical information zone R-PFIZ independently exist. The recording management zone RMZ records recording management data RMD (to be described in detail later) as management information associated with the recording position of data updated by additional recording processing of data. As will be described later using FIG. 13-(a) and -(b), in this embodiment, the recording management zone RMZ is set in each bordered area BRDA to allow to extend the zone of the recording management zone RMZ. As a result, even when the frequency of additional recording increases, and the number of required recording management data RMD areas increases, they can be coped with by extending the recording management zone RMZ as needed, thus providing an effect of greatly increasing the number of times of additional recording. In this case, in this embodiment, the recording management zone RMZ is allocated in a border in BRDI corresponding to each bordered area BRDA (allocated immediately before each bordered area BRDA). In this embodiment, the border in BRDI corresponding to the first bordered area BRDA#1 and the data lead-in area DTLDI are used commonly to omit formation of the first border in BRDI in the data area DTA, thus promoting effective use of the data area DTA. That is, the recording management zone RMZ in the data lead-in area DTLDI is used as the recording location of the recording management data RMD corresponding to the first bordered area BRDA#1.

The RMD duplication zone RDZ is a zone that records information of recording management data RMD which satisfies the following conditions. Like in this embodiment, by redundantly recording the recording management data RMD, the reliability of the recording management data RMD can be improved. That is, when the recording management data RMD in the recording management zone RMZ cannot be played back due to the influences of dust and scratches attached and formed on the surface of the write-once information storage medium, the recording management data RMD recorded in this RMD duplication zone RDZ is played back, and remaining pieces of necessary information are collected by tracing, thus recovering information of the latest recording management data RMD.

The RMD duplication zone RDZ records the recording management data RMD at the time of closing a border (or a plurality of borders). As will be described later, every time one border is closed and a next, new bordered area is set, a new recording management zone RMZ is defined. Therefore, in other words, every time a new recording management zone RMZ is created, the last recording management data RMD related to the immediately preceding bordered area is recorded in this RMD duplication zone RDZ. Every time the recording management data RMD is additionally recorded on the write-once information storage medium, when the same information is recorded in this RMD duplication zone RDZ, the RMD duplication zone RDZ becomes full of data by a relatively small number of times of additional recording, resulting in a small upper limit value of the number of times of additional recording. By contrast, as in this embodiment, when a new recording management zone is prepared (e.g., when a border is closed or when the recording management zone in the border in BRDI becomes full of data, and a new recording management zone RMZ is formed using an R zone), only the last recording management data RMD in the current recording management zone RMZ is recorded in the RMD duplication zone RDZ, thus effectively using the space of the RMD duplication zone RDZ and increasing the allowable number of times of additional recording.

For example, when the recording management data RMD in the recording management zone RMZ corresponding to the bordered area BRDA during additional recording (before being closed) cannot be played back due to the influences of dust or scratches attached or formed on the surface of the write-once information storage medium, the location of the bordered area BRDA can be determined by reading the last recording management data RMD recorded in this RMD duplication zone RDZ. Therefore, by tracing the remaining space in the data area DTA of the information storage medium, the location of the bordered area BRDA during additional recording (before being closed) and the information contents recorded in that area can be collected, thus recovering information of the latest recording management data RMD.

Information similar to physical format information PFI (to be described in detail later) in the control data zone CDZ is recorded in the R-physical information zone R-PFIZ.

FIG. 13 show the data structure in the RMD duplication zone RDZ and recording management zone RMZ which exist in the write-once information storage medium. FIG. 13-(a) is a view that compares the data structures in the system lead-in area and data lead-in area, and FIG. 13-(b) is an enlarged view of the RMD duplication zone RDZ and recording management zone RMZ in FIG. 13-(a). As described above, the recording management zone RMZ in the data lead-in area DTLDI records data associated with recording position management corresponding to the first bordered area BRDA together in one recording management data RMD, and additionally records new recording management data RMD in turn after the previous recording management data RMD every time the contents of the recording management data RMD generated upon execution of additional recording processing on the write-once information storage medium are updated. That is, the recording management data RMD is recorded to have a size unit of one physical segment block (the physical segment block will be described later), and new recording management data RMD is additionally recorded in turn after the previous recording management data RMD every time the data contents are updated. In the example of FIG. 13-(b), since management data has been changed after recording management data RMD#1 and RMD#2 are recorded in advance, changed (updated) data is recorded as recording management data RMD#3 immediately after the recording management data RMD#2. Therefore, the recording management zone RMZ includes a reserved area 273 that allows further additional recording.

FIG. 13-(b) shows the structure in the recording management zone RMZ which exists in the data lead-in area DTLDI. Also, the structure in the recording management zone RMZ (or an extended recording management zone: to be referred to as an extended RMZ hereinafter) which exists in the border in BRDI or bordered area BRDA (to be described later) is the same as that shown in FIG. 13-(b).

In this embodiment, upon closing the first bordered area BRDA#1 or executing end processing (finalization) of the data area DTA, processing for padding the entire reserved area 273 shown in FIG. 13-(b) with the last recording management data RMD is executed. As a result, the following effects are provided:

(1) the “unrecorded” reserved area 273 disappears, and stable tracking correction based on the DPD (Differential Phase Detection) detection method is guaranteed;

(2) the last recording management data RMD is multiple-recorded on the former reserved area 273, and the reliability upon playback of the last recording management data RMD is greatly improved; and

(3) an accident that inadvertently records different recording management data RMD on the unrecorded reserved area 273 can be prevented.

The above processing method is not limited to the recording management zone RMZ in the data lead-in area DTLDI. In this embodiment, when the corresponding bordered area BRDA is closed or the end processing (finalization) of the data area DTA is executed for the recording management zone RMZ (extended recording management zone: extended RMZ) which exists in the border in BRDI or bordered area BRDA (to be described later), the processing for padding the entire reserved area 273 with the last recording management data RMD is executed.

The RMD duplication zone RDZ is divided into an RDZ lead-in RDZLI and a recording area 271 of the last recording management data RMD of a corresponding RMZ. The RDZ lead-in RDZLI includes a system reserved field SRSF having a data size of 48 KB, and a unique ID field UIDF having a data size of 16 KB, as shown in FIG. 13-(b). The system reserved field SRSF is set with all “00h”.

In this embodiment, an RDZ lead-in RDZLI can be recorded in the data lead-in area DTLDI that allows additional recording. Upon delivery of the write-once information storage medium of this embodiment immediately after the manufacture, the RDZ lead-in RDZLI is unrecorded. An information recording/playback apparatus on the user side records information of the RDZ lead-in RDZLI when this write-once information storage medium is used for the first time. Therefore, by checking whether or not information is recorded in this RDZ lead-in RDZLI immediately after the write-once information storage medium is loaded into the information recording/playback apparatus, whether the target write-once information storage medium is in a state immediately after manufacture/delivery or was used even at least once can be easily determined. Furthermore, as shown in FIG. 13-(a), -(b), the RMD duplication zone RDZ is allocated on the inner periphery side of the recording management zone RMZ corresponding to the first bordered area BRDA, and the RDZ lead-in RDZLI can be allocated in the RMD duplication zone RDZ.

By allocating information indicating whether the write-once information storage medium is in a state immediately after the manufacture/delivery or was used even at least once in the RMD duplication zone RDZ used for a common use purpose (improvement of the reliability of RMD), the use efficiency of information collection can be improved. Also, by allocating the RDZ lead-in RDZLI on the inner periphery side of the recording management zone RMZ, a time required to collect necessary information can be shortened. Upon loading an information storage medium into the information recording/playback apparatus, the information recording/playback apparatus starts playback from the burst cutting area BCA allocated at the innermost periphery side, and changes the playback location to the system lead-in area SYLDI and to the data lead-in area DTLDI while sequentially moving the playback position to the outer periphery side. Then, the apparatus checks if information is recorded in the RDZ lead-in RDZLI in the RMD duplication zone RDZ. Since no recording management data RMD is recorded in the recording management zone RMZ on the write-once information storage medium which is never recorded immediately after the delivery, if no information is recorded in the RDZ lead-in RDZLI, the apparatus determines that “the medium is unused immediately after the delivery”, and can omit playback of the recording management zone RMZ, thus shortening a time required to collect necessary information.

As shown in FIG. 13-(c), the unique ID field UIDF records information associated with an information recording/playback apparatus which used (started recording on) a write-once information storage medium immediately after delivery for the first time. That is, the field UIDF records a drive manufacturer ID 281, serial number 283, and model number 284 of the information recording/playback apparatus. The unique ID field UIDF repetitively records the same 2 KB (accurately 2048 bytes) information shown in FIG. 13-(c) eight times. Information in a unique disc ID 287 records year information 293, month information 294, day information 295, hour information 296, minute information 297, and second information 298 of the first use (start recording), as shown in FIG. 13-(d). The data types of respective pieces of information upon description are HEX, BIN, and ASCII, as shown in FIG. 13-(d), and 2 or 4 bytes are used as the number of used bytes.

The size of the area of this RDZ lead-in RDZLI and that of the one recording management data RMD can be an integer multiple of 64 KB, i.e., the user data size in one ECC block. In case of the write-once information storage medium, processing for rewriting data of the changed ECC block on the information storage medium after data in one ECC block has been changed cannot be executed. Therefore, especially, in case of the write-once information storage medium, recording is done in a recording cluster unit formed of an integer multiple of a data segment including one ECC block. Therefore, if the size of the area of the RDZ lead-in RDZLI and that of the one recording management data RMD are different from the user data size in the ECC block, a padding area or stuffing area is required to adjust these sizes to the recording cluster unit, resulting in a practical recording efficiency drop. By setting the size of the area of the RDZ lead-in RDZLI and that of the one recording management data RMD to be an integer multiple of 64 KB, the recording efficiency drop can be prevented.

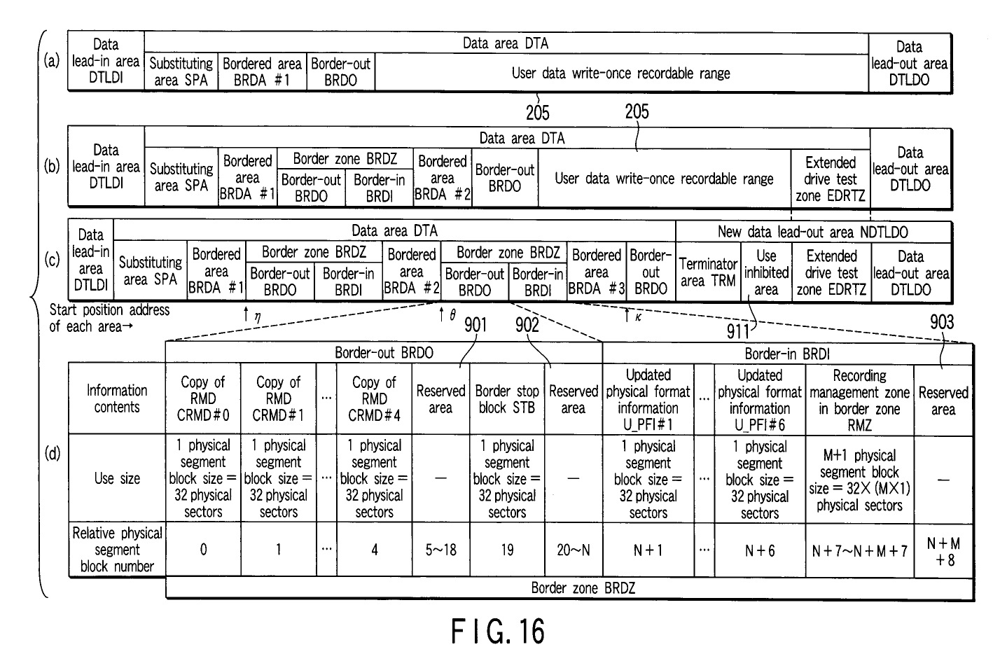

The recording area 271 of the last recording management data RMD of a corresponding RMZ in FIG. 13-(b) will be described below. As described in Japanese Patent No. 2621459, a method of recording intermediate information upon interruption of recording in the lead-in area is available. In this case, every time recording is interrupted or every time additional recording processing is executed, intermediate information (recording management data RMD in this embodiment) must be additionally recorded sequentially in that area. For this reason, the following problem is posed. That is, when recording interruption or additional recording processing is frequently repeated, this area becomes full of data soon, and another additional recording processing is disabled. In order to solve this problem, this embodiment is characterized in that the RMD duplication zone RDZ is set as an area that can record updated recording management data RMD only when a specific condition is met, and decimated recording management data RMD is recorded under the specific condition. In this way, by reducing the frequency of occurrence of recording management data RMD to be additionally recorded in the RMD duplication zone RDZ, there are provided effects of preventing the RMD duplication zone RDZ from being full of data, and greatly increasing the allowable number of times of additional recording for the write-once information storage medium. Parallel to this processing, the recording management data RMD to be updated every additional recording processing is additionally recorded sequentially in the recording management zone RMZ in the border in BRDI shown in FIG. 16-(c) (in the data lead-in area DTLDI shown in FIG. 13-(a) as for the first bordered area BRDA#1) or in the recording management zone RMZ using an R zone to be described later. Upon creating a new recording management zone RMZ (e.g., upon creating a next bordered area BRDA (setting a new border in BRDI), upon setting a new recording management zone RMZ in an R zone, and so forth), the last recording management data RMD (the latest one in a state immediately before the new recording management zone RMZ is created) is recorded in the RMD duplication zone RDZ (the recording area 271 of the last recording management data RMD of a corresponding RMZ in that zone). In this manner, the allowable number of times of additional recording for the write-once information storage medium can be greatly increased, and the latest RMD position search is facilitated using this zone.

This embodiment is characterized in that in any of read-only, write-once, and rewritable information storage media, the system lead-in area is allocated on the opposite side of the data area to sandwich the data lead-in area between them, and the burst cutting area BCA and data lead-in area DTLDI are allocated on the opposite sides to sandwich the system lead-in area SYLDI between them. Upon inserting an information storage medium into an information playback apparatus or information recording/playback apparatus shown in FIG. 14, the information playback apparatus or information recording/playback apparatus executes processing in the order of:

(1) playback of information in the burst cutting area BCA;

→(2) playback of information in the control data zone CDZ in the system lead-in area SYLDI;

→(3) playback of information in the data lead-in area DTLDI (in case of a write-once or rewritable medium)

→(4) re-adjustment (optimization) of the playback circuit constant in the reference code zone RCZ; and

→(5) playback of information recorded in the data area DTA or recording of new information.

Since respective pieces of information are allocated in turn in accordance with the above processing order, the need for unnecessary access processing to the inner periphery side can be obviated, and the data area DTA can be reached by reducing the number of times of access. Therefore, an effect of advancing the start time of playback of information recorded in the data area DTA or recording of new information can be provided. Since signal playback in the system lead-in area SYLDI adopts a slice level detection method and the signal playback in the data lead-in area DTLDI and data area DTA adopts PRML, when the data lead-in area DTLDI and the data area DTA are adjacent to each other and playback progresses in turn from the inner periphery side, stable signal playback can be continuously done by switching from a slice level detection circuit to a PRML detection circuit only once between the system lead-in area SYLDI and data lead-in area DTLDI. For this reason, since the number of times of switching of playback circuits along with the playback procedure is small, the processing control can be facilitated, and the playback start time in the data area can be advanced.

Data recorded in the data lead-out area DTLDO and system lead-out area SYLDO in a read-only information storage medium have a data frame structure (the data frame structure will be described later), and main data values in the data frame structure are set with all “00h”. The read-only information storage medium can use the entire data area DTA as a user data pre-recording area 201. However, as will be described later, in any embodiment of either of the write-once information storage medium and rewritable information storage medium, rewritable/write-once recordable ranges 202 to 205 of user data are narrower than the data area DTA.

In the write-once information storage medium or rewritable information storage medium, a spare area SPA is assured on the innermost periphery side of the data area DTA. When a defect position has occurred in the data area DTA, spare processing is executed using the spare area SPA. In case of the rewritable information storage medium, spare log information (defect management information) is recorded in the defect management zone 1 DMA1, defect management zone 2 DMA2, defect management zone 3 DMA3, and defect management zone 4 DMA4. As defect management information to be recorded in the defect management zone 3 DMA3 and defect management zone 4 DMA4, the same contents as those of information to be recorded in the defect management zone 1 DMA1 and defect management zone 2 DMA2 are recorded. In case of the write-once information storage medium, spare log information (defect management information) upon execution of the spare processing is recorded in copy information C_RMZ of the recording contents in the recording management zone in the data lead-in area DTLDI and a border zone (to be described later). The existing DVD-R disc does not perform any defect management. However, as the number of manufactured DVD-R discs increases, DVD-R discs locally having defect parts start to appear, and a demand for improving the reliability of information to be recorded on the write-once information storage medium is increasing.

The drive test zone DRTZ is assured as a zone where the information recording/playback apparatus makes a trial write prior to recording of information on an information storage medium. The information recording/playback apparatus makes a trial write in this zone to detect an optimal recording condition (write strategy), and can record information in the data area DTA under that optimal recording condition.

The disc test zone DKTZ is assured to conduct a quality test (evaluation) by the manufacturer of information storage media.

In the write-once information storage medium, the drive test zones DRTZ are assured at two positions, i.e., on the inner periphery side and the outer periphery side. The optical recording condition can be sought in detail by finely varying parameters with increasing the number of times of trial write on the drive test zone DRTZ, thus improving the recording precision on the data area DTA. In the rewritable information storage medium, the drive test zone DRTZ is allowed to be reused by overwriting. However, in the write-once information storage medium, the drive test zone DRTZ is used up soon so as to improve the recording precision by increasing the number of times of trial write, thus posing a problem. In order to solve this problem, this embodiment can set extended drive test zones EDRTZ sequentially from the outer peripheral portion along the inner circumferential direction, thus allowing to extend the drive test zones.

This embodiment has the following characteristic features about the method of setting an extended drive test zone and the trial write method in the set extended drive test zone.

1. Extended drive test zones EDRTZ are sequentially set (framed) together from the outer circumferential direction (location closer to the data lead-out area DTLDO) toward the inner periphery side

. . . An extended drive test zone 1 EDRTZ1 is set as a substantial area from a location closest to the outer periphery in the data area (location closest to the data lead-out area DTLDO). After the extended drive test zone 1 EDRTZ1 is used up, an extended drive test zone 2 EDRTZ2 can be set next as a substantial area which exists on the inner periphery side of the zone 1.

2. Trial writes are sequentially made from the inner periphery side in one extended drive test zone EDRTZ

. . . Upon making a trial write in the extended drive test zone EDRTZ, it is done along the groove area 214 allocated in a spiral shape from the inner periphery side to the outer periphery side, and the current trial write is made at an unrecorded location immediate after the (already recorded) location where the previous trial write was made.

The data area has a structure in which additional recording is done along the groove area 214 allocated in a spiral shape from the inner periphery side to the outer periphery side. Since processing of “confirmation of the immediately preceding trial write location”→“execution of the current trial write” can be serially executed by a method of sequentially additionally recording trial write information in the extended drive test zone at a location after the previous trial write location, not only the trial write processing is facilitated, but also management of locations that have already undergone the trial write in the extended drive test zone EDRTZ becomes easy.

3. The data lead-out area DTLDO can be re-set to include the extended drive test zone EDRTZ

. . . A case will be exemplified below wherein in the data area DTA, an extended spare area 1 ESPA1 and extended spare area 2 ESPA2 are set at two locations and the extended drive test zone 1 EDRTZ1 and extended drive test zone 2 EDRTZ2 are set at two locations. In this case, in this embodiment, an area including up to the extended drive test zone 2 EDRTZ2 can be re-set as the data lead-out area DTLDO. The range of the data area DTA is re-set while narrowing down the range in conjunction with this re-setting of the area, and management of the user data write-once recordable range 205 in the data area DTA becomes easy.

The setting location of the extended spare area 1 ESPA1 is considered as an “already used-up extended spare area”, and it is managed that an unrecorded area (an area where a trial write of additional recording can be made) exists in only the extended spare area 2 ESPA2 in the extended drive test zone EDRTZ. In this case, non-defect information which is recorded in the extended spare area 1 ESPA1 and is used as spare information is entirely moved to the location of a non-spare area in the extended spare area 2 ESPA2, thus rewriting defect management information. At this time, the start position information of the re-set data lead-out area DTLDO is recorded in the allocation position information of the latest (updated) data area DTA of RMD field 0 in the recording management data RMD.

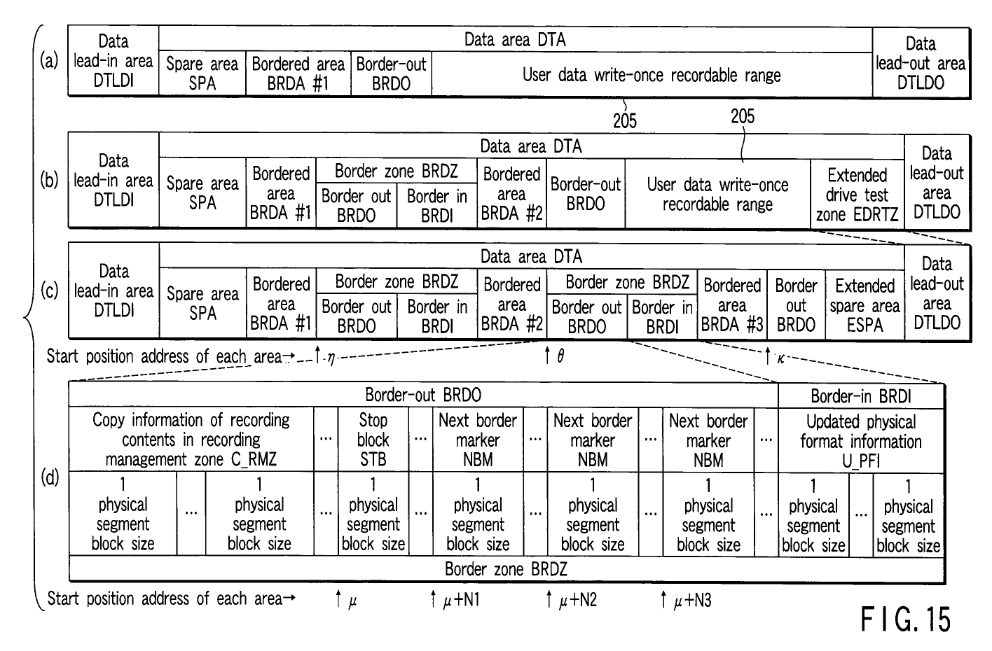

The structure of a border area in the write-once information storage medium will be described below with reference to FIG. 15-(a) to -(d). Upon setting one border area in the write-once information storage medium for the first time, as shown in FIG. 15-(a), a bordered area BRDA#1 is set on the inner periphery side (the side closest to the data lead-in area DTLDI), and a border out BRDO is formed after that area.

Furthermore, when a next bordered area BRDA#2 is to be set, a next border in BRDI (for BRDA#1) is formed after the previous border out BRDO (for BRDA#1), and the next bordered area BRDA#2 is then set, as shown in FIG. 15-(b). When the next bordered area BRDA#2 is to be closed, a border out BRDO (for BRDA#2) is formed immediately after the area BRDA#2. In this embodiment, a state of a pair obtained by forming the next border in BRDI (for BRDA#1) after the previous border out BRDO (for BRDA#1) is called a border zone BRDZ. The border zone BRDZ is set to prevent an optical head from overrunning between respective bordered areas BRDA upon playback by an information playback apparatus (premised on the DPD detection method). Therefore, a dedicated playback apparatus plays back the write-once information storage medium on which information has been recorded under the precondition that the border out BRDO and border in BRDI have already been recorded, and border close processing that records a border out BRDO after the last bordered area BRDA has been executed. The first bordered area BRDA#1 is made up of 4080 or more physical segment blocks, and must have a width of 1.0 mm in the radial direction on the write-once information storage medium. FIG. 15-(b) shows an example in which the extended drive test zone EDRTZ is set in the data area DTA.

FIG. 15-(c) shows a state after the write-once information storage medium has undergone finalization. In the example of FIG. 15-(c), the extended drive test zone EDRTZ is built in the data lead-out area DTLDO, and the extended spare area ESPA has already been set. In this case, the user data write-once recordable range 205 is padded with the last border out BRDO so as not to be left.

FIG. 15-(d) shows the detailed data structure in the aforementioned border zone BRDZ. Each information is recorded to have a size unit of one physical segment block to be described later. At the beginning in the border out BRDO, copy information C_RMZ of the contents recorded in the recording management zone is recorded, and a stop block STB indicating the border out BRDO is recorded. When the next border in BRDI further appears, a first next border marker NBM, a second NBM, and a third NBM, each of which indicates that a border area appears next, are discretely recorded at a total of three locations, i.e., in the “N1-th” physical segment block counted from the physical segment block where the stop block STB is recorded, the “N2-th” physical segment block, and the “N3-th” physical segment block respectively for one physical segment block size.

In the next border in BRDI, updated physical format information U_PFI is recorded. On the existing DVD-R or DVD-RW disc, when no next border area appears (in the last border out BRDO), a location where the “next border mark NBM” shown in FIG. 15-(d) (a location of one physical segment block size) is held as a “location where no data is recorded at all”. When the border area is closed in this state, this write-once information storage medium (existing DVD-R or DVD-RW disc) is ready to be played back by a conventional DVD-ROM drive or conventional DVD player. The conventional DVD-ROM drive or conventional DVD player detects tracking errors based on the DPD (Differential Phase Detection) method by using recording marks recorded on this write-once information storage medium (existing DVD-R or DVD-RW disc). However, since there are no recording marks across one physical segment block size at the “location where no data is recorded at all”, tracking error detection using the DPD (Differential Phase Detection) method cannot be done, and tracking servo cannot be stably applied, thus posing a problem.

As countermeasures against the problem of the existing DVD-R or DVD-RW disc, this embodiment newly adopts a method of:

(1) recording in advance specific pattern data at the “location where the next border mark NBM is to be recorded”, when no next border area appears; and

(2) partially and discretely performing [overwrite processing] of a specific recording pattern at the location of the “next border mark NBM” where the specific pattern data has already been recorded so as to use that pattern as identification information indicating “appearance of the next border area”, when the next border area appears.

By setting the next border mark NBM by overwriting, even when no next border area appears as in (1), recording marks of the specific pattern can be formed in advance at the “location where the next border mark NBM”, and tracking servo can be stably applied even when the dedicated information playback apparatus performs tracking error detection by the DPD method, thus providing a new effect. On the write-once information storage medium, when new recording marks are overwritten even partially on a portion where recording marks have already been formed, there is a problem of disabling of stability of a PLL circuit shown in FIG. 14 in the information recording/playback apparatus or information playback apparatus. As a countermeasure against such problem, this embodiment further newly adopts a method of:

(3) changing an overwrite state depending on the location in a single data segment upon overwriting at the position of the “next border mark NBM” of one physical segment block size;

(4) partially overwriting in sync data 432, and inhibiting overwriting on a sync code 431; and

(5) performing overwriting at a location except for the data ID and IED.

As will be described later, data fields 411 to 418 that record user data and guard fields 441 to 448 are alternately recorded on the information storage medium. Sets of the data fields 411 to 418 and guard fields 441 to 448 are called data segments 490, and one data segment length matches one physical segment block length. The PLL circuit shown in FIG. 14 is easy to especially lead in PLL in VFO fields 471 and 472. Therefore, immediately before the VFO fields 471 and 472, even when PLL is out of phase, the PLL can be easily lead in using the VFO fields 471 and 472, thus eliminating the influence as a whole system in the information recording/playback apparatus or information playback apparatus. Using such state, as described above, since (3) the overwriting state is changed depending on the location in a data segment, and the overwriting amount of the specific pattern on a trailing part near the VFO fields 471 and 472 in the single data segment is increased, discrimination of the “next border mark” is facilitated, and deterioration of the precision of a signal PLL upon playback can be prevented.

One physical sector includes a combination of locations of sync codes 433 (SY0 to SY3) and sync data 434 allocated between the neighboring sync codes 433. The information recording/playback apparatus or information playback apparatus extracts the sync codes 433 (SY0 to SY3) from a channel bit sequence recorded on the information storage medium, and detects a delimiter of the channel bit sequence. As will be described later, the apparatus extracts position information (physical sector number or logical sector number) of data recorded on the information storage medium from information of the data ID. The apparatus then detects an error of the data ID using the IED allocated immediately after the data ID. Therefore, in this embodiment, since (5) overwriting on the data ID and IED is inhibited, and (4) overwriting is partially performed in the sync data 432 except for the sync codes, it is possible to detect the data ID position and to play back (to detect the contents) of information recorded in the data ID using the sync codes 431 even in the “next border mark NBM”.

FIG. 16-(a) to -(d) shows another embodiment different from FIG. 15-(a) to -(d), which is associated with the structure of the border area on the write-once information storage medium. FIG. 16-(a), -(b) shows the same contents as those in FIG. 15-(a), -(b). In FIG. 16-(c), a state after finalization of the write-once information storage medium is different from FIG. 15-(c). For example, as shown in FIG. 16-(c), when finalization is to be executed after completion of information recording in the bordered area BRDA#3, a border out BRDO is formed immediately after the bordered area BRDA#3 as the border close processing. After that, a terminator area TRM is formed after the border out BRDO immediately after the bordered area BRDA#3, thus shortening the time required for finalization.

In the embodiment shown in FIG. 15-(c), an area immediately before the extended spare area ESPA must be padded with the border out BRDO, and a long time is required to form this border out BRDO, thus requiring a long finalization time. By contrast, in the embodiment shown in FIG. 16-(c), the terminator area TRM having a relatively short length is formed, the entire area outside the terminator area TRM is re-defined as a new data lead-out area NDTLDO, and an unrecorded area outside the terminator area TRM is set as a use inhibited area 911. That is, upon finalizing the data area DTA, the terminator area TRM is formed at the end of recording data (immediately after the border out BRDO). By setting the type information of this area to be an attribute of the new data lead-out area NDTLDO, this terminator area TRM is re-defined as the new data lead-out area NDTLDO, as shown in FIG. 16-(c). The type information of this area is recorded in area type information 935 in the data ID, as will be described later. More specifically, by setting the area type information 935 in the data ID in the terminator area TRM to be “10b”, it indicates the presence in the data lead-out area DTLDO. The most characteristic feature of this embodiment lies in that the identification information of the data lead-out position is set using the area type information 935 in the data ID.

A case will be examined below wherein the information recording/playback unit 141 in the information recording/playback apparatus or information playback apparatus shown in FIG. 14 makes a coarse access to a specific target position on the write-once information storage medium. Immediately after the coarse access, the information recording/playback unit 141 must play back the data ID and decode a data frame number 922 so as to detect the location reached on the write-once information storage medium. Since the data ID includes the area type information 935 in the vicinity of the data frame number 922, the access location of the information recording/playback unit 141 in the data lead-out area DTLDO can be immediately detected by simultaneously decoding this area type information 935, thus simplifying and speeding up the access control. As described above, by providing the identification information of the data lead-out area DTLDO by setting information of the terminator area TRM in the data ID, the terminator area TRM can be easily detected.

As an exception, if the last border out BRDO is set as an attribute of the new data lead-out area NDTLDO (i.e., if the area type information 935 in the data ID of a data frame in the border out BRDO is set to be “10b”), the terminator area TRM is not set. Therefore, when the terminator area TRM with the attribute of the new data lead-out area NDTLDO is recorded, since this terminator area TRM is considered as a part of the new data lead-out area NDTLDO, recording onto the data area DTA is disabled, and that area may often remain as the use inhibited area 911, as shown in FIG. 16-(c).

This embodiment shortens the finalization time and improves the processing efficiency by changing the size of the terminator area TRM depending on the position on the write-once information storage medium. This terminator area TRM not only indicates the last position of recording data, but also is used to prevent overrunning due to tracking errors even when it is used in a dedicated playback apparatus used to detect tracking errors by the DPD method. Therefore, as the width of this terminator area TRM in the radial direction on the write-once information storage medium (the width of a part padded with the terminator area TRM), at least a length of 0.05 mm or more is required in terms of the detection characteristics of the dedicated playback apparatus. Since the length of one round on the write-once information storage medium is different depending on the radial position, the number of physical segment blocks included per round differs depending on the radial position. For this reason, the size of the terminator area TRM differs depending on the radial position, i.e., the physical sector number of a first physical sector located in the terminator area TRM, and it becomes larger toward the outer periphery side. A minimum value of an allowable physical sector number of the terminator area TRM must be larger than “04FE00h”. This results from limitation conditions that the first bordered area BRDA#1 must include 4080 or more physical segment blocks, and must have a width of 1.0 mm or more in the radial direction on the write-once information storage medium, as described above. The terminator area TRM must start from the boundary position of a physical segment block.

In FIG. 16-(d), the location where each information is recorded is set for one physical segment block size for the same reason as described above, and user data of a total of 64 KB, which are distributed and recorded in 32 physical sectors, are recorded in one physical segment block. A relative physical segment block number is set for each information, and respective pieces of information are recorded in turn on the write-once information storage medium in ascending order of relative physical segment block number, as shown in FIG. 16-(d). In the embodiment shown in FIG. 16-(d), five pieces of RMD copy information CRMD#0 to CRMD#4 having the same contents are multiple-recorded five times in the copy information recording area C_RMZ of the recording contents in the recording management zone in FIG. 15-(d). By performing multiple-recording in this way, the reliability upon playback can be improved, and even when dust or scratches are attached on the write-once information storage medium, the copy information CRMD of the recording contents in the recording management zone can be stably played back. The stop block STB in FIG. 16-(d) matches that in FIG. 15-(d). However, the embodiment shown in FIG. 16-(d) does not have any next border mark NBM unlike in the embodiment shown in FIG. 15-(d). Information of main data in reserved areas 901 and 902 is set to be all “00h”.

Six pieces of the same information are multiple-recorded six times as the updated physical format information U_PFI at the beginning of the border in BRDI to have relative physical segment block numbers N+1 to N+6, so as to form the updated physical format information U_PFI shown in FIG. 15-(d). By multiple-recording the updated physical format information U_PFI in this way, the reliability of information is improved.

A large characteristic feature of FIG. 16-(d) lies in that the recording management zone RMZ in the border zone is provided in the border in BRDI. As shown in FIG. 13B, when the size of the recording management zone RMZ in the data lead-in area DTLDI is relatively small, and a new bordered area BRDA is frequently repetitively set, recording management data RMD recorded in the recording management zone RMZ is saturated, and it becomes impossible to set a new bordered area BRDA in the middle of recording. As in the embodiment shown in FIG. 16-(d), by forming, in the border in BRDI, the recording management zone that records the recording management data RMD associated with the contents of the bordered area BRDA#3 that follows the border in BRDI, a new bordered area BRDA can be set a large number of times, and the number of times of additional recording in the bordered area can be greatly increased, thus providing new effects. When the bordered area BRDA#3 that follows the border in BRDI which includes the recording management zone RMZ in this border zone is closed, or when the data area DTA is finalized, the last recording management data RMD must be repetitively recorded to pad all the unrecorded reserved areas 273 in the recording management zone RMZ. In this manner, the unrecorded reserved areas 273 are removed to prevent tracking errors (by DPD) upon playback by the dedicated playback apparatus, and the playback reliability of the recording management data RMD can be improved by multiple-recording of the recording management data RMD. All data in a reserved area 903 are set to be “00h”.

The border out BRDO has a role of preventing overrunning due to tracking errors in the dedicated playback apparatus premised on the DPD. However, the border in BRDI need not especially have a large size, except that it has the updated physical format information U_PFI and information of the recording management zone RMZ in the border zone. Therefore, in order to shorten the time (required to record the border zone BRDZ) upon setting a new bordered area BRDA, the size of the border in BRDI is reduced as much as possible. Before formation of the border out BRDO by the border close processing to the state shown in FIG. 16-(a), the user data write-once recordable range 205 is sufficiently broad, and additional recording is more likely to be executed a large number of times. Therefore, a large value “M” in FIG. 16-(d) need be assured to record recording management data a large number of times in the recording management zone RMZ in the border zone. By contrast, in a state before the bordered area BRDA#2 is closed and before the border out BRDO is recorded with respect to the state in FIG. 16-(b), since the user data write-once recordable range 205 is narrowed down, the number of times of additional recording of recording management data to be additionally recorded in the recording management zone RMZ in the border zone RMZ may not become so large. Therefore, a relatively small setting size “M” of the recording management zone RMZ in the border in BRDI allocated immediately before the bordered area BRDA#2 can be set. More specifically, this embodiment provides a characteristic feature that since the expected number of times of additional recording of recording management data is larger when the allocation location of the border in BRDI is on the inner periphery side, and it decreases toward the outer periphery, the size of the border in BRDI is set to be small on the outer periphery side. As a result, the setting time of a new bordered area BRDA can be shortened, and the processing efficiency can be improved.

A logical recording unit of information to be recorded in the bordered area BRDA shown in FIG. 15-(c) is called an R zone. Therefore, one bordered area BRDA includes at least one R zone. The existing DVD-ROM adopts a file system called “UDF bridge” in which file management information compliant to UDF (Universal Disc Format) and that compliant to ISO9660 are simultaneously recorded in one information storage medium. The file management method compliant to ISO9660 has a rule that one file must be continuously recorded in the information storage medium. That is, this file management method inhibits information in one file from being divisionally allocated at discrete positions on the information storage medium. Therefore, when information is recorded in conformity with the UDF bridge, since all pieces of information which form one file are continuously recorded, an area where this one file is continuously recorded may form one R zone.

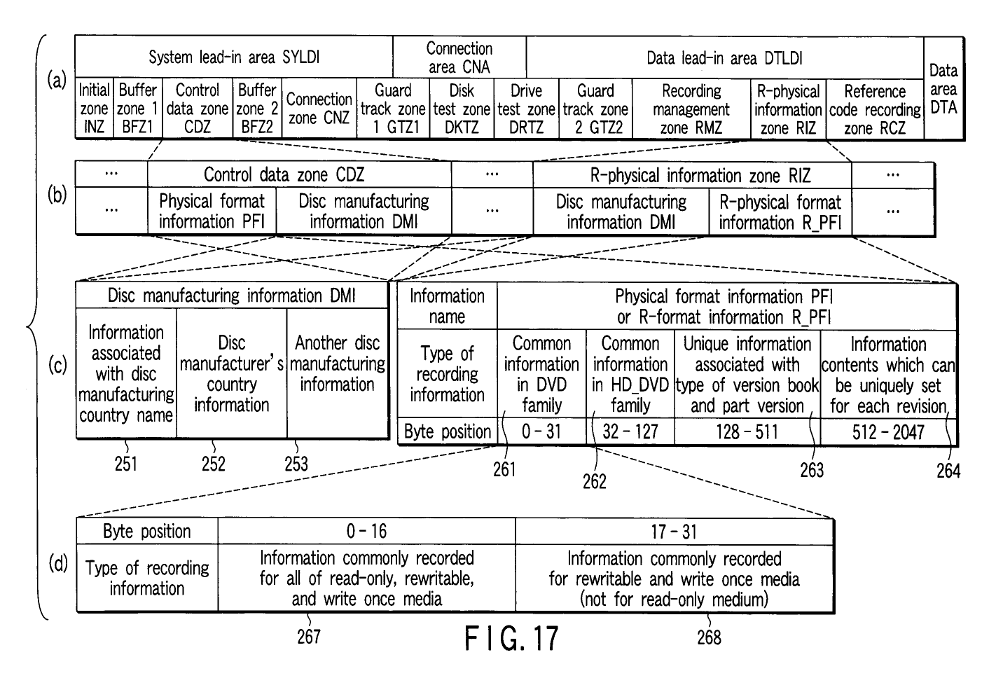

FIG. 17 shows the data structures in the control data zone CDZ and R-physical information zone RIZ. As shown in FIG. 17-(b), the control data zone CDZ includes physical format information PFI, and disc manufacturing information DMI, and the R-physical information zone RIZ includes the same disc manufacturing information DMI and R-physical format information R-PFI.

The disc manufacturing information DMI records information 251 associated with a disc manufacturing country name, and disc manufacturer's country information 252. When sold information storage media infringe a patent, an infringement alert is often issued to a country where the manufacturing site is located or that which consumes (uses) the information storage media. Since each information storage medium is required to record the aforementioned information, the manufacturing site (country name) is determined to facilitate issuance of the patent infringement alert, thus protecting the intellectual properties and promoting the advance in technology. Furthermore, the disc manufacturing information DMI also records another disc manufacturing information 253.

A characteristic feature of this embodiment lies in that the types of information to be recorded are specified depending on the recording locations (the relative byte positions from the head) in the physical format information PFI or R-physical format information R_PFI. More specifically, common information 261 in a DVD family is recorded in a 32-byte area from the 0th byte to the 31st byte as the recording location in the physical format information PFI or R-physical format information R_PFI, and common information 262 in an HD DVD family as the target of this embodiment is recorded in a 96-byte area from the 32nd byte to the 127th byte. Unique information (specific information) 263 associated with the type of version book and part version is recorded in a 384-byte area from the 128th byte to the 511th byte, and information corresponding to each revision is recorded in a 1536-byte area from the 512th byte to the 2047th byte. In this way, by commonizing the information allocation positions in the physical format information based on the information contents, the locations of recorded information can be commonized independently of the types of media. Therefore, the playback processing of the information playback apparatus or information recording/playback apparatus can be commonized and simplified. The common information 261 in the DVD family, which is recorded from the 0th byte to the 31st byte, is further divided into information 267 which is commonly recorded from the 0th byte to the 16th byte for all of the read-only information storage medium, rewritable information storage medium, and write-once information storage medium, and information 268 which is commonly recorded from the 17th byte to the 31st byte for the rewritable information storage medium and write-once information storage medium but is not recorded for the read-only type, as shown in FIG. 17-(d).

The meaning of the specific information 263 of the types of version books and part versions in the 128th byte to the 511th byte and that of the information contents 264 which can be uniquely set for each revision from the 512th byte to the 2047th byte will be described below with reference to FIG. 17-(c). The information contents 264 which can be uniquely set for each revision from the 512th byte to the 2047th byte allow the recorded information contents at respective byte positions to have different meanings in not only the rewritable information storage medium and write-once information storage medium as different types of media but also in media of the same type having different revisions.

A practical implementation method of the information recording/playback apparatus will be described below. The version book or revision book describes both the playback signal characteristics from an “H→L” recording film and those from an “L→H” recording film, and support circuits of two different ways each are prepared in a PR equalization circuit 130 and Viterbi decoder 156 in FIG. 14. When an information storage medium is loaded in the information playback unit 141, a slice level detection circuit 132 used to read information in the system lead-in area SYLDI is started up first. This slice level detection circuit 132 reads polarity information (identification information of “H→L” or “L→H”) of a recording mark recorded at the 192nd byte to determine “H→L” or “L→H”, and the circuits in the PR equalization circuit 130 and Viterbi decoder 156 are then switched in correspondence with the determination result. After that, information recorded in the data lead-in area DTLDI or data area DTA is played back. With the aforementioned method, information in the data lead-in area DTLDI or data area DTA can be read relatively early and accurately. The 17th byte describes revision number information that specifies a highest recording speed, and the 18th byte describes revision number information that specifies a lowest recording speed. However, these two pieces of information are merely range information which specify the highest and lowest speeds. In order to record information most stably, optimal linear velocity information is required upon recording. Hence, this information is recorded at the 193rd byte.

The next most characteristic feature of this embodiment lies in that information of a rim intensity value of an optical system in the circumferential direction at the 194th byte and that of a rim intensity value of the optical system in the radial direction at the 195th byte are allocated as optical system condition information at positions prior to various kinds of recording condition (write strategy) information included in the information contents 264 which can be uniquely set for each revision. These pieces of information mean the condition information of the optical system of an optical head used to determine the recording conditions allocated behind them. The rim intensity means the distribution condition of incident light which strikes an objective lens before being focused on the recording surface of an information storage medium, and is defined by:

[an intensity value at an objective lens peripheral position (pupil plane outer peripheral position) when the central intensity of the incident light intensity distribution is “1”]

The incident light intensity distribution to the object lens has not a point-symmetry distribution but an elliptic distribution, and the information storage medium has different rim intensity values in the radial direction and circumferential direction. Hence, two different values are recorded. Since a beam spot size on the recording surface of the information storage medium becomes smaller with increasing rim intensity value, an optimal recording power condition changes largely depending on this rim intensity value. Since the information recording/playback apparatus knows the rim intensity value information of its own optical head in advance, it reads the rim intensity values of the optical system in the circumferential direction and radial direction, which are recorded in the information storage medium, and compares these values with those of its own optical head. If the comparison results do not have large differences, the apparatus can apply the recording condition recorded behind these values. However, if the comparison results have large differences, the apparatus ignores the recording condition recorded behind these values, and must begin to determine an optimal recording condition by making trial writes by itself using the drive test zone DRTZ.

In this way, the apparatus needs to decide as soon as possible whether it uses the recording condition recorded behind the rim intensity values or ignores that information and begins to determine an optimal recording condition by making trial writes by itself. By allocating the condition information of the optical system used to determine the recommended recording condition at a position prior to the recorded position of the recording condition, the rim intensity information can be read first, and whether or not the recording condition allocated after the rim intensity information can be applied can be determined quickly.

As described above, this embodiment divides the information contents in association with the version book which is issued to change a version in correspondence with a major change of the contents, and with the revision book which is issued to change a revision in correspondence with a minor change such as a recording speed or the like, and can issue only a revision book, only a revision of which is updated every time the recording speed increase. Therefore, since the recording condition in the revision book changes in correspondence with a different revision number, information associated with the recording condition (write strategy) is mainly recorded in the information contents 264 which can be uniquely set for each revision from the 512th byte to 2047th byte.

On the write-once information storage medium, the R-physical format information recorded in the R-physical information zone RIZ in the data lead-in area DTLDI records the start position information of the border zone (the outermost peripheral address of the first border) in addition to the physical format information PFI (a copy of the common information of the HD DVD family). The updated physical format information U_PFI in the border in BRDI shown in FIG. 15-(d) or 16-(d) records updated start position information (the outermost peripheral address of the self border) in addition to the physical format information PFI (a copy of the common information of the HD DVD family). The updated start position information is allocated from the 256th byte to the 263rd byte as a position prior to information (the information contents 264 which can be uniquely set for each revision) associated with the recording condition such as a peak power, bias power 1, and the like as in the start position information of the border zone, i.e., a position after the common information 262 in the DVD family.

As the detailed information contents associated with the start position information of the border zone, the start position information of the border out BRDO which is allocated outside the (current) bordered area BRDA which is currently used is described from the 256th byte to the 259th byte using the physical sector number (PSN) or physical segment number (PSN), and that of the border in BRDI associated with the next bordered area BRDA to be used is described from the 260th byte to the 263rd byte using the physical sector number (PSN) or physical segment number (PSN).

The detailed information contents associated with the updated start position information indicate the latest border zone position information when a new bordered area BRDA is set. That is, the start position information of the border out BRDO which is located outside the (current) bordered area BRDA which is currently used is described from the 256th byte to the 259th byte using the physical sector number (PSN) or physical segment number (PSN), and that of the border in BRDI associated with the next bordered area BRDA to be used is described from the 260th byte to the 263rd byte using the physical sector number (PSN) or physical segment number (PSN). When the next bordered area BRDA is unrecordable, this area (from the 260th byte to the 263rd byte) is padded with all “00h”.

By contrast, the R-physical format information R_PFI on the write-once information storage medium records the last position information of already recorded data in the corresponding bordered area BRDA.

Furthermore, the write-once information storage medium also records the last address information in “layer 0” as a layer on the front side viewed from the playback optical system, and the rewritable information storage medium also records information of difference values of respective pieces of start position information between the land and groove areas.

As shown in FIG. 15-(d), the copy information of the recording management zone RMZ is also recorded in the border out BRDO as the copy information C_RMZ of the recording contents in the recording management zone. In this recording management zone RMZ, as shown in FIG. 13B, recording management data RMD having the same data size as one physical segment block is recorded. Every time the contents of the recording management data RMD are updated, new recording management data RMD can be additionally recorded after that data. The recording management data RMD is further divided into some pieces of fine RMD field information RMDF each having a 2048-byte size. The first 2048 bytes in the recording management data are assured as a reserved area.

In RMD field 0 of the next 2048-byte size, recording management data format code information, medium status information indicating whether the target medium is (1) in an unrecorded state, (2) in the middle of recording before finalization, or (3) after finalization, allocation position information of the data area DTA and that of the latest (updated) data area DTA, and allocation position information of recording management data RMD are sequentially allocated. The allocation position information of the data area DTA records the start position information of the data area DTA and the last position information of a recordable range of user data in an initial state as information indicating an user data write-once recordable range in the initial state.

In the information playback apparatus or information recording/playback apparatus shown in FIG. 14, a wobble signal detector 135 is also used to detect tracking errors using a push-pull signal. A tracking error detection circuit (wobble signal detector 135) can stably perform tracking error detection within the range of 0.1≦(I1−I2)PP/(I1+I2)DC≦0.8 as the value of the push-pull signal (I1−I2)PP/(I1+I2)DC. Especially, this circuit can perform tracking error detection more stably within the range of 0.26≦(I1−I2)PP/(I1+I2)DC≦0.52 for an “H→L” recording film, and within the range of 0.30≦(I1−I2)PP/(I1+I2)DC≦0.60 for an “L→H” recording film.

Therefore, in this embodiment, the push-pull signal specifies the information storage medium characteristics to fall within the range of 0.1≦(I1−I2)PP/(I1+I2)DC≦0.8 (preferably, the range of 0.26≦(I1−I2)PP/(I1+I2)DC≦0.52 for the “H→L” recording film or the range of 0.30≦(I1−I2)PP/(I1+I2)DC≦0.60 for the “L→H” recording film). The above range is specified to hold at both the already recorded location (location where recording marks are formed) and unrecorded location (location where no recording marks are formed) in the data lead-in area DTLDI or data area DTA, and the data lead-out area DTLDO. However, the present invention is not limited to this, and the range may be specified to hold at only the already recorded location (location where recording marks are formed) or at only the unrecorded location (location where no recording marks are formed).

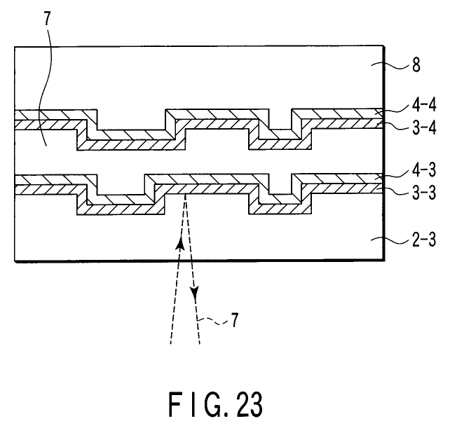

On the write-once information storage medium of this embodiment, since tracking is made on a pre-groove area (since recording marks are formed on the pre-groove area), an on-track signal means a detection signal level upon tracking on the pre-groove area. That is, the on-track information means a signal level (Iot) groove of an unrecorded area upon track loop ON, shown in, e.g., FIG. 23B. However, the present invention does not mean that recording marks can only be formed on the pre-groove area, but recording marks can be formed between neighboring pre-groove areas. In this case, “groove” can be read as “land”.

The R-physical format information R_PFI records the physical sector number (030000h) that represents the start position information of the data area DTA, and also records the physical sector number indicating the last recording location in the last R zone in the corresponding bordered area.

The updated physical format information U_PFI records the physical sector number (030000h) that represents the start position information of the data area DTA, and also records the physical sector number indicating the last recording location in the last R zone in the corresponding bordered area.

These pieces of position information may be described using ECC block address numbers in place of the physical sector numbers as another embodiment. As will be described later, in this embodiment, 32 sectors form one ECC block. Therefore, the lower 5 bits of the physical sector number of a sector which is allocated at the head in a specific ECC block matches the sector number of a sector which is allocated at the head position in a neighboring ECC block. When the physical sector number is set so that the lower 5 bits of the physical sector number of a sector which is located at the head in an ECC block is set to be “00000”, the values of the lower 6th bit or higher of the physical sector numbers of all the sectors included in the identical ECC block match. Therefore, address information obtained by removing the lower 5-bit data of the physical sector number of each sector included in the identical ECC block, and extracting only data of the lower 6th bit or higher is defined as ECC block address information (or ECC block address number). As will be described later, since data segment address information (or physical segment block number information) which is pre-recorded by wobble modulation matches the ECC block address, when the position information in the recording management data RMD is described using the ECC block address number, the following effects can be provided:

(1) access to an unrecorded area is especially speeded up

. . . this is because difference calculation processing is facilitated since the position information unit in the recording management data RMD matches the information unit of the data segment address which is pre-recorded by wobble modulation; and

(2) the management data size in the recording management data RMD can be reduced

. . . this is because the number of bits required to describe the address information can be saved to 5 bits per address. As will be described later, one physical segment block length matches one data segment length, and user data for one ECC block is recorded in one data segment. Therefore, as address expressions, expressions “ECC block address number”, “ECC block address” or “data segment address”, “data segment number”, “physical segment block number”, and the like are used, but they have the meanings of synonyms.

The allocation position information of the recording management data RMD recorded in RMD field 0 records set size information of the recording management zone RMZ that can additionally record this position management data RMD in turn using an ECC block unit or physical segment block unit. As shown in FIG. 13B, since one recording management zone RMD is recorded for each physical segment block, how many updated recording management data RMD can be additionally recorded in the recording management zone RMZ can be determined based on this information. Next, the current recording management data number in the recording management zone RMZ is recorded. This current recording management data number means the number information of recording management data RMD already recorded in the recording management zone RMZ. For example, as an example shown in FIG. 13B, assuming that this information is that in recording management data RMD#2, since this information indicates the second recording management data RMD recorded in the recording management zone RMZ, a value “2” is recorded in this column. Next, remaining size information in the recording management zone RMZ is recorded. This information means information of the number of recording management data RMD which can be further additionally recorded in the recording management zone RMZ, and is described using a physical segment block unit (=ECC block unit=data segment unit). Among these three pieces of information, the relation

[Set size information of RMZ]

=[current recording management data number]

+[remaining size in RMZ]

holds. A characteristic feature of this embodiment lies in that the already used size or remaining size information of the recording management data RMD in the recording management zone RMZ is recorded in the recording zone of the recording management data RMD.

For example, upon recording all pieces of information in one write-once information storage medium, the recording management data RMD need only be recorded only once. However, when information is to be recorded by repeating additional recording of user data very frequently in one write-once information storage medium, the updated recording management data RMD must be additionally recorded for each additional recording. In this case, when the recording management RMD is frequently additionally recorded, the reserved area 273 shown in FIG. 13B is used up, and the information recording/playback apparatus needs to handle it properly. Therefore, by recording the already used size or remaining size information of the recording management data RMD in the recording management zone RMZ in the recording zone of the recording management data RMD, a state that does not allow further additional recording in the recording management zone RMZ can be detected in advance, and the information recording/playback apparatus can take a countermeasure against it earlier.

An example of the processing method in which the information recording/playback apparatus shown in FIG. 14 sets the extended drive test zone EDRTZ (FIG. 16-(b), FIG. 15-(b)) and makes a trial write on that zone will be described below.

(1) A write-once information storage medium is loaded in the information recording/playback apparatus.

→(2) The information recording/playback unit 141 plays back data formed on the burst cutting area BCA, and transfers it to a controller 143. →The controller 143 interprets the transferred information, and checks if the process advances to the next step.

→(3) The information recording/playback unit 141 plays back information recorded in the control data zone CDZ in the system lead-in area SYLDI, and transfers it to the controller 143.

→(4) The controller 143 compares the rim intensity value upon determining the recommended recording condition with that of the optical head used in the information recording/playback unit 141 to determine an area size required to make a trial write.

→(5) The information recording/playback unit 141 plays back information in the recording management data, and transfers it to the controller 143. The controller interprets information in RMD field 4 to check the presence/absence of a margin of the area size required to make a trial write, which is determined in (4). If there is a margin, the process advances to (6); otherwise, the process jumps to (9).

→(6) The current trial write start location is determined from the last position information of the location which has already been used for the trial write in the drive test zone DRTZ or extended drive test zone EDRTZ used in the trial write in RMD field 4.

→(7) A trial write is executed for the size determined in (4) from the location determined in (6).

→(8) Since the number of locations used for the trial write increases as a result of the processing in (7), recording management data RMD in which the last position information of the location which has already used for the trial write is rewritten is temporarily stored in a memory 175, and the process jumps to (12).

→(9) The information recording/playback unit 141 reads information of the “last position of the recordable range 205 of latest user data” recorded in RMD field 0 or “the last position information of the user data write-once recordable range” recorded in the allocation position information of the data area DTA in the physical format information PFI, and the controller 143 further sets the range of a new extended drive test zone EDRTZ to be set.

→(10) The information of “the last position of the recordable range 205 of latest user data” recorded in RMD field 0 based on the result in (9) is updated, and additional set count information of the extended drive test zone EDRTZ in RMD field 4 is incremented by 1 (“1” is added to the count). Furthermore, the recording management data RMD to which the start/end position information of a new extended drive test zone EDRTZ to be set is added is temporarily stored in the memory 175.

→(11) The process shifts→(7)→(12).

→(12) Required user information is additionally recorded in the user data write-once recordable range 205 under an optimal recording condition obtained as a result of the trial write executed in (7).

→(13) The recording management data RMD which is updated by additionally recording the start/end position information in a new R zone which is generated in correspondence with (12) is temporarily stored in the memory 175.

→(14) The controller 143 controls the information recording/playback unit 141 to additionally record the latest recording management data RMD temporarily stored in the memory 175 in the reserved area 273 (e.g., FIG. 13B) in the recording management zone RMZ.

Information of the physical sector number or physical segment number (PSN) which indicates the last recorded position on the write-once information storage medium of this embodiment can be obtained from information in “the last recording management data RMD which is recorded in the recording management zone RMZ which is set last”. That is, since the recording management data RMD includes the end position information (physical sector number) of the n-th “complete R zone” or information of “physical sector number LRA that represents the last recording position in the n-th R zone” described in RMD field 7 or subsequent fields, the physical sector number or physical segment number (PSN) of the last recording location is read from the last recording management data RMD (see RMD#3 in FIG. 13B) recorded in the extended RMZ which is set last, and the last recording location can be detected from the result.

Since the information playback apparatus uses the DPD (Differential Phase Detection) method in place of the push-pull method, it can perform tracking control only on an area where embossed pits or recording marks are formed. For this reason, the information playback apparatus cannot access an unrecorded area of the write-once information storage medium, and cannot play back the contents of the RMD duplication zone RDZ including the unrecorded area. As a result, the information playback apparatus cannot play back the recording management data RMD recorded in that zone. Instead, since the information playback apparatus can play back the physical format information PFI, R-physical information zone R-PFIZ, and updated physical format information UPFI, it can seek the last recording location.

After the information playback apparatus plays back information in the system lead-in area SYLDI, it reads the last position information (information of the “physical sector number indicating the last recording location in the last R zone in the corresponding bordered area” described in Table 1) of already recorded data recorded in the R-physical information zone R-PFIZ. As a result, the information playback apparatus can detect the last location of the bordered area BRDA#1. After the information playback apparatus confirms the position of the border out BRDO allocated immediately after the bordered area BRDA#1, it can read information of the updated physical format information UPFI recorded in the border in BRDI which is recorded immediately after the border out BRDO.

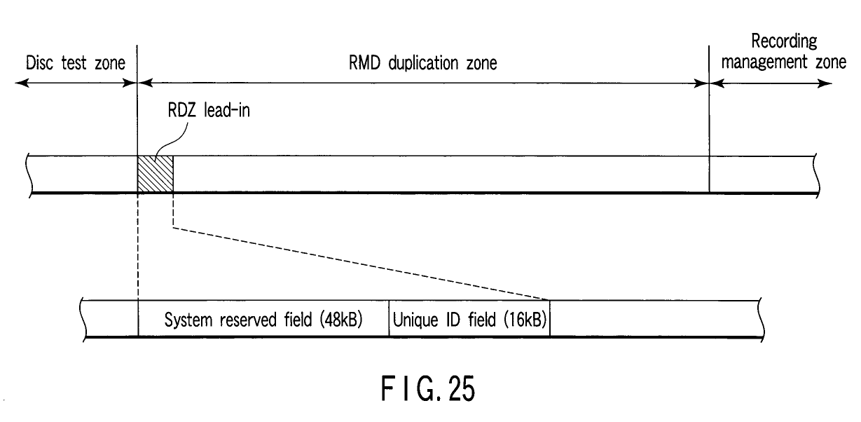

TABLE 1
Contents of allocation location information of data area DTA

| Physical format information PFI | | | | |
|---|---|---|---|---|
| Read-only | Rewritable | | | Updated physical |
| information | information storage | Write-once information | R-physical format | format |
| storage medium | medium | storage medium | information R_PFI | information U_PFI |
| “00h” | “00h” | “00h” | “00h” | “00h” |
| Start position | Start position | Start position | Start position | Start position |
| information of | information of data | information of data | information of | information of |
| data area | area DTA in land | area | data area | data area |
| (Physical sector | area | (Physical sector number | (Physical sector | (Physical sector |
| number or ECC | (Physical sector | or ECC block number) | number) | number) |
| block number) | number or ECC block | | | |
| | number) | | | |
| “00h” | “00h” | “00h” | “00h” | “00h” |
| End position | End position | Last position | Physical sector | Physical sector |
| information of | information of data | information of user | number indicating | number indicating |
| data area | area DTA in land | data write-once | location recorded | location recorded |
| (Physical sector | area | recordable range | last in last R | last in last R |
| number or ECC | (Physical sector | [Position immediately | zone in | zone in |
| block number) | number or ECC block | before ζ point in | corresponding | corresponding |
| | number) | FIG. 25E] | bordered area | bordered area |
| | | (Physical sector number | | |
| | | or ECC block number) | | |
| “00h” | “00h” | “00h” | “00h” | “00” |
| Last address | Difference value | | | |
| information of | between two pieces | | | |
| “layer 0” | of start position | | | |
| (Physical sector | information of land | | | |
| number or ECC | area and groove area | | | |
| block number) | (Physical sector | | | |
| | number or ECC block | | | |
| | number) | | | |

In place of the method of using the “physical sector number indicating the last recording location in the last R zone in the corresponding bordered area” described in Table 1, the start position of the border out BRDO may be accessed using information of “physical sector number PSN indicating the start position of the border zone (as can be seen from FIG. 16-(c), this start position means that of the border out BRDO)”.

Next, the last position of already recorded data is accessed to read the last position information (Table 1) of the already recorded data in the updated physical format information UPFI. Processing for reading “information of the last recorded physical sector number or physical segment number (PSN)” which is recorded in the updated physical format information, and accessing the last recorded physical sector number or physical segment number (PSN) based on the read information is repeated until the last recorded physical sector number PSN in the last R zone is reached. That is, it is checked if the information reading location reached after access is really the position which is recorded last in the last R zone. If the location reached after access is not the last recorded position, the above access processing is repeated. As the R-physical information zone R-PFIZ, the recording position of the updated physical format information UPFI recorded in the border zone (border in BRDI) may be searched using “information of the updated physical sector number or physical segment number (PSN) indicating the start position of the border zone” in the updated physical format information UPFI.

If the position of the last recorded physical sector number (or physical sector number) in the last R zone is found, the information playback apparatus starts playback from the position of the immediately preceding border out BRDO. After that, as shown in ST46, the information playback apparatus reaches the last recorded position while sequentially playing back the contents of the last bordered area BRDA from the head. Then, the apparatus confirms the position of the last border out BRDO. On the write-once information storage medium described in this embodiment, an unrecorded area where no recording marks are recorded continues up to the position of the data lead-out area DTLDO outside the last border out BRDO. The information playback apparatus does not perform tracking on the unrecorded area on the write-once information storage medium, and no information of the physical sector number PSN is recorded there. Hence, it becomes impossible for the information playback apparatus to play back information at a position after the last border out BRDO. For this reason, the apparatus ends the access processing and continuous playback processing when the last border out position is reached.

The update timing of the information contents in the recording management data RMD (update conditions) will be described below using Table 2. There are five different conditions for updating the information of the recording management data RMD.

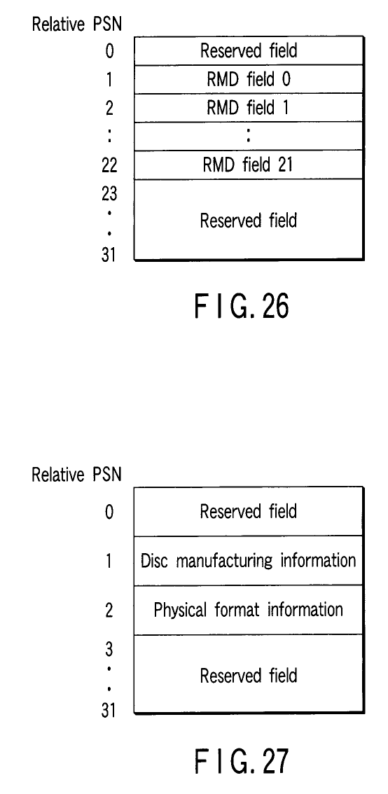

TABLE 2
Update conditions of recording management data RMD

| | |
|---|---|
| 1 | When disk status information in RMD field “0” is changed |
| 2 | When start position information of any one of border-out areas BRDO in RMD field |
| | “3” is changed or when open recording management zone RMZ number is changed |
| 3 | When one of following pieces of information is changed in RMD field “4” |
| | Total number of number of undesignated R zones, number of open R zones, and |
| | number of complete R zones |
| | Number information of first open R zone |
| | Number information of second open R zone |
| 4 | When difference between “physical sector number LRA indicating last recording |
| | position in R zone” recorded in latest recording management data RMD and |
| | “physical sector number PSN of last recorded location which actually exists |
| | currently in R zone” exceeds 8192 *note 1 |
| | . . . RMD is not updated when unrecorded area (reserved area 273 in FIG. 26B) in |
| | recording management zone RMZ is equal to or smaller than four physical |
| | segment blocks (4 × 64 KB) |

note 1 RMD need not be updated during period of series of recording processes on write-once information storage medium

(Condition 1a) When disc status information in RMD field “0” is changed

. . . Note that the update processing of the recording management data RMD is skipped upon recording of a terminator (“termination position information” recorded after (on the outer periphery side) of the last recorded border out BRDO).

(Condition 1b) When an inner or outer test zone address specified in RMD field “1” is changed

(Condition 2) When the start physical sector number of the border-out area BRDO or open (additionally recordable) extended RMZ number specified in RMD field “3” is changed

(Condition 3) When one of the following pieces of information in RMD field “4” is changed

(1) a total of the undesignated RZone number, open RZone number, and complete RZone number or invisible RZone number

(2) the first open RZone number

(3) the second open RZone number

Note that in this embodiment, the RMD need not be updated during a period of a series of information recording operations on the write-once information storage medium such as an HD DVD-R or the like (by a disc drive). For example, upon recording video information, continuous recording must be guaranteed. If the recording management data RMD is updated during recording of video information (if access control is made up to the position of the recording management data RMD to update the recording management data RMD), since recording of the video information is interrupted at that time, the continuous recording cannot be guaranteed. Therefore, it is a common practice to update the RMD after completion of video recording. However, when a series of video information recording operations continue for all too long period, the last recorded location on the write-once information storage medium at the present moment is largely different from the last position information in the recording management data RMD already recorded on the write-once information storage medium. At this time, when the information recording/playback apparatus (disc drive) is forcibly terminated due to any abnormality during continuous recording, a disjunction between the “last position information in the recording management data RMD” and the recording position immediately before forcible termination becomes too large. As a result, data restoration of the “last position information in the recording management data RMD” in correspondence with the recording position immediately before forcible termination after recovery of the information recording/playback apparatus may become difficult to attain. For this reason, this embodiment further adds the following update condition.

(Condition 4) When the difference (the difference “PSN−LRA”) between “physical sector number LRA indicating the last recording position in the R zone” which is recorded in the latest recording management data RMD and the “physical sector number PSN of the last recorded location in the R zone at the present moment”, which changes sequentially during continuous recording exceeds 8192 (information of the recording management data RMD is updated)

. . . Note that updating is skipped when the size of the unrecorded reserved area 273 in the recording management zone RMZ in “(Condition 1b)” or “(Condition 4)” above is equal to or smaller than four physical segment blocks (4×64 KB).

The extended recording management zone will be described below. This embodiment specifies the following three allocation locations of the recording management zone RMZ.

(1) Recording Management Zone RMZ (L-RMZ) in Data Lead-In Area DTLDI

As can be seen from FIG. 16-(b), in this embodiment, a part in the data lead-in area DTLDI commonly uses the border in BRDI corresponding to the first bordered area. For this reason, as shown in FIG. 13-(a), the recording management zone RMZ to be recorded in the border in BRDI corresponding to the first bordered area is set in advance in the data lead-in area DTLDI. The structure in this recording management zone RMZ allows to additionally record position management data RMD sequentially for each 64 KB (one physical segment block size), as shown in FIG. 13B.

(2) Recording Management Zone RMZ (B-RMZ) in Border in BRDI

The write-once information storage medium of this embodiment requires the border close processing before the dedicated playback apparatus plays back recorded information. Upon recording new information after the border close processing, a new bordered area must be set. The border in BRDI is set at a position before this new bordered area BRDA. Since the unrecorded area (reserved area 273 shown in FIG. 13B) in the latest recording management zone is closed in the stage of the border close processing, a new area (recording management zone RMZ) used to record recording management data RMD indicating the position of information recorded in the new bordered area BRDA must be set. A large characteristic feature of this embodiment lies in that the recording management zone RMZ is set in the newly set border in BRDI as shown in FIG. 16-(d). The structure in the recording management zone RMZ in this border zone is the same as that of the “recording management zone RMZ (L-RMZ) corresponding to the first bordered area”. As information in the recording management data RMD recorded in this zone, not only the recording management data associated with data recorded in the corresponding bordered area BRDA but also the recording management information associated with data recorded in the preceding bordered area BRDA is recorded together.

(3) Recording Management Zone RMZ (U-RMZ) in Bordered Area BRDA

The RMZ (B-RMZ) in the border in BRDI in (2) cannot be set unless a new bordered area BRDA is formed. Since the size of the first bordered area management zone RMZ (L-RMZ) is limited, the reserved area 273 is exhausted after repetition of additional recording, and it becomes impossible to additionally record new recording management data RMD. To solve this problem, in this embodiment, a new R zone used to record a recording management zone RMZ in the bordered area BRDA is assured to allow further additional recording. That is, there is a special R zone set with the “recording management zone RMZ (U-RMZ) in the bordered area”.

In this embodiment, a new “recording management zone RMZ (U-RMZ) in the bordered area BRDA” can be set not only when the remaining size of the unrecorded area (reserved area 273) in the first bordered area management zone RMZ (L-RMZ) becomes small but also when the remaining size of the unrecorded area (reserved area 273) in the “recording management zone RMZ (B-RMZ) in the border in BRDI” or the already set “recording management zone RMZ (U-RMZ) in the bordered area BRDA” becomes small.

The information contents recorded in the recording management zone RMZ (U-RMZ) in the bordered area BRDA have the same structure as that in the recording management zone RMZ (L-RMZ) in the data lead-in area DTLDI shown in FIG. 13B. As information in the recording management data RMD recorded in this zone, not only the recording management data associated with data recorded in the corresponding bordered area BRDA but also the recording management information associated with data recorded in the preceding bordered area BRDA are recorded together.

Of these kinds of recording management zones RMZ,

1. the position of the recording management zone RMZ (L-RMZ) in the data lead-in area DTLDI is set in advance before recording of user data. However, in this embodiment, since

2. the recording management zone RMZ (B-RMZ) in the border in BRDI and

3. the recording management zone RMZ (U-RMZ) in the bordered area BRDA

are appropriately set (extended) by the information recording/playback apparatus in correspondence with the user data recording (additional recording) state, these zones will be referred to as an “extended recording management zone RMZ”.

When the unrecorded area (reserved area 273) in the currently used recording management zone RMZ becomes equal to or smaller than 15 physical sector blocks (15×64 KB), a recording management zone RMZ (U-RMZ) in the bordered area BRDA can be set. The size of the recording management zone RMZ (U-RMZ) in the bordered area BRDA upon setting is that of 128 physical segment blocks (128×64 KB), and that zone is defined as an R zone dedicated to the recording management zone RMZ.

Since the write-once information storage medium of this embodiment can set the three types of recording management zones RMZ, it allows the presence of a very large number of recording management zones RMZ per write-once information storage medium. For this reason, this embodiment executes the following processing for the purpose of easy search to the recording location of the latest recording management zone RMZ.

(1) Upon setting a new recording management zone RMZ, the latest recording management data RMD is multiple-recorded in the recording management zone RMZ used so far, so the recording management zone RMZ used so far does not include any unrecorded area. (This allows to identify whether the recording management zone RMZ is currently used or a recording management zone is set at a new location.)

(2) Every time a new recording management zone RMZ is set, duplication information 48 of the latest recording management data RMD is recorded in the RMD duplication zone RMZ. This allows an easy search of the location of the currently used recording management zone RMZ.

The write-once information storage medium of this embodiment allows the presence of many unrecorded area. However, since the dedicated playback apparatus uses the DPD (Differential Phase Detection) method as tracking error detection, it cannot perform tracking on the unrecorded areas. For this reason, the border close processing must executed before the write-once information storage medium is played back by the dedicated playback apparatus so that the unrecorded areas are not present.

The pattern contents of a reference code recorded in the reference code zone RCZ will be described in detail below. The existing DVD adopts an “8/16 modulation” method that converts 8-bit data into 16-channel bits as the modulation method, and a repetition pattern “00100000100000010010000010000001” is used as a reference code pattern as a channel bit sequence recorded on the information storage medium after modulation. By contrast, this embodiment uses ETM modulation that modulates 8-bit data into 12-channel bits to apply a runlength limitation of RLL(1, 10), and adopts the PRML method in signal playback from the data lead-in area DTLDI, data area DTA, data lead-out area DTLDO, and middle area MDA. Therefore, a reference code pattern optimal to the modulation rules and PRML detection must be set. According to the runlength limitation of RLL(1, 10), a minimum value of a run of “0” is a repetition pattern “10101010” when “d=1”. If a distance from a code “1” or “0” to the next neighboring code is “T”, the distance between the neighboring “1”s in the above pattern is “2T”.

In this embodiment, to attain the high density of the information storage medium, since a playback signal from the “2T” repetition pattern (“10101010”) is present in the vicinity of the cutoff frequency of the MTF (Modulation Transfer Function) characteristics of an objective lens in an optical head (included in the information recording/playback unit 141 in FIG. 14), nearly no degree of modulation (signal amplitude) is obtained. Therefore, when the playback signal from the “2T” repetition pattern (“10101010”) is used as that used in circuit adjustment of the information playback apparatus or information recording/playback apparatus, the influence of noise is large, resulting in poor stability. Therefore, it is desirable to perform circuit adjustment using a “3T” pattern with the next highest density for a signal after modulation executed according to the runlength limitation of RLL (1, 10).

In consideration of a DSV (Digital Sum Value) value of a playback signal, the absolute value of a DC (direct current) value increases in proportion to a “0” run count until next “1” that appears immediately after “1” and is added to the immediately preceding DSV value. The polarity of this DC value to be added is reversed every time “1” appears. Therefore, by setting a DSV value to be “0” in 12 channel bit sequences after E™ modulation as a method of setting a DSV value to be “0” after channel bit sequences including continuous reference codes continue, the number of occurrence of “1” that appears in the 12 channel bit sequences after E™ modulation is set to be an odd value to cancel a DC component generated in one set of reference code cells including 12-channel bits by that generated in the next set of reference code cells of 12-channel bits, thus increasing the degree of freedom in reference code pattern design. Therefore, in this embodiment, the number of “1”s which appear in reference code cells including 12 channel bit sequences after ETM modulation is set to be an odd value.

This embodiment adopts a mark edge recording method in which a position of “1” matches the boundary position of recording marks or embossed pits. For example, when “3T” repetition patterns (“100100100100100100100”) continue, the lengths of embossed pits and those of spaces between the neighboring embossed pits may often have a slight difference depending on the recording condition or master preparation condition. When the PRML detection method is used, the level value of a playback signal is very important. Hence, even when the lengths of recording marks or embossed pits and those of spaces between them are slightly different, the slight difference must be corrected in a circuitry manner so as to attain stable, precise signal detection. Therefore, a reference code used to adjust the circuit constant preferably includes recording marks or embossed pits with the “3T” length and spaces with the “3T” length to improve the adjustment precision of the circuit constant. For this purpose, when a pattern “1001001” is included as the reference code pattern of this embodiment, recording marks or embossed pits and spaces with the “3T” length are indispensably arranged.

The circuit adjustment also requires a low-density pattern in addition to a high-density pattern (“1001001”). Therefore, in consideration of the above requirements that a low-density state (a pattern including a run of many “0”s) is generated in a portion excluding the pattern “1001001” in the 12 channel bit sequences after E™ modulation, and the number of occurrence of “1”s is set to be an odd value, an optimal condition of the reference code pattern is repetition of “100100100000”. In order to set a channel bit pattern after modulation to have the above pattern, a data word before modulation is set to be “A4h” using a modulation table (not shown) specified by the H-format of this embodiment. This data “A4h” (hexadecimal) corresponds to a data symbol “164” (decimal).

A practical data generation method according to the above data conversion rules will be described below. In the aforementioned data frame structure, the data symbol “164” (=“0A4h”) is set in main data “D0 to D2047” first. Next, data frames 1 to 15 are pre-scrambled by an initial preset number “0Eh”, and data frames 16 to 31 are pre-scrambled by an initial preset number “0Fh. When the data frames are pre-scrambled, they are double-scrambled upon scrambling according to the data conversion rules (double-scrambling restores an original pattern), and the data symbol “164” (=“0A4h”) appears intact. When all reference codes including 32 physical sectors are pre-scrambled, the DSV control is disabled. Hence, only data frame 0 is not pre-scrambled. After scrambling, a modulated pattern is recorded on the information storage medium.

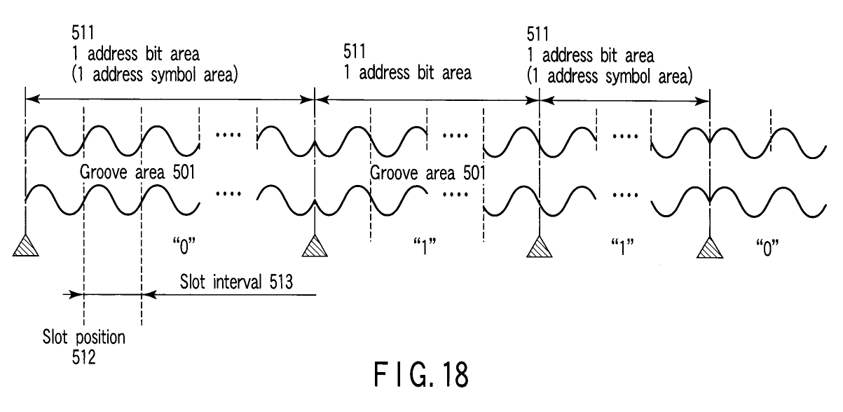

In the present invention, address information on a recordable (rewritable or write-once) information storage medium is recorded in advance using wobble modulation. This embodiment is characterized in that address information is recorded in advance on the information storage medium using ±90° (180°) phase modulation as the wobble modulation method, and also adopting the NRZ (Non Return to Zero) method. A detailed explanation will be given using FIG. 18. In this embodiment, as for address information, a 1-address bit (also called address symbol) area 511 is expressed by four wobble cycles, and the frequencies, amplitudes, and phases of wobbles match everywhere in the 1-address bit area 511. When the same value continues as an address bit value, an in-phase state continues at the boundaries (with “triangular marks” in FIG. 18) of respective 1-address bit areas 511; when an address bit is reversed, reversal of a wobble pattern (180° phase shift) occurs.

The wobble signal detector 135 of the information recording/playback apparatus shown in FIG. 14 simultaneously detects the boundary position (with the “triangular mark” in FIG. 18) of the address bit area 511 and a slot position 512 as the boundary position of one wobble cycle. The wobble signal detector 135 incorporates a PLL (Phase Lock Loop) circuit (not shown), which synchronously applies PLL to both the boundary position of the address bit area 511 and the slot position 512. When the boundary position of the address bit area 511 or the slot position 512 deviates, the wobble signal detector 135 cannot stably play back (decode) a wobble signal due to out of sync. An interval between the neighboring slot positions 512 is called a slot interval 513, and as this slot interval 513 is physically shorter, synchronization of the PLL circuit can be taken more easily, and a wobble signal can be stably played back (to decode the information contents).

As can be seen from FIG. 18, when the 180° phase modulation method that shifts to 180° or 0° is adopted, this slot interval 513 matches one wobble cycle. As the wobble modulation method, an AM (Amplitude Modulation) method that changes the wobble amplitude is readily influenced by dust and scratches attached to the surface of the information storage medium. However, since the phase modulation detects a change in phase in place of the signal amplitude, it is relatively hardly influenced by dust and scratches on the surface of the information storage medium. With an FSK (Frequency Shift Keying) method that changes the frequency as another modulation method, the slot interval 513 is long with respect to a wobble cycle, and synchronization of the PLL circuit is relatively hardly taken. Therefore, when address information is recorded by wobble phase modulation, the slot interval is short, and a wobble signal can be easily synchronized.

As shown in FIG. 18, binary data “1” or “0” are assigned to the 1-address bit areas 511. FIG. 18 shows the bit assignment method of this embodiment. As shown in the left side of FIG. 18, a wobble pattern which initially wobbles from the start position of one wobble toward the outer periphery side is called an NPW (Normal Phase Wobble), and is assigned data “0”. As shown in the right side, a wobble pattern which initially wobbles from the start position of one wobble toward the inner periphery side is called an IPW (Invert Phase Wobble), and is assigned data “1”.

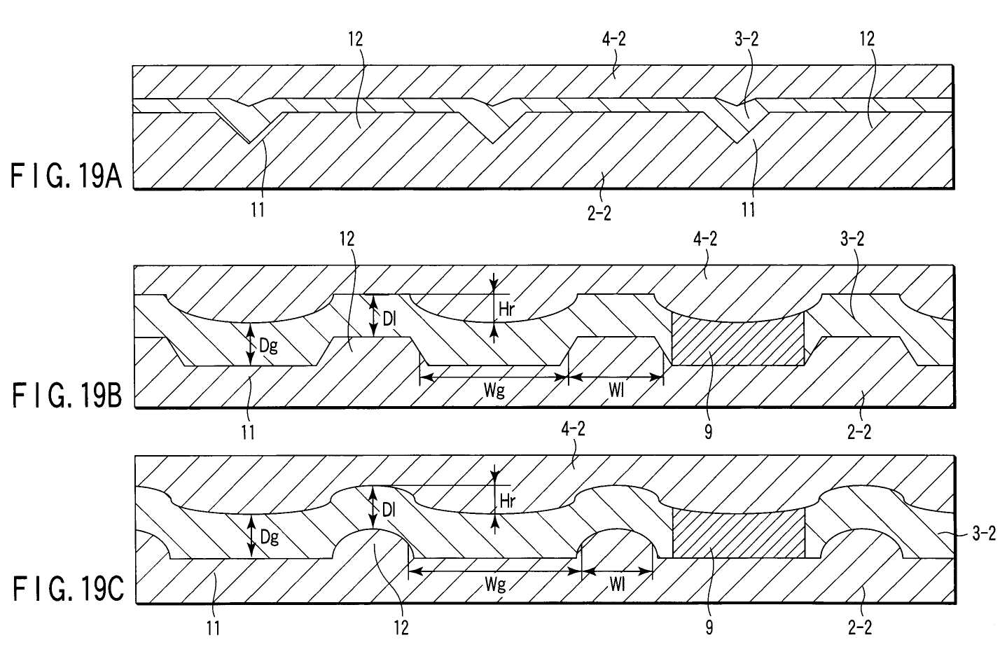

In this embodiment, as shown in FIGS. 19B and 19C, a width Wg of a pre-groove area 11 is set to be larger than a width W1 of a land area 12. As a result, the detection signal level of a wobble detection signal lowers, and the C/N ratio drops, thus posing a problem. To solve this problem, this embodiment is characterized in that a non-modulation area is set to be broader than a modulation area to attain stable wobble signal detection.

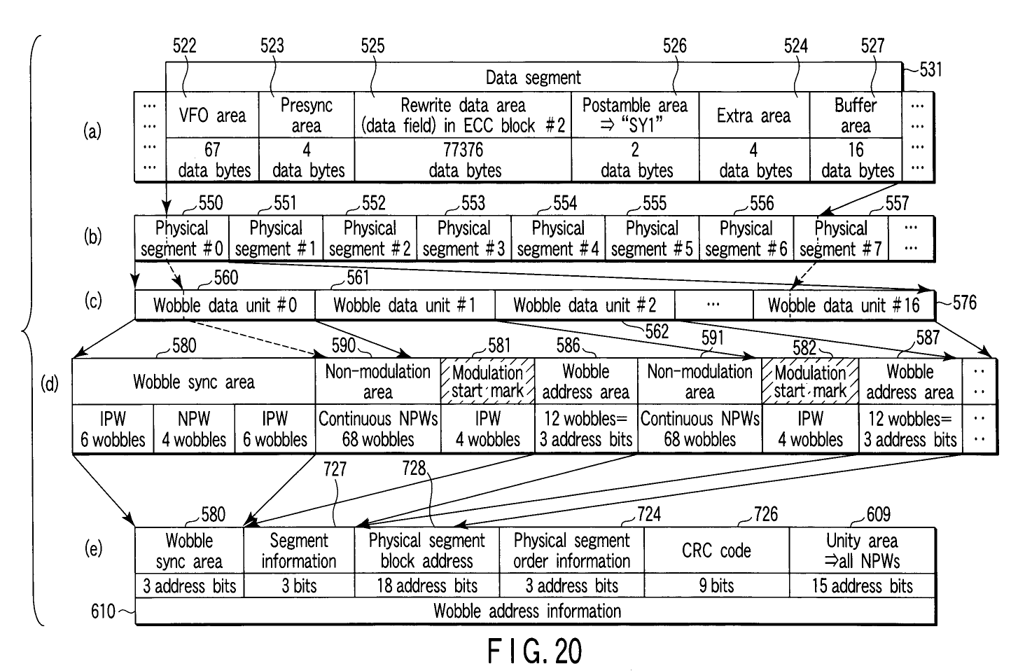

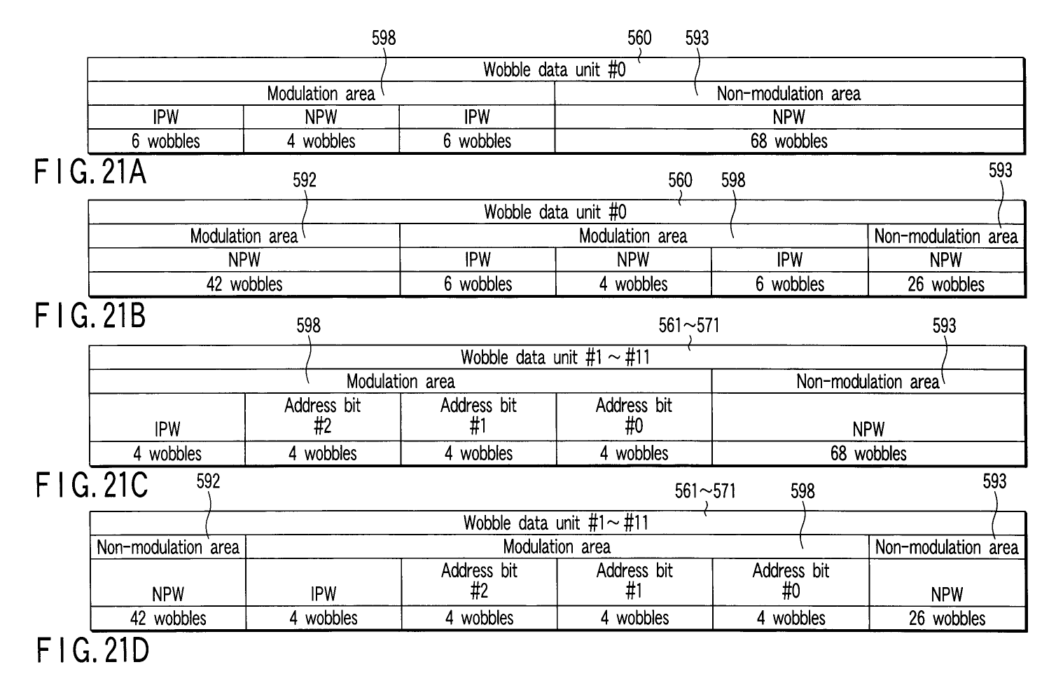

The wobble address format in the H-format of this embodiment will be described below using FIG. 20. As shown in FIG. 20-(b), in the H-format of this embodiment, seven physical segments 550 to 556 form one physical segment block. Each of the physical segments 550 to 556 is made up of 17 wobble data units 560 to 576, as shown in FIG. 20-(c). Furthermore, the wobble data units 560 to 576 are made up of modulation areas that form any of a wobble sync area 580, modulation start marks 581 and 582, and wobble address areas 586 and 587, and non-modulation areas 590 and 519 on which all continuous NPWs are formed. FIGS. 21A to 21D shows the presence ratio of the modulation areas and non-modulation areas in respective wobble data units. In all wobble units shown in FIGS. 21A to 21D, a modulation area 598 is formed by 16 wobbles, and a non-modulation area 593 is formed by 68 wobbles. This embodiment is characterized in that the non-modulation area 593 is broader than the modulation area 598. By setting the broader non-modulation area 593, a wobble detection signal, write clocks, or playback clocks can be stably synchronized in the PLL circuit using the non-modulation area 593. In order to attain stable synchronization, the non-modulation area 593 is desirably broader twice or more than the width of the modulation area 598.

The address information recording format using wobble modulation in the H-format of the write-once information storage medium of the present invention will be described below. The most characteristic feature of the address information setting method using wobble modulation in this embodiment lies in that “assignment is made using a sync frame length 433 as a unit”. One sector is formed of 26 sync frames, and one ECC block includes 32 physical sectors. Hence, one ECC block includes 832 (=26×32) sync frames.

Each physical segment is divided into 17 wobble data units (WDUs). Seven sync frames are assigned to the length of one wobble data unit.

As shown in FIG. 21A to 21D, each of wobble data units #0 560 to #11 571 includes the modulation area 598 for 16 wobbles, and the non-modulation areas 592 and 593 for 68 wobbles. The most characteristic feature of this embodiment lies in that the occupation ratio of the non-modulation areas 592 and 593 to the modulation area is very large. Since the groove or land area is wobbled always at a constant frequency on the non-modulation areas 592 and 593, PLL (Phase Locked Loop) is applied using these non-modulation areas 592 and 593, and reference clocks upon playing back recording marks recorded on the information storage medium or recording reference clocks used upon recording new recording marks can be stably extracted (generated).

Since the occupation ratio of the non-modulation areas 592 and 593 to the modulation area 598 is very large in this embodiment, the precision and extraction (generation) stability of extraction (generation) of playback reference clocks or extraction and that of recording reference clocks can be greatly improved. That is, upon executing phase modulation based on wobbles, when a playback signal passes through a bandpass filter for waveform shaping, a phenomenon occurs in which the detection signal waveform amplitude after shaping becomes small before and after the phase change position. Therefore, the following problem is posed. That is, when the frequency of occurrence of phase change points due to phase modulation becomes high, the waveform amplitude variation becomes large, and the clock extraction precision drops. Conversely, when the frequency of occurrence of phase change points in the modulation area is low, bit shifts upon detection of wobble address information readily occur. To solve this problem, this embodiment improves the clock extraction precision by forming the modulation area and non-modulation area by phase modulation, and setting a high occupation ratio of the non-modulation area.

In this embodiment, since the switching position between the modulation area and non-modulation area can be predicted, the non-modulation area is gated to detect a signal of only the non-modulation area for the purpose of the clock extraction, and clocks are extracted from the detection signal. Especially, when a recording layer 3-2 is formed of an organic dye recording material using the recording principle according to this embodiment, a wobble signal is relatively hardly extracted upon using the pre-groove shape/dimensions described in “3-2-D] basic feature associated with pre-groove shape/dimensions in this embodiment” in “3-2) basic feature description common to organic dye film in this embodiment”. To solve this problem, since the occupation ratio of the non-modulation areas 592 and 593 to the modulation area is set to be very large, the reliability of wobble signal detection is improved.

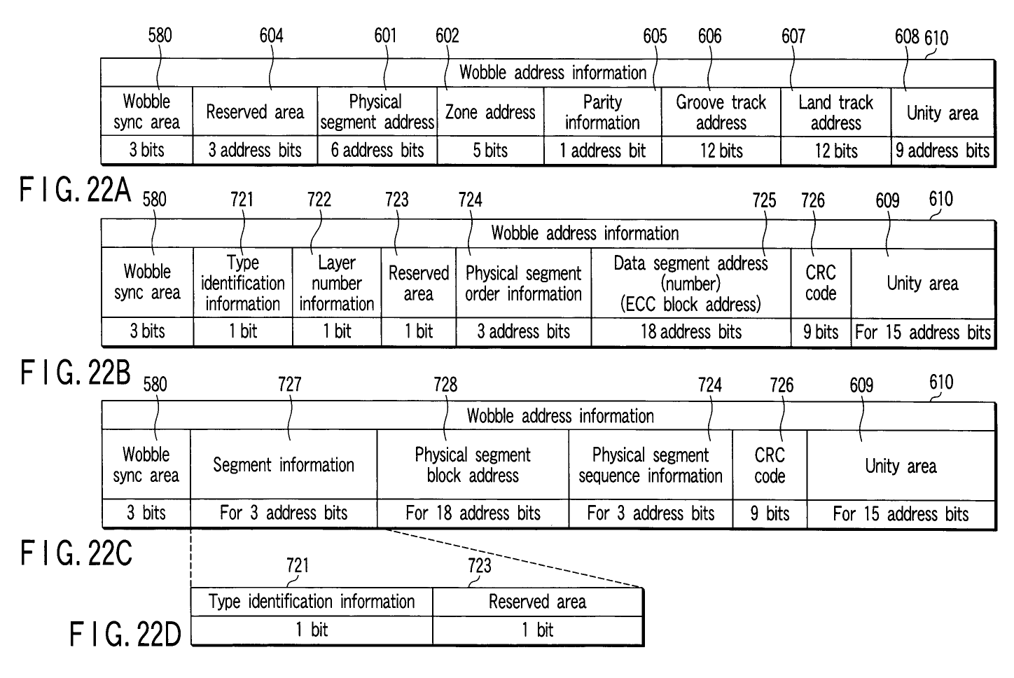

Upon transition from the non-modulation area 592 or 593 to the modulation area 598, an IPW area as a modulation start mark is set using four or six wobbles, and wobble address areas (address bits #2 to #0) appear immediately after detection of the IPW area as the modulation start mark in a wobble data part shown in FIGS. 21C and 21D. FIGS. 21A and 21B show the contents of a wobble data unit #0 560 corresponding to the wobble sync area 580 shown in FIG. 22C, and FIGS. 21C and 21D show the contents of the wobble data units corresponding to a wobble data part from segment information 727 to a CRC code 726 shown in FIG. 22C. FIGS. 21A and 21C show the wobble data unit contents corresponding to a primary position 701 of the modulation area to be described later, and FIGS. 21B and 21D show the wobble data unit contents corresponding to a secondary position 702 of the modulation area. As shown in FIGS. 21A and 21B, in the wobble sync area 580, six wobbles are assigned to each of IPW areas, and four wobbles are assigned to an NPW area bounded by the IPW areas. As shown in FIGS. 21C and 21D, in the wobble data part, four wobbles are respectively assigned to the IPW area and all the address bit areas #2 to #0.

FIGS. 22A to 22D show an embodiment associated with the data structure in wobble address information on the write-once information storage medium. FIG. 22A shows the data structure in wobble address information on a rewritable information storage medium for the sake of comparison. FIGS. 22B and 22C show two different embodiments associated with the data structure in wobble address information on the write-once information storage medium.

In wobble address information 610, three address bits are set using 12 wobbles (see FIG. 18). That is, four continuous wobbles form one address bit. In this way, this embodiment adopts a structure in which the address information locations are distributed for every three address bits. When all pieces of wobble information 610 are concentratively recorded at one location in the information storage medium, all the pieces of information cannot be detected when dust or scratches are formed on the surface. As in this embodiment, the locations of the wobble address information 610 are distributed in three address bits (12 wobbles) included in one of the wobble data units 560 to 576, information is recorded for an integer multiple of three address bits, and even when it is difficult to detect information at a given location due to the influence of dust or scratches, another information can be detected.

Since the locations of the wobble address information 610 are distributed, and the wobble address information 610 is allocated to be completed for each physical segment, the address information can be detected for each physical segment. Therefore, upon accessing by the information recording/playback apparatus, the current position can be detected for each physical segment.

Since this embodiment adopts the NRZ method, as shown in FIG. 18, a phase never changes in four continuous wobbles in the wobble address information 610. By using this feature, the wobble sync area 580 is set. That is, since a wobble pattern which can never be generated in the wobble address information 610 is set for the wobble sync area 580, the allocation position of the wobble sync area 580 is easily identified. This embodiment is characterized in that one address bit is set to have a length other than four wobbles at the position of the wobble sync area 580 with respect to the wobble address areas 586 and 587 each of which forms one address bit by four continuous wobbles. More specifically, in the wobble sync area 580, a wobble pattern change that can never be taken place on the wobble data part (FIGS. 21C and 21D) is set like that an area (IPW area) where a wobble bit=“1” is set to be different from four wobbles, i.e., “six wobbles→four wobbles→six wobbles, as shown in FIGS. 21A and 21B. When the method of changing the wobble cycles is adopted, as described above, as the practical method of setting a wobble pattern which can never be generated in the wobble data part in the wobble sync area 580, the following effects are provided.

(1) Wobble detection (determination of wobble signals) can be stably continued without breaking PLL associated with the slot positions 512 (FIG. 18) of wobbles, which is executed inside the wobble signal detector 135 in FIG. 14.

(2) The wobble sync area 580 and modulation start marks 581 and 582 can be easily detected by shift of the address bit boundary positions, which is done inside the wobble signal detector 135 in FIG. 14.

A characteristic feature of this embodiment lies in that the wobble sync area 580 is formed to have a 12-wobble cycle and the length of the wobble sync area 580 matches three address bit lengths, as shown in FIG. 21. In this way, by assigning the entire modulation area (for 16 wobbles) in one wobble data unit #0 560 to the wobble sync area 580, the start position of the wobble address information 610 (the allocation position of the wobble sync area 580) is more easier to detect. This wobble sync area is allocated in the first wobble unit in the physical segment. By allocating the wobble sync area 580 at the head position in the physical segment, the boundary position of the physical segment can be extracted by only detecting the position of the wobble sync area 580.

As shown in FIGS. 21C and 21D, an IPW area as a modulation start mark (see FIG. 18) is allocated at the head position ahead of address bits #2 to #0 in the wobble data units #1 561 to #1 571. Since the non-modulation areas 592 and 593 allocated at positions ahead of it have continuous NPW waveforms, the wobble signal detector 135 shown in FIG. 14 extracts the position of the modulation start mark by detecting a switching position from the NPW to IPW.

For reference, the contents of the wobble address information 610 in the rewritable information storage medium shown in FIG. 22A record:

(1) Physical segment address 601

. . . Information indicating the physical segment number in a track (in one round in an information storage medium 221).

(2) Zone address 602

. . . Indicates the zone number in the information storage medium 221.

(3) Parity information 605

. . . Information which is set to detect an error upon playback from the wobble address information 610 and indicates if a sum obtained by individually adding 14 address bits from reserved information 604 to the zone address 602 in address bit units is an even or odd number. The value of the parity information 605 is set so that a result obtained by exclusively ORing a total of 15 address bits including one address bit of this address parity information 605 becomes “1”.

(4) Unity area 608

. . . As described above, each wobble data unit is set to include the modulation area 598 for 16 wobbles and the non-modulation areas 592 and 593 for 68 wobbles, so that the occupation ratio of the non-modulation areas 592 and 593 to the modulation area 598 is set to be very large. Furthermore, by increasing the occupation ratio of the non-modulation areas 592 and 593, the precision and stability of extraction (generation) of playback reference clocks or recording reference clocks are improved. In the unity area 608, all NPW areas continue to form a non-modulation area with a uniform phase.

FIG. 22A shows the numbers of address bits assigned to these pieces of information. As described above, the contents of the wobble address information 610 are separated for respective three bit addresses and are distributed in respective wobble data units. Even when a burst error has occurred due to dust or scratches on the surface of the information storage medium, the probability of errors which spread across different wobble data units is very low. Therefore, the number of times that the recording location of identical information extends over different wobble data units is reduced as much as possible, thus matching the delimited position of each information with the boundary position of each wobble data unit. In this way, even if a burst error has occurred due to dust or scratches on the surface of the information storage medium and specific information cannot be read, another information recorded in other wobble data units can be read to improve the playback reliability of the wobble address information.

The most characteristic feature of this embodiment also lies in that the unit areas 608 and 609 are allocated last in the wobble address information 610, as shown in FIGS. 22A to 22C. As described above, since wobble waveforms in the unity areas 608 and 609 are defined by NPWs, NPWs continue substantially in three continuous wobble data units. By utilizing this feature, the wobble signal detector 135 in FIG. 14 can easily extract the position of the unity area 608 allocated last in the wobble address information 610 by searching for a location where the NPWs continue for a length of three wobble data units 576. Using this position information, the wobble signal detector 135 can detect the start position of the wobble address information 610.

Of various kinds of information shown in FIG. 22A, the physical segment address 601 and zone address 602 indicate the same values between neighboring tracks, while a groove track address 606 and land track address 607 change their values between neighboring tracks. Therefore, an indefinite bit area 504 appears in an area where the groove track address 606 and land track address 607 are recorded. In order to reduce this indefinite bit frequency, this embodiment indicates addresses (numbers) using gray codes for the groove track address 606 and land track address 607. The gray code means a code which changes by only “1 bit” after conversion when an original value is changed by “1”. In this way, the indefinite bit frequency is reduced, and not only the wobble detection signals but also playback signals from recording marks can be detected stably.

As shown in FIGS. 22B and 22C, on the write-once information storage medium, the wobble sync area 680 is allocated at the head position of a physical segment to allow easy detection of the head position of the physical segment or the boundary position between neighboring physical segment. Since type identification information 721 of the physical segment shown in FIG. 22D indicates the allocation position of the modulation area in the physical segment in the same manner as the wobble sync pattern in the aforementioned wobble sync area 580, the allocation position of another modulation area 598 in the identical physical segment can be predicted in advance, and an advance preparation of detection of the forthcoming modulation area can be made, thus improving the signal detection (determination) precision in the modulation area.

Layer number information 722 on the write-once information storage medium shown in FIG. 22B indicates a single-sided, single recording layer or either one recording layer in case of single-sided, double recording layers, and means:
the single-sided, single recording layer medium or “L0 layer” (a front-side layer on the laser beam incident side) in case of the single-sided, double recording layers when it is “0”; or
“L1 layer” (a back-side layer on the laser beam incident side) of the single-sided, double recording layers when it is “1”.

Physical segment order information 724 indicates a relative allocation order of physical segments in a single physical segment block. As can be seen from comparison with FIG. 22A, the head position of the physical segment order information 724 in the wobble address information 610 matches that of the physical segment address 601 on the rewritable information storage medium. By determining the position of the physical segment order information in correspondence with that on the rewritable medium, the compatibility between different medium types can improve, and a common address detection control program using wobble signals can be used in an information recording/playback apparatus which can use both the rewritable information storage medium and write-once information storage medium, thus simplifying the arrangement.

A data segment address 725 in FIG. 22B describes address information of a data segment using a number. As has already been described above, in this embodiment, 32 sectors form one ECC block. Therefore, the lower 5 bits of the physical sector number of a sector allocated at the head in a specific ECC block matches the sector numbers of sectors allocated at the head in neighboring ECC blocks. When the physical sector number of the sector allocated at the head in the ECC block is set so that its lower 5 bits are “00000”, the values of the lower 6th bit or higher of the physical sector numbers of all sectors included in the identical ECC block match. Therefore, address information obtained by removing the lower 5-bit data of the physical sector number of each sector included in the identical ECC block, and extracting only data of the lower 6th bit or higher is set as an ECC block address (or ECC block address number). The data segment address 725 (or physical segment block number information) which is recorded in advance by wobble modulation matches the ECC block address. Hence, if the position information of each physical segment block by wobble modulation is displayed as a data segment address, the data size is reduced by 5 bits compared to display as the physical sector number, thus simplifying the current position detection upon accessing.

The CRC code 726 shown in FIGS. 22B and 22C is a CRC code (error correction code) for 24 address bits from the type identification information 721 of the physical segment to the data segment address 725 or that for 24 address bits from the segment information 727 to the physical segment order information 724, and even when a wobble modulation signal is partially erroneously read, it can be partially corrected by this CRC code 726.

On the write-once information storage medium, an area corresponding to the remaining 15 address bits is assigned to the unity area 609, and the contents of five, 12th to 16th wobble data units are defined by all NWPs (no modulation area 598 is included).

A physical segment block address 728 in FIG. 22C is an address for each physical segment block which forms one unit by seven physical segments, and the physical segment address for the first physical segment block in the data lead-in DTLDI is set to be “1358h”. The value of this physical segment block address is sequentially incremented by one from the first physical segment block in the data lead-in area DTLDI to the last physical segment block in the data lead-out area DTLDO as well as the data area DTA.

The physical segment order information 724 represents the order of physical segments in one physical segment block: “0” is set for the first physical segment, and “6” is set for the last physical segment.

The embodiment shown in FIG. 22C is characterized in that the physical segment block address 728 is allocated at a position ahead of the physical segment order information 724. For example, address information is normally managed using this physical segment block address like in RMD field 1. In order to access a predetermined physical segment block address in accordance with the management information, the wobble signal detector 136 shown in FIG. 14 detects the location of the wobble sync area 580 shown in FIG. 22C first, and then sequentially decodes information in turn from that recorded immediately after the wobble sync area 580. When the physical segment block address is allocated at the position ahead of the physical segment order information 724, since a predetermined physical block address or not can be checked without decoding the physical segment order information 724, accessibility using wobble addresses can improve.

This embodiment is also characterized in that the type identification information 721 is allocated immediately after the wobble sync area 580 in FIG. 22C. As described above, the wobble signal detector 135 shown in FIG. 14 detects the location of the wobble sync area 580 shown in FIG. 22C first, and then sequentially decodes information in turn from that recorded immediately after the wobble sync area 580. Therefore, by allocating the type identification information 721 immediately after the wobble sync area 580, since the allocation position of the modulation area in the physical segment can be immediately confirmed, access processing using the wobble addresses can be speeded up.

Since this embodiment uses the H-format, a predetermined value of the wobble signal frequency is set to be 697 kHz.

A measurement example of a maximum value (Cwmax) and minimum value (Cwmin) of the carrier level of the wobble detection signal will be described below.

Since the write-once storage medium of this embodiment uses the CLV (Constant Linear Velocity) recording method, wobble phases change between neighboring tracks depending on track positions. When wobble phases between neighboring tracks are in phase, the carrier level of the wobble detection signal becomes highest, i.e., it assumes a maximum value (Cwmax). On the other hand, when wobble phases between neighboring tracks are in antiphase, the wobble detection signal becomes lowest due to the influence of crosstalk of neighboring tracks, and assumes a minimum value (Cwmin). Therefore, upon tracing from the inner periphery in the outer periphery direction along tracks, the magnitude of the carrier of the wobble detection signal to be detected varies in four track cycles.

In this embodiment, a wobble carrier signal is detected every four tracks to measure the maximum value (Cwmax) and minimum value (Cwmin) every four tracks. In step ST03, pairs of the maximum values (Cwmax) and minimum values (Cwmin) are stored as 30 or more pairs of data.

Using the following calculation formula, a maximum amplitude (Wppmax) and minimum amplitude (Wppmin) are calculated based on the average values of the maximum values (Cwmax) and minimum values (Cwmin) in step ST04.

In the following formulas, R is the terminated resistance of a spectrum analyzer. The formulas for converting Wppmax and Wppmin from the values of Cwmax and Cwmin will be described below.

In a dBm unit system, 0 dBm=1 mW is used as a reference. A voltage amplitude V0 which yields electric power Wa=1 mW is given by:

$$\begin{matrix}Wao = IVo \\ = Vo \times Vo / R \\ = 1 / 1000 W\end{matrix}$$

Therefore, we have:

Vo=(R/1000)1/2

Next, the relationship between a wobble amplitude Wpp [V] and a carrier level Cw [dBm] observed by the spectrum analyzer is as follows. Since Wpp is a sine wave, if the amplitude is converted into a root-mean-square value, we have:

Wpp−rms=Wpp/(2×21/2)

Cw=20×log(Wpp−rms/Vo)[dBm]

Therefore, we have:

Cw=10×log(Wpp−rms/Vo)2

Therefore, transformation of log in the above formula yields:

$$\begin{matrix}( Wpp - rms / Vo ) 2 = 10 ( Cw / 10 ) \\ = \{ [ Wpp / ( 2 \times 21 / 2 ) ] / Vo \} 2 \\ = \{ Wpp / ( 2 \times 22 ) / ( R / 1000 ) 1 / 2 \} 2 \\ = ( Wpp 2 / 8 ) / ( R / 1000 )\end{matrix} \\ \begin{matrix}WPP 22 = ( 8 \times R ) / ( 1000 \times 10 ( Cw / 10 ) ) \\ = 8 \times R \times 10 ( - 3 ) \times 10 ( Cw / 10 ) \\ = 8 \times R \times 10 ( Cw / 10 ) ( - 3 )\end{matrix} \\ Wpp = \{ 8 \times R \times 10 ( Cw / 10 ) ( - 3 ) \} 1 / 2 \qquad ( 5 )$$

As described above, this embodiment provides the following effects.

(1) The ratio of the minimum value (Wppmin) of the amplitude of the wobble detection signal to (I1−I2)pp as a tracking error signal is set to be 0.1 or more, a wobble detection signal sufficiently larger than the dynamic range of the tracking error signal can be obtained, and the high detection precision of the wobble detection signal can be consequently assured.

(2) Since the ratio between the maximum value (Wppmax) and minimum value (Wppmin) of the amplitudes of the wobble detection signals is set to be 2.3 or less, a wobble signal can be stably detected without any large influence from crosstalk of wobbles from the neighboring tracks.

(3) Since the PRSNR value as the square result of a wobble signal is assured to be 26 dB or higher, a stable wobble signal with the high C/N ratio can be assured, thus improving the detection precision of a wobble signal.

The write-once information storage medium of this embodiment adopts the CLV recording method by forming recording marks on the groove area. In this case, since wobble slot positions are deviated between neighboring tracks, an interference between neighboring wobbles is readily superposed on a wobble playback signal, as described above. In order to remove this influence, this embodiment devises to shift modulation areas so that they do not overlap each other between neighboring tracks.

The practical primary position and secondary position associated with the modulation areas are set by switching the positions in a single wobble data unit. In this embodiment, since the occupation ratio of the non-modulation area is set to be higher than that of the modulation area, the primary position and secondary position can be switched by changing only the positions in the single wobble data unit. More specifically, the modulation area 598 is allocated at the head position in one wobble data unit at the primary position 701, as shown in FIGS. 21A and 21C, and the modulation area 598 is allocated at the latter half position in each of the wobble data units 560 to 571 at the secondary position 702, as shown in FIGS. 21B and 21D.

In this embodiment, the adaptive range of the primary positions 701 and secondary positions 702 shown in FIGS. 21A to 21D, i.e., the range where the primary positions or secondary positions continuously appear is specified as the range of physical segments. That is, as shown in FIGS. 22A to 22D, three types (a plurality of types) of allocation patterns of modulation areas in a single physical segment are provided. When the wobble signal detector 135 in FIG. 14 identifies the allocation pattern of the modulation area in a physical segment based on information of the type identification information 721 of the physical segment, the position of another modulation area 598 in the single physical segment can be predicted. As a result, an advance preparation of detection of the forthcoming modulation area can be made, thus improving the signal detection (determination) precision in the modulation area.

A method of recording the aforementioned data segment data in the physical segment or physical segment block whose address information is recorded in advance by wobble modulation, as described above, will be described below. On both the rewritable information storage medium and write-once information storage medium, data are recorded in a recording cluster unit as a unit for continuously recording data. In this way, since a recording cluster that represents a rewrite unit has a structure which is made up of one or more data segments, mixed recording processing of PC data (PC files) which are normally frequently rewritten by small data sizes and AV data (AV files) which continuously record a large volume of data at a time on a single information storage medium can be facilitated. More specifically, as data used for a personal computer, data of relatively small sizes are often frequently rewritten. Therefore, when a rewrite or additional recording data unit is set as small as possible, a recording method suited to PC data can be provided. In this embodiment, since 32 physical sectors form one ECC block, a data segment unit which includes only one ECC block and used to execute rewrite or additional recording processing becomes a minimum unit that allows efficient rewrite or additional recording processing. Therefore, the structure of this embodiment, which includes one or more data segments in a recording cluster that represents a rewrite unit or additional recording unit serves as a recording structure suited to PC data (PC files). As AV (Audio Visual) data, a very large volume of video information and audio information must be continuously recorded without being interrupted. In this case, data to be continuously recorded is recorded together as one recording cluster. If a random shift amount, the structure in a data segment, the attribute of a data segment, and the like are switched for each data segment that forms one recording cluster upon recording of AV data, switching processing requires a long time, and it becomes difficult to attain continuous recording processing. In this embodiment, since a recording cluster is formed by continuously arranging data segments of the same format (without changing the attribute or random shift amount, and without inserting any specific information between neighboring data segments), the recording format suited to AV data recording that recording a large volume of data continuously can be provided. Also, the structure in a recording cluster is simplified to simplify a recording control circuit and playback detection circuit of the information recording/playback apparatus or information playback apparatus, thus reducing the cost of the information recording/playback apparatus or information playback apparatus. Both the read-only information storage medium and write-once information storage medium adopt the same data structure in a recording cluster 540 (except for an extended guard field 528). Since the data structure is common to all types of information storage media irrespective of read-only/write-once/rewriteable media, the compatibility among media is assured, and a detection circuit in the information recording/playback apparatus or information playback apparatus can be commonized, thus assuring high playback reliability and attaining a cost reduction.

A guard area of the rewritable medium includes a postamble area, extra area, buffer area, VFO area, and presync area, and an extended guard field is allocated at only the continuous recording end position. This embodiment is characterized in that rewrite or additional recording processing is executed so that the extended guard field and VFO area on the back side partially overlap each other at overlapping position upon rewrite processing. By executing rewrite or additional recording processing so that the extended guard field and VFO area partially overlap each other, formation of a gap (an area where no recording marks are formed) between neighboring recording clusters can be prevented to remove inter-layer crosstalk on an information storage medium that allows recording on single-sided double recording layers, thus stably detecting a playback signal.

A rewritable data size in one data segment of this embodiment amounts to:

67+4+77376+2+4+16=77469(data bytes)

One wobble data unit 560 is made up of:

6+4+6+68=84(wobbles)

As shown in FIG. 26, 17 wobble data units form one physical segment 550, and the length of seven physical segments 550 to 556 match that of one data segment 531. Hence,

84×17×7=9996(wobbles)

are allocated within the length of one data segment 531. Therefore, from the above equation, one wobble corresponds to

77496÷9996=7.75(data bytes/wobble)

After 24 wobbles from the head position of the physical segment, an overlapping portion between the next VFO area 522 and extended guard field 528 appears. In this case, from the head of the physical segment 550 to the 16th wobble, the wobbles fall within the wobble sync area 580, but subsequent 68 wobbles fall within the non-modulation area 590. Therefore, the overlapping portion between the next VFO area 522 and extended guard field 528 after 24 wobbles falls within the non-modulation area 590. In this way, by locating the head position of the data segment after 24 wobbles from the head position of the physical segment, not only the overlapping portion falls within the non-modulation area 590, a suitable detection time of the wobble sync area 580 and preparation time of the recording processing can be assured, thus guaranteeing stable, precise recording processing.

The recording film of the rewritable information storage medium in this embodiment uses a phase change recording film. Since deterioration of the recording film sets in from the vicinity of the rewrite start/end position on the phase change recording film, if recording start/recording end is repeated at the same position, the number of rewrite times is limited due to deterioration of the recording film. In this embodiment, in order to reduce the above problem, the recording start position is randomly shifted by Jm+1/12 data bytes upon rewriting.

In the above description, the head position of the extended guard field matches that of the VFO area for the sake of an explanation of the basic concept. However, strictly speaking, the head position of the VFO area is randomly shifted.

A DVD-RAM disc as an existing rewritable information storage medium uses a phase change recording film as the recording film, and randomly shifts the recording start/end positions to improve the number of rewrite times. A maximum shift amount range upon making a random shift on the existing DVD-RAM disc is set to be 8 data bytes. The average channel bit length (as data after modulation to be recorded on the disc) on the existing DVD-RAM disc is set to be 0.143 μm. On the rewritable information storage medium of this embodiment, the average channel bit length is (0.087+0.093)÷2=0.090 (μm). When the length of the physical shift range is set to be equal to that of the existing DVD-RAM disc, the minimum required length as the random shift range in this embodiment is, using the aforementioned values:

8 bytes×(0.143 μm÷0.090 μm)=12.7 bytes

In this embodiment, in order to assure easy playback signal detection processing, a unit of the random shift amount is set to be equal to “channel bits” after modulation. Since this embodiment uses ETM modulation (Eight to Twelve modulation) that converts 8 bits into 12 bits as modulation, the random shift amount is mathematically expressed using data bytes by:

Jm/12(data bytes)

As a value that Jm can assume, using the values of the above equation,

12.7×12=152.4

Hence, Jm falls within the range from 0 to 152. For the above reasons, within the range in which the above equation holds, the length of the random shift range matches that of the existing DVD-RAM disc, and the same number of rewrite times as that of the existing DVD-RAM disc can be guaranteed. In this embodiment, in order to assure the number of rewrite times more than that of the existing DVD-RAM disc, a slight margin is provided to the minimum required length to set:

Length of random shift range=14(data bytes)

From these equations, since 14×12=168, the value that Jm can assume is set to fall within:

0 to 167

As described above, since the random shift amount is set to be a range larger than Jm/12 (0≦Jm≦154), the length of the physical length with respect to the random shift amount matches that of the existing DVD-RAM, thus assuring the same number of times of repetitive recording as that of the existing DVD-RAM.

The lengths of the buffer area and VFO area in the recording cluster are constant. The random shift amounts Jm of all data segments in a single recording cluster have the same value everywhere. Upon continuously recording one recording cluster which includes a large number of data segments, the recording position is monitored from wobbles. That is, confirmation of the recording position on the information storage medium and recording are performed at the same time while detecting the position of the wobble sync area 580 shown in FIGS. 22A to 22C and counting the number of wobbles in the non-modulation areas 592 and 593 shown in FIGS. 21B and 21D. At this time, a wobble slip (to record at a position shifted for one wobble cycle) infrequently occurs due to a count error of wobbles or rotation nonuniformity of a rotation motor which rotates the information storage medium, and the recording position on the information storage medium is shifted. The information storage medium of this embodiment is characterized in that upon detection of the recording position shift generated in this way, the adjustment is made in the guard area of the rewritable medium to correct the recording timing. In this embodiment, the H-format has been explained, but this basic concept is adopted in a B-format, as will be described later. The postamble area, extra area, and presync area record important information that does not allow bit omissions or duplications. However, since the buffer area and VFO area record repetitions of specific patterns, they allow an omission or duplication of only one pattern as long as the repetition boundary position is assured. Therefore, in this embodiment, adjustment is made especially in the buffer area or VFO area in the guard area, thus correcting the recording timing.

In this embodiment, an actual start point position as a reference for a position setting is set to match the (wobble central) position with a wobble amplitude “0”. However, since the wobble position detection precision is low, as described as “±1 max”, this embodiment permits the actual start point position to have a maximum of:

a shift amount up to “±1 data byte”

Let Jm be a random shift amount in a data segment (as described above, random shift amounts in all data segments in a recording cluster match), and Jm+1 be a random shift amount of a data segment to be additionally recorded later. As a value that Jm and Jm+1 in the above formula can assume, an intermediate value is assumed, i.e., Jm=Jm+1=84. When the positional precision of the actual start point is sufficiently high, the start position of the extended guard field matches that of the VFO area.

By contrast, when a data segment is recorded at a maximally rear position, and a data segment which is additionally recorded or rewritten later is recorded at a maximally front position, the head position of the VFO area may enter the buffer area by a maximum of 15 data bytes. The extra area immediately before the buffer area records specific important information. Therefore, in this embodiment, the length of the buffer area requires:

15 data bytes or more

In this embodiment, a margin for one data byte is added, and the data size of the buffer area is set to be 16 data bytes.

If a gap is formed between the extended guard field and VFO area as a result of random shift, it causes inter-layer crosstalk upon playback when the single-sided, double-recording layer structure is adopted. For this reason, even when the random shift is made, the extended guard field and VFO area partially overlap each other so as not to form any gap. Therefore, in this embodiment, the length of the extended guard field must be set to be 15 data bytes or more. Since the VFO area which follows has a sufficiently large length of 71 data bytes, no problem is posed upon playback even when the overlapping area between the extended guard field and VFO area becomes broader slightly (since a sufficiently long time to synchronize playback reference clocks in the non-overlapping VFO area is assured). Therefore, the extended guard field can be set to have a value larger than 15 data bytes. In case of continuous recording, a wobble slip infrequently occurs, and the recording position is shifted for one wobble cycle, as described above. Since one wobble cycle corresponds to 7.75 (≈8) data bytes, this embodiment sets the length of the extended guard fields to be:

(15+8=)23 data bytes or more

In this embodiment, a margin for one data byte is added as in the buffer area, and the length of the extended guard field is set to be 24 data bytes.

The recording start position of a recording cluster 541 must be accurately set. The information recording/playback apparatus of this embodiment detects this recording start position using wobble signals recorded in advance on the rewritable or write-once information storage medium. In all areas other than the wobble sync area, patterns change from NPWs to IPWs for four wobbles. By contrast, since the wobble switching unit is partially shifted from four wobbles in the wobble sync area, the position of the wobble sync area can be detected most easily. For this reason, after detection of the position of the wobble sync area, the information recording/playback apparatus of this embodiment performs a preparation for recording processing, and starts recording. For this purpose, the start position of the recording cluster must be located in the non-modulation area immediately after the wobble sync area. In this case, the wobble sync area is allocated immediately after switching of a physical segment. The length of the wobble sync area amounts to 16 wobble cycles. Furthermore, after detection of the wobble sync area, eight wobble cycles are required in prospect of a margin for the preparation of recording processing. Therefore, the head position of the VFO area which is located at the head position of the recording cluster must be allocated at a position 24 wobbles or more after the switching position of a physical segment even in consideration of random shift.

At the overlapping position upon rewrite processing, recording processing is repeated a number of times. When rewrite processing is repeated, the physical shape of a wobble groove or wobble land changes (deteriorates), and the quality of a wobble playback signal from there drops. In this embodiment, the overlapping position upon write or additional recording processing is avoided from being recorded in the wobble sync area and wobble address area, but is recorded in the non-modulation area. Since given wobble patterns (NPW) are merely repeated in the non-modulation area, even when the wobble playback signal quality partially deteriorates, the deteriorated wobble playback signal can be interpolated using neighboring wobble playback signals. Since the overlapping position upon rewrite or additional recording processing is set to be located in the non-modulation area, deterioration of the wobble playback signal quality due to the shape deterioration in the wobble sync area or wobble address area can be prevented, and a stable wobble detection signal from wobble address information can be guaranteed.

The single-sided, single-layer information storage medium has been mainly described. A single-sided, multi-layer (single-sided, double-layer in this case), write-once information storage medium will be described below. A description of the same configurations as those in the single-sided, single-layer medium will be omitted, and only differences will be explained.

<<Measurement Condition>>

The characteristics of storage media are determined by the specification, and whether or not each storage medium satisfies the specification must be tested before distribution of storage media. For this purpose, an apparatus for measuring the disc characteristics is required, and the specification also determines the measurement conditions of the measurement apparatus. The characteristics of an optical head used to measure the characteristics of media are specified as follows:

Wavelength (λ): 405±5 nm

Polarization: circular polarization

Polarization beam splitter: used

Numerical aperture: 0.65±0.01

Light intensity at pupil edge of objective lens: 55 to 70% of maximum intensity level

Wavefront aberration after passage through ideal substrate: 0.033λ (max)

Normalized detector size on disc:

100<A/M2<144 μm2

where

A: central detector area of optical head

M: transverse magnification from disc to detector

A photodetector must be set at a position closer to the objective lens side than a focal point position. This is to determine that the photodetector is indispensably located in front of the focal point position to suppress generation of variations in detection values due to different influences of inter-layer crosstalk depending on the positions of the photodetector. Note that the focal point position is an image point of an optical system in a reflecting optical path from the disc.

Relative intensity noise (RIN)*of laser diode: −125 dB/Hz (max)

*RIN(dB/Hz)=10 log[(AC output density/Hz)/DC output]

<<Sectional Structure of Write-Once, Single-Sided, Double-Layer Disc>>

FIG. 23 is a sectional view of a write-once, single-sided, double-layer disc. The single-sided, double-layer disc has a first transparent substrate 2-3, which is formed of polycarbonate, on the light incidence surface (read-out surface) side of a laser beam 7 coming from an objective lens. The first transparent substrate 2-3 has translucency with respect to the wavelength of the laser beam. The wavelength of the laser beam is 405 (±5) nm.

A first recording layer (layer 0) 3-3 is formed on a surface opposite to the light incidence surface of the first transparent substrate 2-3. Pits according to recording information are formed on the first recording layer 3-3. A light semi-transparent layer 4-3 is formed on the first recording layer 3-3.

A space layer 7 is formed on the light semi-transparent layer 4-3. The space layer 7 serves as a transparent substrate of layer 1, and has translucency for the wavelength of the laser beam.

A second recording layer (layer 1) 3-4 is formed on the surface opposite to the light incidence surface of the space layer 7. Pits according to recording information are formed on the second recording layer 3-4. A light reflecting layer 4-4 is formed on the second recording layer 3-4. A substrate 8 is formed on the light reflecting layer 4-4.

<<Thickness of Space Layer 7>>

The thickness of the space layer 7 in the write-once, single-sided, double-layer disc is 25.0±5.0 μm. If the space layer 7 is thin, inter-layer crosstalk is large, and it is difficult to manufacture. Hence, a certain thickness is specified. On a single-sided, double-layer read-only storage medium, the thickness of the space layer 7 is 20.0±5.0 μm. Since the write-once medium has a larger influence of inter-layer crosstalk than the read-only medium, the space layer 7 of the write-once medium is slightly thicker than that of the read-only medium, and the central value of the thickness of the space layer 7 is specified to be 25 μm or more.

<<Reflectance Including Birefringence>>

The reflectance of the system lead-in area and system lead-out area of an “H→L” disc is 4.5 to 9.0%, and that of an “L→H” disc is 4.5 to 9.0%.

The reflectance of the data lead-in area, data area, middle area, and data lead-out area of the “H→L” disc is 4.5 to 9.0%, and that of the “L→H” disc is 4.5 to 9.0%.

The reflectance is better as it is higher, but it is limited, and the number of times of repetitive playback and playback signal characteristics are determined to meet predetermined criteria. Since the recording layer of layer 0 must be semi-transparent, its reflectance is lower than that of a single-layer medium.

<<Inter-layer Crosstalk>>

As described above, the single-sided, multi-layer storage medium suffers a problem that reflected light from another layer influences a playback signal. More specifically, during playback of one layer (e.g., layer 1), if the recording state of a signal on the other layer (e.g., layer 0) irradiated with the playback light beam of layer 1 changes, the signal of layer 1 during playback offsets due to its crosstalk, thus posing a problem. Upon recording a signal on layer 1, an optimal recording power varies depending on whether layer 0 has been recorded or has not been recorded yet, thus posing another problem. These problems are posed due to changes in transmittance and reflectance of the storage medium of layer 0 depending on the recording state or non-recording state, a limitation of an increase in thickness of the space layer owing to suppression of optical aberrations. It is very difficult to physically reduce such characteristics. To solve these problems, a characteristic feature of the optical disc of the present invention lies in that the disc is free from any signal offset since a clearance (a recording state constant area) is formed on each layer.

<<General Parameter>>

Table 3 shows general parameters of a write-once, single-sided, double-layer disc compared to those of the write-once, single-sided, single-layer disc.

TABLE 3
General parameter setting example on write-once information storage medium

| Parameter | | Single-layer structure | Double-layer structure |
|---|---|---|---|
| User available recording capacity | | 15 Gbytes/side | 30 Gbytes/side |
| Use wavelength | | 405 nm | 405 nm |
| NA value of objective lens | | 0.65 | 0.65 |
| Data bit length | (A) | 0.306 μm | 0.306 μm |
| | (B) | 0.153 μm | 0.153 μm |
| Channel bit length | (A) | 0.204 μm | 0.204 μm |
| | (B) | 0.102 μm | 0.102 μm |
| Minimum mark/pit length (2T) | (A) | 0.408 μm | 0.408 μm |
| | (B) | 0.204 μm | 0.204 μm |
| Maximum mark/pit length (13T) | (A) | 2.652 μm | 2.652 μm |
| | (B) | 1.326 μm | 1.326 μm |
| Track pitches | (A) | 0.68 μm | 0.68 μm |
| | (B) | 0.40 μm | 0.40 μm |
| Physical address setting method | (B) | Wobble address | Wobble address |
| Outer diameter of information storage medium | | 120 mm | 120 mm |
| Total thickness of information storage medium | | 1.20 mm | 1.20 mm |
| Diameter of center hold | | 15.0 mm | 15.0 mm |
| Inner radius of data area DTA | | 24.1 mm | 24.6 mm (Layer 0) |
| | | | 24.7 mm (Layer 1) |
| Outer radius of data area DTA | | 58.0 mm | 58.1 mm |
| Sector size | | 2048 bytes | 2048 bytes |
| ECC | | Reed-Solomon product code | Reed-Solomon product code |
| (Error Correction Code) | | RS(208,192,17) × RS(182,172,11) | RS(208,192,17) × RS(182,172,11) |
| ECC block size | | 32 physical sectors | 32 physical sectors |
| Modulation system | | ETM, RLL(1, 10) | ETM, RLL(1, 10) |
| Correctable error length | | 7.1 mm | 7.1 mm |
| Linear velocity | | 6.61 m/s | 6.61 m/s |
| Channel bit transfer rate | (A) | 32.40 Mbps | 32.40 Mbps |
| | (B) | 64.80 Mbps | 64.80 Mbps |
| User data transfer rate | (A) | 18.28 Mbps | 18.28 Mbps |
| | (B) | 36.55 Mbps | 36.55 Mbps |

(A) denotes numerical values in system lead-in area SYLDI and system lead-out area SYLDO
(B) denotes numerical values in data lead-in area DTLDI, data area DTA, middle area, and data lead-out area DTLDO

The general parameters of the write-once, single-sided, double-layer disc are nearly the same as those of the single-layer disc, except for the following points. The recording capacity that the user can use is 30 GB, the inner radius of the data area is 24.6 mm (layer 0) and 24.7 mm (layer 1), and the outer radius of the data area is 58.1 mm (common to layers 0 and 1).

<<Format of Information Area>>

The information area which is formed to extend across two layers includes seven areas: the system lead-in area, connection area, data lead-in area, data area, data lead-out area, system lead-out area, and middle area. Since the middle layer is formed on each layer, a playback beam can be moved from layer 0 to layer 1 (see FIG. 34). The data area records main data. The system lead-in area contains control data and reference codes. The data lead-out area allows continuous, smooth read-out processing.

<<Lead-Out Area>>

The system lead-in area and system lead-out area include tracks defined by embossed pits. The data lead-in area, data area, and middle area of layer 0, and the middle area, data area, and data-lead out area of layer 1 include groove tracks. The groove track is continuous from the start position of the data lead-in area of layer 0 to the end position of the middle area, and is also continuous from the start position of the middle area of layer 1 to the end position of the data lead-out area. By adhering single-sided, double-layer discs, a double-sided, double-layer disc having two read-out surfaces can be formed.

Respective tracks in the system lead-in area and system lead-out area are divided into data segments.

Tracks in the data lead-in area, data area, data lead-out area, and middle area are divided into PS blocks. Each PS block is divided into seven physical segments. Each physical segment has 11067 bytes.

<<Lead-In Area, Lead-Out Area>>

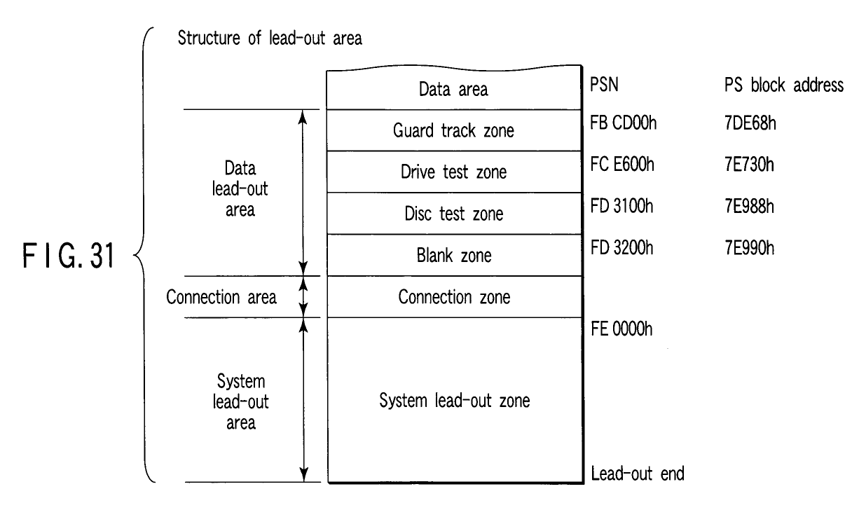

FIG. 31 shows an overview of the lead-in area and lead-out area. The boundaries of respective zones and areas of the lead-in area, lead-out area, and middle area must match those of data segments.

The system lead-in area, connection area, data lead-in area, and data area are formed on the inner periphery side of layer 0 in turn from the innermost periphery. The system lead-out area, connection area, data lead-out area, and data area are formed on the inner periphery side of layer 1 in turn from the innermost periphery. In this manner, since the data lead-in area which includes a management area is formed only on layer 0, when layer 1 undergoes finalization, information of layer 1 is also written in the data lead-in area of layer 0. In this way, all pieces of management information can be obtained by reading only layer 0 upon start-up, and each of layers 0 and 1 need not be read. In order to record data on layer 1, data must be fully recorded on layer 0. The management area is padded at the time of finalization.

The system lead-in area of layer 0 includes an initial zone, buffer zone, control data zone, and buffer zone in turn from the inner periphery side. The data lead-in area of layer 0 includes a blank zone, guard track zone, drive test zone, disc test zone, blank zone, RMD duplication zone, L-RMD (recording position management data), R-physical format information zone, and reference code zone in turn from the inner periphery side. The start address (inner periphery side) of the data area of layer 0 has a difference from the end address (inner periphery side) of the data area of layer 1 due to the presence of a clearance, and the end address (inner periphery side) the data area of layer 1 is located on the outer periphery side of the start address (inner periphery side) of the data area of layer 0.

The data lead-out area of layer 1 includes a blank zone, disc test zone, drive test zone, and guard track zone in turn from the inner periphery side.

The blank zone is a zone on which grooves are formed but no data is recorded. The guard track zone records a specific pattern for a test, i.e., data “00” before modulation. The guard track zone of layer 0 is formed for recording on the disc test zone and drive test zone of layer 1. For this reason, the guard track zone of layer 0 corresponds to a range defined by adding at least a clearance to the disc test zone and drive test zone of layer 1. The guard track zone of layer 1 is formed for recording on the drive test zone, disc test zone, blank zone, RMD duplication zone, L-RMD, R-physical format information zone, and reference code zone of layer 0. For this reason, the guard track zone of layer 1 corresponds to a range defined by adding at least a clearance to the drive test zone, disc test zone, blank zone, RMD duplication zone, L-RMD, R-physical format information zone, and reference code zone of layer 0.

<<Track Path>>

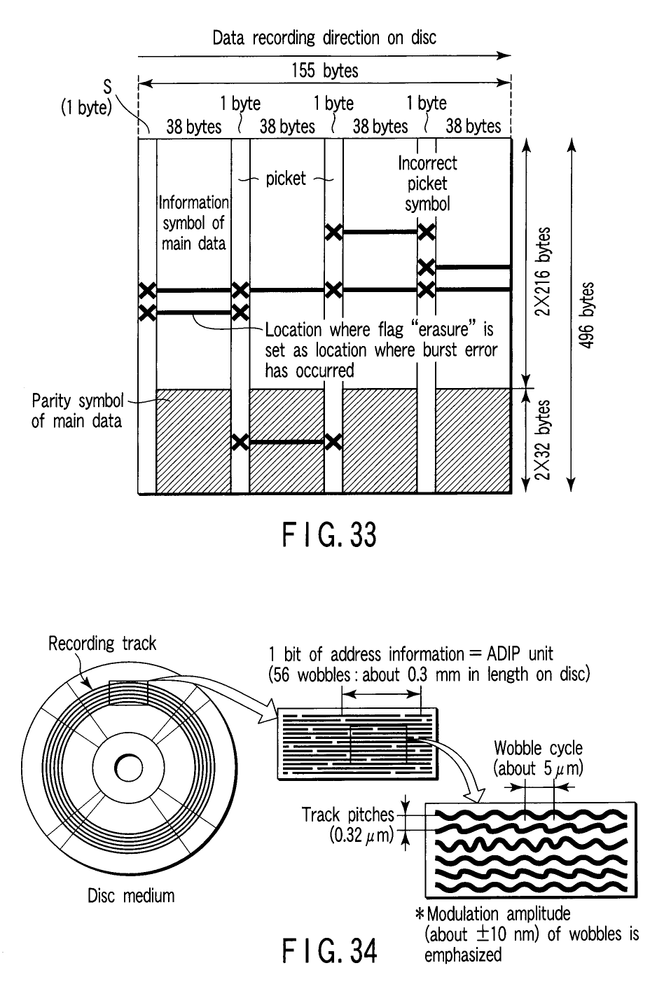

This embodiment adopts opposite track paths shown in FIG. 33 to maintain continuity of recording from layer 0 to layer 1. In sequential recording, recording on layer 1 does not start unless recording on layer 0 is complete.

<<Physical Sector Layout and Physical Sector Number>>

Each PS block includes 32 physical sectors. The physical sector number (PSN) of layer 0 on an HD DVD-R for the single-sided, double-layer disc is successively incremented in the system lead-in area, and from the beginning of the data lead-in area to the end of the middle area, as shown in FIG. 34. However, the PSN of layer 1 assumes inverted bits to those of layer 0, and is successively incremented from the beginning of the middle area (outer side) to the end of the data lead-out area (inner side) and from the outer side of the system lead-out area to the inner side of the system lead-out area.

A numerical value of the bit inversion is calculated so that a bit value “1” becomes “0” (and vice versa). The physical sectors of respective layers whose PSNs are bit-inverted have nearly the same distances from the center of the disc.

A physical sector whose PSN is X is included in a PS block with a PS block address which has a value calculated by dividing X by 32, and omitting fractions.

The PSNs of the system lead-in area are calculated to have that of a physical sector at the end position of the system lead-in area as “131071” (01 FFFFh).

The PSNs of layer 0 except for the system lead-in area are calculated to have that of a physical sector at the start position of the data area after the data lead-in area as “262144” (04 0000h). The PSNs of layer 1 except for the system lead-out area are calculated to have that of a physical sector at the start position of the data area after the middle area as “9184256” (8C 2400h).

<<Physical Segment Structure>>

The data lead-in area, data area, data lead-out area, and middle area comprise physical segments. Each physical segment is designated by a physical segment order and PS block address.

<<Structure of Lead-In Area>>

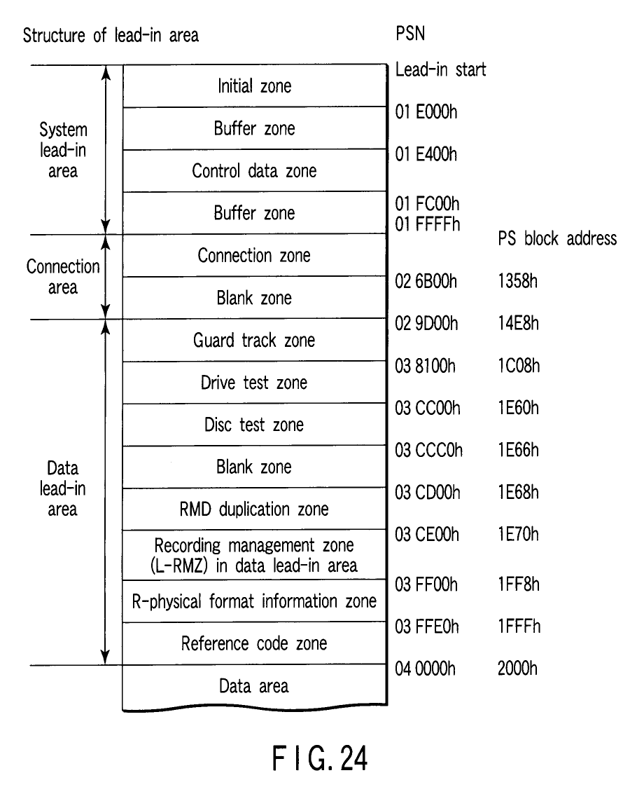

FIG. 24 shows the structure of the lead-in area of layer 0. In the system lead-in area, an initial zone, buffer zone, control data zone, and buffer zone are allocated in turn from the inner periphery side. In the data lead-in area, a blank zone, guard track zone, drive test zone, disc test zone, blank zone, RMD duplication zone, recording management zone in the data lead-in area (L-RMZ), R-physical format information zone, and reference code zone are allocated in turn from the inner periphery side.

<<Details of System Lead-In Area>>

The initial zone includes embossed data segments. Main data of a data frame recorded as a data segment of the initial zone is set to be “00h”.

The buffer zone includes 32 data segments, i.e., 1024 physical sectors. Main data of a data frame recorded as a data segment of this zone is set to be “00h”.

The control data zone includes embossed data segments. Each data segment includes embossed control data. The control data includes 192 data segments to have the PSN=“123904” (01 E400h) as a start point.

Table 4 shows physical format information in the control data zone.

TABLE 4
Physical format information

| Byte position (BP) | Contents |
|---|---|
| 0 | Book type and part version |
| 1 | Disk size and maximum possible data transfer |
| 2 | Disk structure |
| 3 | Recording density |
| 4-15 | Data area allocation |
| 16 | BCA descriptor |
| 17 | Revision number of highest recording speed |
| 18 | Revision number of lowest recording speed |
| 19-25 | Revision number table |
| 26 | Class |
| 27 | Extended part version |
| 28-31 | Reserved field |
| 32 | Actual number of highest playback speed |
| 33 | Layer format information |
| 34-127 | Reserved field |
| 128 | Mark polarity descriptor |
| 129 | Speed |
| 130 | Rim intensity value along circumferential direction |
| 131 | Rim intensity value along radial direction |
| 132 | Laser power upon playback |
| 133 | Actual number of lowest recording speed |
| 134 | Actual number of second lowest recording speed |
| 135 | Actual number of third lowest recording speed |
| 136 | Actual number of fourth lowest recording speed |
| 137 | Actual number of fifth lowest recording speed |
| 138 | Actual number of sixth lowest recording speed |
| 139 | Actual number of seventh lowest recording speed |
| 140 | Actual number of eighth lowest recording speed |
| 141 | Actual number of ninth lowest recording speed |
| 142 | Actual number of 10th lowest recording speed |
| 143 | Actual number of 11th lowest recording speed |
| 144 | Actual number of 12th lowest recording speed |
| 145 | Actual number of 13th lowest recording speed |
| 146 | Actual number of 14th lowest recording speed |
| 147 | Actual number of 15th lowest recording speed |
| 148 | Actual number of highest recording speed |
| 149 | Reflectance of data area (layer 0) |
| 150 | Push-pull signal (layer 0) |
| 151 | On-track signal (layer 0) |
| 152 | Reflectance of data area (layer 1) |
| 153 | Push-pull signal (layer 1) |
| 154 | On-track signal (layer 1) |
| 155-2047 | Reserved field |

Note:
BP0-BP31 are data common to DVD family
BP32-BP2047 are data unique to each block

The functions of respective byte positions (BP) will be described below. The values of a read power, recording speeds, reflectance of the data area, push-pull signal, and on-track signal shown in BP132 to BP154 are examples. The disc manufacturer can select actual values of them from the values which satisfy the specification of emboss information and that of the characteristics of user data after recording.

Table 5 shows details of a data area layout in BP4 to BP15.

TABLE 5
Data area allocation

| Byte position (BP) | Contents |
|---|---|
| 4 | 00h |
| 5-7 | Start PSN of data area (04 0000h) |
| 8 | 00h |
| 9-11 | Maximum PSN of data recordable area (FB CCFFh) |
| 12 | 00h |
| 13-15 | End PSN of layer 0 |

BP149 and BP152 designate the reflectance values of the data areas of layer 0 and layer 1. For example, 0000 1010b indicate 5%. An actual reflectance value is designated by:

Actual reflectance=value×(1/2)

BP150 and BP153 designate push-pull signal values of layer 0 and layer 1. Bit b7 designates the track shape of the disc of respective layers. Bits b6 to b0 designates the amplitude of the push-pull signal.

Track shape: 0b (track on groove)
1b (track on land)

Push-pull signal: for example, 010 1000b indicate 0.40.

An actual amplitude of the push-pull signal is designated by:

Actual amplitude of push-pull signal=value×(1/100)

BP151 and BP154 designate the amplitude values of the on-track signals of layer 0 and layer 1.

On-track signal: for example, 0100 0110b indicate 0.70.

An actual amplitude of the on-track signal is designated by:

Actual amplitude of on-track signal=value×(1/100)

<<Connection Area>>

The connection area of layer 0 is formed for the purpose of connecting the system lead-in area and data lead-in area. The distance between the central line of the end physical sector whose PSN=“01 FFFFh” of the system lead-in area, and that of the start physical sector whose PSN=“02 6B00h” of the data lead-in area falls within the range from 1.36 to 5.10 μm. In case of a single-layer medium, an upper limit is 10.20 μm. This is because the double-layer medium should have smaller distances due to the presence of inter-layer crosstalk. The connection area has neither embossed pits nor grooves.

<<Details of Data Lead-In Area>>

Each data segment of the blank zone does not record any data.

Each data segment of the guard track zone is padded with “00h” before recording on layer 1.

The disc test zone is prepared for the purpose of the quality test by the disc manufacturer.

The drive test zone is prepared for the purpose of the test by a drive. This zone must be recorded from an outer PS block to an inner PS block. All data segments of this zone must be recorded before finalization of the disc.

The RMD duplication zone includes an RDZ lead-in, as shown in FIG. 25. The RDZ lead-in must be recorded before the first RMD of the L-RMZ is recorded. Other fields of the RMD duplication zone must be reserved and padded with “00h”. The RDZ lead-in has a size of 64 KB, and must include a system reserved field (48 KB) and unique ID (unique identifier) field (16 KB). Data of the system reserved field is set to be “00h”. The unique ID field includes eight units, each has information having a size of 2 KB. Each unit includes a drive manufacturer ID, serial number, model number, unique disc ID, and reserved field.

The recording management zone (L-RMZ) in the data lead-in area must be recorded in the PSN range from “03 CE00h” to “03 FFFFh”. The recording management zone RMZ includes recording management data RMD. An unrecorded area of the L-RMZ must be recorded with the current recording management data RMD before finalization of the disc.

The recording management data RMD in the data lead-in area must store information about the recording position of the disc. The size of the RMD is 64 KB, and FIG. 26 shows the data configuration of the recording management data RMD.

Each RMD must include 2048-byte main data, and must be recorded by predetermined signal processing.

RMD field 0 designates general information of the disc, and Table 6 shows the contents of this field.

TABLE 6

| Byte position (BP) | Contents |
|---|---|
| 0-1 | RMD format |
| 2 | Disk status |
| 3 | Padding status |
| 4-21 | Unique disk ID |
| 22-33 | Data area allocation |
| 34-45 | Updated data area allocation |
| 46-47 | Reserved field |
| 48-79 | Drive test zone allocation |
| 80-2047 | Reserved field |

Disc status of BP2 indicates the following contents.

00h: indicates that the disc is empty

01h: indicates that the disc is in recording mode 1

02h: indicates that the disc is in recording mode 2

03h: indicates that the disc has been finalized

08h: indicates that the disc is in recording mode U

Other values are reserved.

Respective bits of padding status of BP3 indicate the following contents.

b7 . . . 0b: indicates that the inner periphery side guard zone of layer 0 is not padded
1b: indicates that the inner periphery side guard zone of layer 0 is padded

b6 . . . 0b: indicates that the inner periphery side test zone of layer 0 is not padded
1b: indicates that the inner periphery side test zone of layer 0 is padded

b5 . . . 0b: indicates that the RMD duplication zone of layer 0 is not padded
1b: indicates that the RMD duplication zone of layer 0 is padded
b4 . . . 0b: indicates that the recording management zone of layer 0 is not padded
1b: indicates that the recording management zone of layer 0 is padded

b3 . . . 0b: indicates that the outer periphery side guard zone of layer 0 is not padded
1b: indicates that the outer periphery side guard zone of layer 0 is padded

b2 . . . 0b: indicates that the outer periphery side test zone of layer 0 is not padded
1b: indicates that the outer periphery side test zone of layer 0 is padded

b1 . . . 0b: indicates that the outer periphery side guard zone of layer 1 is not padded
1b: indicates that the outer periphery side guard zone of layer 1 is padded

b0 . . . 0b: indicates that the inner periphery side guard zone of layer 1 is not padded
1b: indicates that the inner periphery side guard zone of layer 1 is padded

RMD field 1 includes optimal power control (OPC) related information required to determine an optimal recording power. RMD field 1 can record OPC related information of a maximum of four drives which coexist in the system, as shown in Tables 7 and 8.

TABLE 7
RMD field 1

| Byte | | |
|---|---|---|
| position (BP) | | Contents |
| 0-31 | #1 | Manufacturer identification number of disk drive |
| | | (described in binary code) |
| 32-47 | | Serial number of disk drive (described in ASCII code) |
| 48-63 | | Model number of disk drive (described in ASCII code) |
| 64-71 | | Time stamp |
| 72-75 | | Inner periphery side test zone address (layer 0) |
| 76-79 | | Outer periphery side test zone address (layer 0) |
| 80-103 | | Running OPC information |
| 104-105 | | DSV (Digital Sum Value) |
| 106 | | Test zone use descriptor |
| 107 | | Reserved field |
| 108-111 | | Inner periphery side test zone address (layer 1) |
| 112-115 | | Outer periphery side test zone address (layer 1) |
| 116-127 | | Reserved field |
| 128-191 | | Drive unique information |
| 192-255 | | Reserved field |
| 256-287 | #2 | Manufacturer identification number of disk drive |
| | | (described in binary code) |
| 288-303 | | Serial number of disk drive (described in ASCII code) |
| 304-319 | | Model number of disk drive (described in ASCII code) |
| 320-327 | | Time stamp |
| 328-331 | | Inner periphery side test zone address (layer 0) |
| 332-335 | | Outer periphery side test zone address (layer 0) |
| 336-359 | | Running OPC information |
| 360-361 | | DSV |
| 362 | | Test zone use descriptor |
| 363 | | Reserved field |
| 364-367 | | Inner periphery side test zone address (layer 1) |
| 368-371 | | Outer periphery side test zone address (layer 1) |
| 372-383 | | Reserved field |
| 384-447 | | Drive unique information |
| 448-511 | | Reserved field |

TABLE 8
RMD field 1

| Byte | | |
|---|---|---|
| position (BP) | | Contents |
| 512-543 | #3 | Manufacturer identification number of disk drive |
| | | (described in binary code) |
| 544-559 | | Serial number of disk drive (described in ASCII code) |
| 560-575 | | Model number of disk drive (described in ASCII code) |
| 576-583 | | Time stamp |
| 584-587 | | Inner periphery side test zone address (layer 0) |
| 588-591 | | Outer periphery side test zone address (layer 0) |
| 592-615 | | Running OPC information |
| 616-617 | | DSV |
| 618 | | Test zone use descriptor |
| 619 | | Reserved field |
| 620-623 | | Inner periphery side test zone address (layer 1) |
| 624-627 | | Outer periphery side test zone address (layer 1) |
| 628-639 | | Reserved field |
| 640-703 | | Drive unique information |
| 704-767 | | Reserved field |
| 768-799 | #4 | Manufacturer identification number of disk drive |
| | | (described in binary code) |
| 800-815 | | Serial number of disk drive (described in ASCII code) |
| 816-831 | | Model number of disk drive (described in ASCII code) |
| 832-839 | | Time stamp |
| 840-843 | | Inner periphery side test zone address (layer 0) |
| 844-847 | | Outer periphery side test zone address (layer 0) |
| 848-871 | | Running OPC information |
| 872-873 | | DSV |
| 874 | | Test zone use descriptor |
| 875 | | Reserved field |
| 876-579 | | Inner periphery side test zone address (layer 1) |
| 880-883 | | Outer periphery side test zone address (layer 1) |
| 884-895 | | Reserved field |
| 896-959 | | Drive unique information |
| 960-1023 | | Reserved field |

| | |
|---|---|
| 1024-2047 | Reserved field |

When the number of drives is 1, the OPC related information is recorded in field #1, and other fields are set to be “00h”. In any case, unused fields of RMD field 1 are set to be “00h”. The OPC related information of the current drive is always recorded in field #1. If information (drive manufacturer ID, serial number, model number) of the current drive is not stored in field #1 of the current RMD, three sets of information in fields #1 to #3 of the current RMD are respectively copied to fields #2 to #4 of new RMD, and information in field #4 of the current RMD is discarded. If field #1 of the current RMD stores the current drive information, the information in field #1 is updated, and sets of information in other fields are copied to fields #2 to #4 of new RMD.

Inner periphery side test zone address of layer 0 in BP72 to BP75, BP328 to BP331, BP584 to BP587, and BP840 to BP843:

Each of these fields designates a minimum PS block address of the drive test zone in the data lead-in area, which has undergone the latest power calibration. When the current drive does not execute power calibration on the inner periphery side test zone of layer 0, the inner periphery side test zone address of layer 0 of the current RMD is copied to that of new RMD. If these fields are set to be “00h”, this test zone is not used.

Outer periphery side test zone address of layer 0 in BP76 to BP79, BP332 to BP335, BP588 to BP591, and BP844 to BP847:

Each of these fields designates a minimum PS block address of the drive test zone in the middle area of layer 0, which has undergone the latest power calibration. When the current drive does not execute power calibration on the outer periphery side test zone of layer 0, the outer periphery side test zone address of layer 0 of the current RMD is copied to that of new RMD. If these fields are set to be “00h”, this test zone is not used.

Test zone use descriptor in BP106, BP362, BP618, and BP874:

These fields designate use methods of four test zones.

Respective bits are assigned as follows.

b7 to b4 . . . reserved fields

b3 . . . 0b: the drive did not use the inner periphery side test zone of layer 0
1b: the drive used the inner periphery side test zone of layer 0

b2 . . . 0b: the drive did not use the outer periphery side test zone of layer 0
1b: the drive used the outer periphery side test zone of layer 0

b1 . . . 0b: the drive did not use the inner periphery side test zone of layer 1
1b: the drive used the inner periphery side test zone of layer 1

b0 . . . 0b: the drive did not use the outer periphery side test zone of layer 1
1b: the drive used the outer periphery side test zone of layer 1

Inner periphery side test zone address of layer 1 in BP108 to BP111, BP364 to BP367, BP620 to BP623, and BP876 to BP879:

Each of these fields designates a minimum PS block address of the drive test zone in the data lead-out area, which has undergone the latest power calibration. When the current drive does not execute power calibration on the inner periphery side test zone of layer 1, the inner periphery side test zone address of layer 1 of the current RMD is copied to that of new RMD. If these fields are set to be “00h”, this test zone is not used.

Outer periphery side test zone address of layer 1 in BP112 to BP115, BP368 to BP371, BP624 to BP627, and BP880 to BP883:

Each of these fields designates a minimum PS block address of the drive test zone in the middle area of layer 1, which has undergone the latest power calibration. When the current drive does not execute power calibration on the outer periphery side test zone of layer 1, the outer periphery side test zone address of layer 1 of the current RMD is copied to that of new RMD. If these fields are set to be “00h”, this test zone is not used.

RMD field 2 designates user dedicated data. If this field is not used, “00h” is designated in each field. BP0 to BP2047 are fields which can be used for user dedicated data.

All bytes of RMD field 3 are reserved, and are set to be “00h”.

RMD field 4 designates information of an R zone. Table 9 shows the contents of this field. A part of a data recordable area reserved to record user data is called an R zone. The R zone is classified into two types depending on the recording conditions. In an open R zone, user data can be added. In a complete R zone, user data cannot be added. Three or more open R zones cannot exist in the data recordable area. A part of a data recordable area which is not reserved for data recording is called an invisible R zone. An area that follows the R zone can be reserved for an invisible R zone. If data cannot be added any more, there is no invisible R zone.

The number of invisible R zones in BP0 and BP1 is the total number of invisible R zones, open R zones, and complete R zones.

TABLE 9
RMD field 4

| Byte position (BP) | Contents |
|---|---|
| 0-1 | Invisible R zone number |
| 2-3 | First open R zone number |
| 4-5 | Second open R zone number |
| 6-15 | Reserved field |
| 16-19 | Start PSN of R zone #1 |
| 20-23 | Last recorded PSN of R zone #1 |
| 24-27 | Start PSN of R zone #2 |
| 28-31 | Last recorded PSN of R zone #2 |
| . | . |
| . | . |
| . | . |
| 2040-2043 | Start PSN of R zone #254 |
| 2044-2047 | Last recorded PSN of R zone #254 |

RMD fields 5 to 21 designate information of the R zone. Table 10 shows the contents of these fields. If these fields are not used, all of them are set to be “00h”.

TABLE 10
RMD field 5-21

| Byte position (BP) | Contents |
|---|---|
| 0-3 | Start PSN of R zone #n |
| 4-7 | Last recorded PSN of R zone #n |
| 8-11 | Start PSN of R zone #n + 1 |
| 12-15 | Last recorded PSN of R zone #n + 1 |
| . | . |
| . | . |
| . | . |
| 2044-2047 | Last recorded PSN of R zone #n + 255 |

The R-physical format information zone in the data lead-in area includes seven PS blocks (224 physical sectors) to have the PSN=“261888” (03 FF00h) as a start point. The contents of the first PS block in the R-physical format information zone are repeated seven times. FIG. 27 shows the configuration of the PS block in the R-physical format information zone.

Table 11 shows the contents of physical format information in the data lead-in area. Table 11 is the same as Table 4 that shows the contents of the physical format information in the system lead-in area. The contents of BP0 to BP3 are copied from the physical format information in the system lead-in area. The contents of the data area layout in BP4 to BP15 are different from those in Table 11, and are shown in Table 12. The contents in BP16 to BP2047 are copied from the physical format information in the system lead-in area.

TABLE 11
R-physical format information

| Byte position (BP) | Contents |
|---|---|
| 0 | Book type and part version |
| 1 | Disk size and maximum possible data transfer |
| 2 | Disk structure |
| 3 | Recording density |
| 4-15 | Data area allocation |
| 16 | BCA descriptor |
| 17 | Revision number of highest recording speed |
| 18 | Revision number of lowest recording speed |
| 19-25 | Revision number table |
| 26 | Class |
| 27 | Extended part version |
| 28-31 | Reserved field |
| 32 | Actual number of highest playback speed |
| 33 | Layer format information |
| 34-127 | Reserved field |
| 128 | Mark polarity descriptor |
| 129 | Speed |
| 130 | Rim intensity value along circumferential direction |
| 131 | Rim intensity value along radial direction |
| 132 | Laser power upon playback |
| 133 | Actual number of lowest recording speed |
| 134 | Actual number of second lowest recording speed |
| 135 | Actual number of third lowest recording speed |
| 136 | Actual number of fourth lowest recording speed |
| 137 | Actual number of fifth lowest recording speed |
| 138 | Actual number of sixth lowest recording speed |
| 139 | Actual number of seventh lowest recording speed |
| 140 | Actual number of eighth lowest recording speed |
| 141 | Actual number of ninth lowest recording speed |
| 142 | Actual number of 10th lowest recording speed |
| 143 | Actual number of 11th lowest recording speed |
| 144 | Actual number of 12th lowest recording speed |
| 145 | Actual number of 13th lowest recording speed |
| 146 | Actual number of 14th lowest recording speed |
| 147 | Actual number of 15th lowest recording speed |
| 148 | Actual number of highest recording speed |
| 149 | Reflectance of data area (layer 0) |
| 150 | Push-pull signal (layer 0) |
| 151 | On-track signal (layer 0) |
| 152 | Reflectance of data area (layer 1) |
| 153 | Push-pull signal (layer 1) |
| 154 | On-track signal (layer 1) |
| 155-2047 | Reserved field |

TABLE 10
RMD field 5-21

| Byte position (BP) | Contents |
|---|---|
| 0-3 | Start PSN of R zone #n |
| 4-7 | Last recorded PSN of R zone #n |
| 8-11 | Start PSN of R zone #n + 1 |
| 12-15 | Last recorded PSN of R zone #n + 1 |
| . | . |
| . | . |
| . | . |
| 2044-2047 | Last recorded PSN of R zone #n + 255 |

<<Middle Area>>

The structure of the middle area is changed by middle area extension. If the volume of data recorded by the user is small, the dummy data size for finalization can be reduced by extending the middle area, and the finalization time can be shortened.

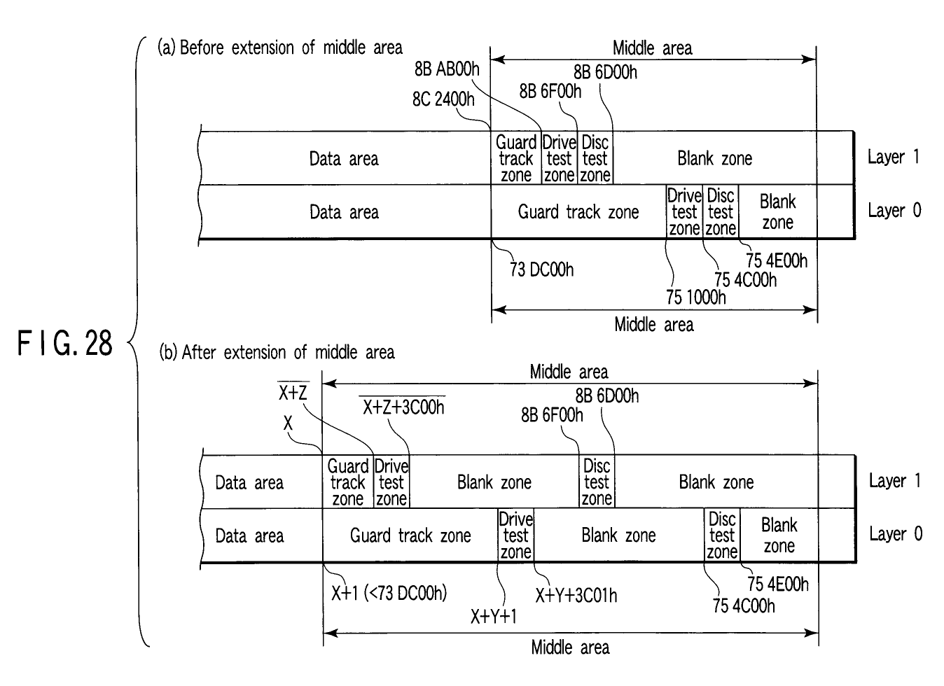

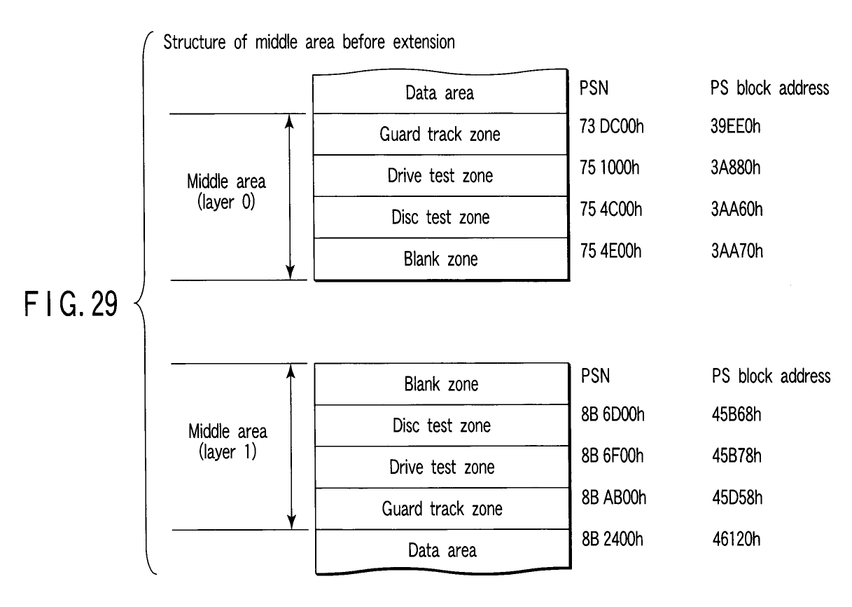

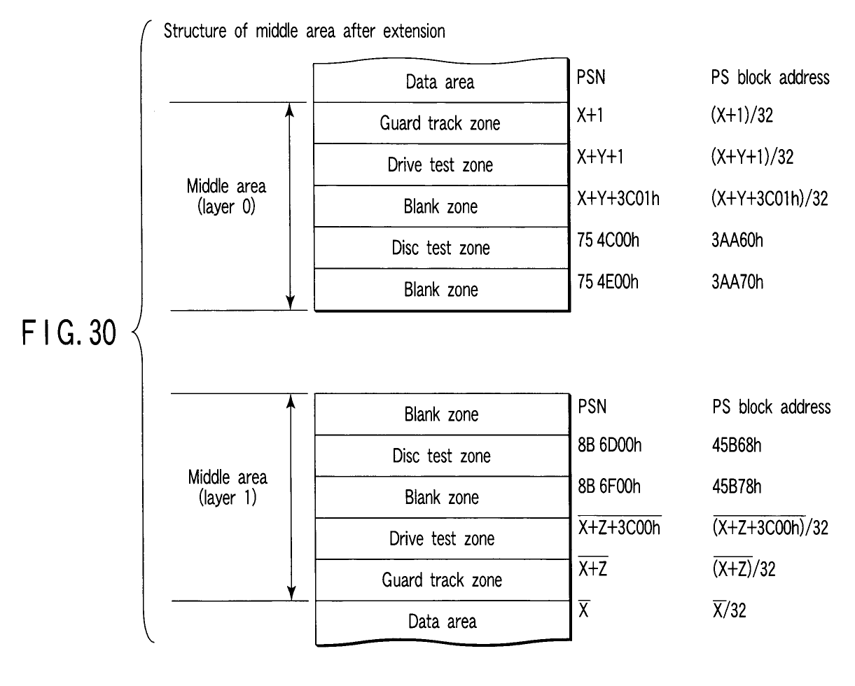

FIG. 28 shows overviews of middle area extension. Details of extension will be described later. FIGS. 29 and 30 show the structures of the middle area before and after extension. The size of the guard track zone after extension depends on the end PSN of the data area of layer 0. Table 13 shows values Y and Z as the number of physical sectors in the guard track zone.

TABLE 13
Number of physical sectors of
guard track zone

| | | | |
|---|---|---|---|
| End PSN (X) | 05 FE00H | 1E 0E00h | 42 1C00h |
| of data area | — | — | — |
| (layer 0) | 1E 0DFFh | 42 1BFFh | 73 DBFFh |
| Y (Layer 0) | 00 D400h | 01 0200h | 01 3400h |
| Z (Layer 0) | 00 4E00h | 00 6600h | 00 7F00h |

Each data segment of the guard track zone of layer 0 must be padded with “00h” before recording on layer 1. Each data segment of the guard track zone of layer 1 must be padded with “00h” before finalization of the disc.

The drive test zone is prepared for the purpose of the test by a drive. This zone must be recorded from an outer PS block to an inner PS block. All data segments of the drive test zone of layer 0 may be padded with “00h” before recording on layer 1.

The disc test zone is prepared for the purpose of the quality test by the disc manufacturer.

Each data segment of the blank zone does not include any data. The size of the outermost blank zone of layer 0 must amount to 968 PS blocks or more. The size of the outermost blank zone of layer 1 must amount to 2464 PS blocks or more.

<<Lead-Out Area>>

FIG. 31 shows the structure of the lead-out area. In the data lead-out area, a guard track zone, drive test zone, disc test zone, and blank zone are allocated in turn from the outer side. The system lead-out area includes a system lead-out zone.

Each data segment of the guard track zone must be padded with “00h” before finalization of the disc.

The drive test zone is prepared for the purpose of the test by a drive. This zone is recorded from an outer PS block to an inner PS block.

Each data segment of the blank zone does not record any data.

<<Connection Area of Layer 1>>

The connection area of layer 1 is formed for the purpose of connecting the data lead-out area and system lead-out area. The distance between the central line of the end physical sector of the data lead-out area, and that of the start physical sector whose PSN=“FE 000h” of the system lead-out area is required to fall within the range from 1.36 to 5.10 μm. The connection area has neither embossed pits nor grooves.

All main data of data frames recorded as physical sectors in the system lead-out area must be set to be “00h”.

<<Formatting>>

Initialization:

Before user data is recorded on the disc, the RMD lead-in in the RMD duplication zone must be recorded and the recording mode must be selected.

Extension of Middle Area:

Before recording on the middle area of layer 0, middle area extension can be executed. The middle area extension enlarges the middle area and reduces the data area at the same time. A default end PSN of the data area of layer 0 is “73 DBFFh”, and a default start PSN of the data area of layer 1 is “8C 2400h”. Before recording on the middle area of layer 0, the drive can re-assign a PSN of “73 DBFFh” or lower to a new end PSN of the data area of layer 0. The contents of RMD field 0 must be updated by the middle area extension, and the new end PSN of the data area of layer 0 must be recorded in the R-physical format information zone except for re-allocation of the data area by finalization.

When the middle area extension is executed and the end PSN of the data area of layer 0 becomes X (<“73 DBFFh”), the bit inverted value of X must be the start PSN of the data area of layer 1. Furthermore, the guard track zone, drive test zone, and blank zone of the middle area are re-allocated (see FIG. 28).

Requirement Before Layer 1 Recording:

Before recording on layer 1, the guard track zones of layer 0, which are allocated in the data lead-in area and middle area, must be padded with “00h” to avoid the influence (generation of inter-layer crosstalk) of layer 0. The drive test zone in the middle area of layer 0 are often padded with “00h”. When these zones are padded with “00h”, information of RMD field 0 must be updated.

<<Measurement Condition of Operation Signal of Data Lead-In Area, Data Area, Middle Area, and Data Lead-Out Area>>

An offset canceller is broadened as follows compared to a single-layer medium.

−3 dB closed loop band: 20.0 kHz to 25.0 kHz

This band in the single-layer medium is 5 kHz, but it is broadened to have a margin.

<<Burst Cutting Area (BCA) Code>>

The BCA is an area of recording information after completion of the disc manufacturing process. When a read-out signal meets the BCA code signal specification, it is permitted to describe a BCA code via a copy process using pre-pits. The BCA must be formed on layer 1 of the single-sided, double-layer disc. This is to keep the compatibility of drives since the BCA is also formed on layer 1 in a read-only medium.

<<RMD Update Condition>>

The RMD must be updated if even one of the following condition is met.

1. When at least one of the contents designated by RMD field 0 is changed

2. When the drive test zone address designated by RMD field 1 is changed

3. When the invisible R zone number, first open R zone number, or second R zone number designated by RMD field 4 is changed

4. When the difference between the PSN of the physical segment recorded last in R zone #i and that of the physical segment recorded last in R zone #i registered in the latest RMD becomes larger than 37888

Note: the RMD need not be updated as long as the data recording operation is in progress.

The RMD must not be updated when an unrecorded part of the RMZ is equal to or smaller than four PS blocks in the second or fourth condition.

<<Light Stability of Disc>>

The light stability of the disc is tested using an air-conditioned xenon lamp, and an apparatus which is compliant to ISO-105-B02.

Test conditions . . . black panel temperature: less than 40° C.

relative humidity: 70 to 80%

Disc illumination: normal illumination via a substrate

<<Recording Power>>

The recording power includes four levels, i.e., peak power, bias power 1, bias power 2, and bias power 3. These power levels indicate projection of optical power onto the read-out surface of the disc, and are used to write marks and spaces.

The peak power, bias power 1, bias power 2, and bias power 3 are described in the control data zone. A maximum peak power does not exceed 13.0 mW. A maximum bias power 1, bias power 2, and bias power 3 do not exceed 6.5 mW.

Prec as the peak power of layer 1 through the recording area of layer 0 and Punrec as the peak power of layer 1 through an unrecorded part of layer 0 must meet the following requirement.

|Prec−Punrec|<10% of Punrec

Both Prec and Punrec must meet requirement that they do not exceed 13.0 mW.

§2 B-format

Optical Disc Specification of B-format

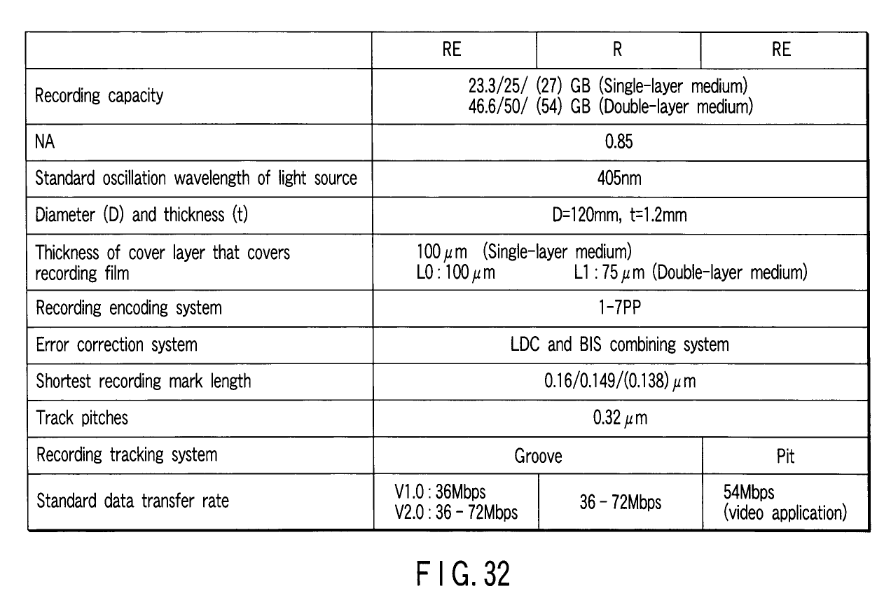

FIG. 32 shows the specification of an optical disc of a B-format which uses a blue-violet laser light source. Optical discs of the B-format are classified into a writeable type (RE disc), read-only type (ROM disc), and write-once type (R disc). However, as shown in FIG. 32, discs of these types have common specifications except for a standard data transfer rate, and it is easy to implement a drive which is compatible to discs of different types. In the existing DVD, two 0.6-nm thick disc substrates are adhered to each other. However, a disc of the B-format has a structure in which a recording layer is formed on a 1.1-nm thick disc substrate, and is covered by a 0.1-nm thick cover layer. A single-sided, double-layer medium is also specified.

[Error Correction System]

The B-format adopts an error correction system called a picket code, which can efficiently detect a burst error. Pickets are inserted in a sequence of main data (user data) at given intervals. The main data is protected by robust, efficient Reed-Solomon coding. The pickets are protected by another coding, i.e., the second, very robust, efficient Reed-Solomon coding. Upon decoding, the pickets undergo error correction first. The correction information can be used to estimate burst error positions in main data. As symbols for these positions, flags called “Erasure” used upon correcting codewords of the main data are set.

FIG. 33 shows the configuration of a picket code (error correction block). The error correction block (ECC block) of the B-format is configured to have 64-kbyte user data as a unit as in the H-format. This data is protected by a very robust Reed-Solomon LDC (long distance code).

The LCD includes 304 codewords. Each codeword includes 216 information symbols and 32 parity symbols. That is, the codeword length is 248 (=216+32) symbols. These codewords are interleaved in a vertical direction of the ECC block every 2×2 codewords, thus forming an ECC block of horizontal 152 (=304÷2) bytes×vertical 496 (=2×216+2×32) bytes.

The interleaved length of the pickets is 155×8 bytes (there are eight correction sequences of control code in 496 bytes), and the interleaved length of the user data is 155×2 bytes. Four hundreds and ninety six bytes in the vertical direction have 31 rows as a recording unit. As for the parity symbols of the main data, parity symbols for two groups are nested every other rows.

The B-format adopts a picket code which is embedded at given intervals in the form of “columns” in the ECC block. By checking an error state, a burst error is detected. More specifically, four picket columns are allocated at equal intervals in one ECC block. The pickets also have addresses. The pickets include unique parities.

Since symbols in picket columns must be corrected, pickets in three right columns are protected by error correction coding using a BIS (burst indicator subcode). This BIS includes 30 information symbols and 32 parity symbols, and the codeword length is 62 symbols. As can be seen from the ratio between the information symbols and parity symbols, very robust correction capability can be provided.

The BIS codeword is interleaved and stored in three picket columns each having 496 bytes. The numbers of parity symbols per codeword of the LDC and BIS codes are equal to each other, i.e., 32. This means that a single, common Reed-Solomon decoder can decode both the LDC and BIS.

Upon decoding data, the picket columns undergo correction processing using the BIS. With this processing, burst error locations are estimated, and flags called “Erasure” are set at these locations. These flags are used to correct the codewords of the main data.

Note that information symbols protected by the BIS code form another, additional data channel (side channel) independently of the main data. This side channel stores address information. Error correction of the address information uses dedicated Reed-Solomon coding prepared independently of the main data. This code includes five information symbols and four parity symbols. With this sub channel, high-speed, highly reliable address recognition is implemented independently of the error correction system of the main data.

[Address Format]

An RE disc is formed with very thin grooves like a spiral as recording tracks as in a CD-R disc. Recording marks are written only on convex portions of concave and convex portions of the grooves when viewed from the incoming direction of a laser beam (on-groove recording).

Address information indicating each absolute position on the disc is embedded by slightly wobbling this groove like in a CD-R disc and the like. A signal is modulated and digital data indicating “1” and “0” are superposed on the wobble shape, period, or the like. FIG. 34 shows the wobble method. The amplitude of wobbles is only ±10 nm in the disc radial direction. Fifteen six wobbles (about 0.3 mm as the length on the disc) define 1 bit of address information=an ADIP unit (to be described later).

In order to write fine recording marks with nearly no positional deviations, a stable, accurate recording clock signal must be generated. Hence, this embodiment focuses a method in which wobbles have a single principal frequency component, and grooves smoothly continue. If the single frequency is used, a stable recording clock signal can be easily generated from wobble components extracted using a filter.

Timing information and address information are appended to wobbles based on the single frequency. “Modulation” is required to append such information. The modulation method which hardly causes errors even if there are various distortions unique to an optical disc is selected.

There are the following four distortions of a wobble signal which occur on an optical disc while being sorted out depending on their causes.

(1) Disc noise: the disorder of the surface shape (surface roughness) formed on groove portions upon manufacturing, noise generated by a recording film, crosstalk noise which leaks from recorded data, and the like.

(2) Wobble shift: a phenomenon that the detection sensitivity drops due to a shift of the wobble detection position relative to the regular position in the recording/playback apparatus. Such phenomenon readily occurs immediately after a seek operation.

(3) Wobble beat: crosstalk generated between wobble signals of a track to be recorded and neighboring tracks. Such crosstalk is generated when the angular frequencies of neighboring wobbles have a difference in the CLV (constant linear velocity) rotation control method.

(4) Defect: caused by local defects such as dust and scratches on the disc surface.

The RE disc combines two different wobble modulation systems to generate a synergistic effect under the condition that these systems have high resistances against all these four different types of signal distortions. This is because the resistances against the four types of signal distortions, which are hardly achieved by only one type of modulation system, can be obtained without any side effects.

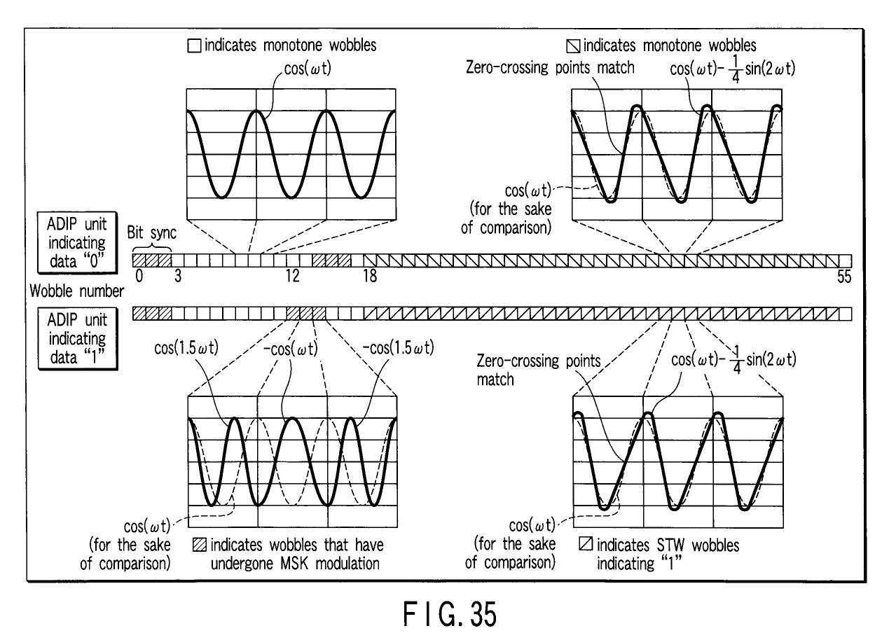

The two systems include an MSK (minimum shift keying) system and STW (saw tooth wobble) system (FIG. 35). “STW” is termed since its waveform is similar to a “sawtooth shape”.

On the RE disc, a total of 56 wobbles express 1 bit “0” or “1”. These 56 wobbles are called an integrated unit, i.e., an ADIP (address in pregroove) unit. When 83 ADIP units are successively read out, they form an ADIP word indicating one address. The ADIP word includes 24-bit address information, 12-bit auxiliary data, a reference (calibration) field, error correction data, and the like. On the RE disc, three ADIP words are assigned per RUB (recording unit block; a 64-kbyte unit) used to record main data.

The ADIP unit made up of 56 wobbles is roughly divided into the former and latter halves. The former half including wobbles #0 to #17 is modulated by the MSK system, the latter half including wobbles #18 to #55 is modulated by the STW system, and such ADIP unit is smoothly contiguous with the next ADIP unit. One ADIP unit can express 1 bit. “0” or “1” is distinguished in such a manner that the former half changes wobble positions which have undergone the MSK modulation, and the latter half changes the directions of the sawtooth shape.

The former half part of the MSK system is further divided into a field of three wobbles that have undergone the MSK modulation, and a field of monotone wobbles cos(ωt). Every ADIP unit starts from three wobbles #0 to #2 which have always undergone the MSK modulation. This is called a bit sync (an identifier indicating the start position of an ADIP unit).

After the bit sync, monotone wobbles continuously appear. Data is expressed by the number of monotone wobbles which appear until the next three wobbles which have undergone the MSK modulation. More specifically, 11 monotone wobbles represent “0”, and nine monotone wobbles represent “1”. A difference for two wobbles is used to distinguish data.

The MSK system uses a local phase change of a fundamental wave. In other words, a field free from any phase change is dominant. This field is also effectively used as that free from any phase change of the fundamental wave in the STW system.

The field that has undergone the MSK modulation has a length for three wobbles. The first wobble position has a frequency 1.5 times that of a monotone wobble (cos(1.5ωt)), the second wobble position has the same frequency as that of a monotone wobble, and the third wobble position has the frequency 1.5 times that of a monotone wobble again, thus returning the phase. In this way, the polarity of the second (central) wobble is inverted to that of a monotone wobble, and this wobble is detected. The start point of the first wobble and the end point of the third wobble are just in phase with a monotone wobble. Therefore, connection free from any discontinuous part can be attained.

On the other hand, there are two different types of waveforms of the STW system of the latter half. One waveform steeply rises toward the disc outer periphery side, and returns in gentle inclination toward the disc center side. The other waveform rises in gentle inclination, and returns steeply. The former waveform expresses data “0”, and the latter waveform expresses data “1”. Since one ADIP unit indicates an identical bit using both the MSK system and STW system, the data reliability improves.

The STW system is mathematically expressed like that a secondary harmonic wave sin(2ωt) with a ¼ amplitude is added to or subtracted from a fundamental wave cos(ωt). Note that the STW system has the same zero-crossing point as a monotone wobble even if it expresses “0” or “1”. That is, upon extracting a clock signal from the fundamental wave component common to a monotone wobble part of the MSK system, the STW system does not impose any influence on phases.

As described above, the MSK system and STW system function to cover each other's weak points.

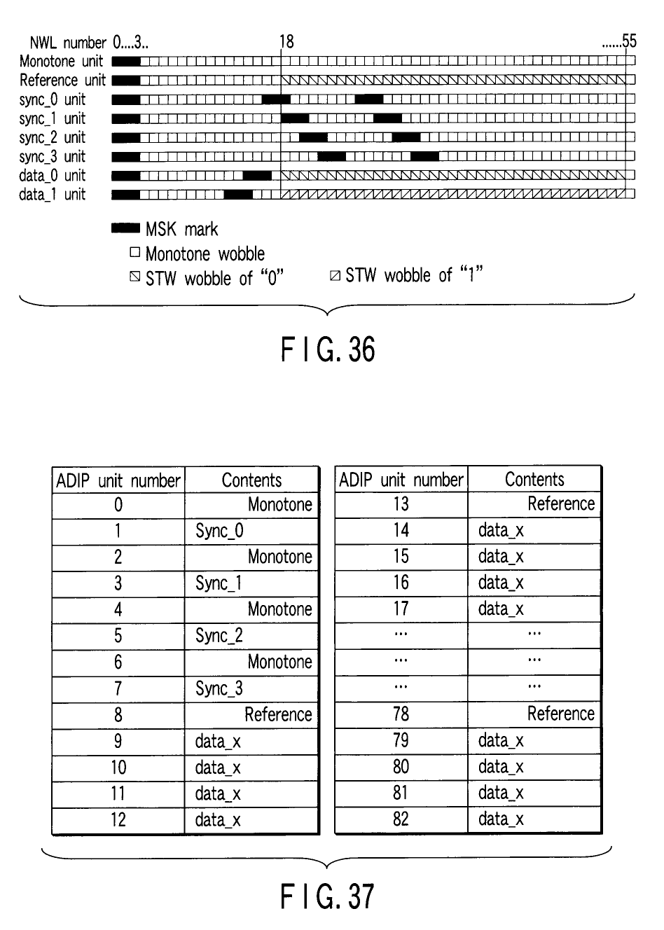

FIG. 36 shows an ADIP unit. A basic unit of an address wobble format is an ADIP unit. Each group of 56 NMLs (nominal wobble length) is called an ADIP unit. One NML is equal to 69 channel bits. An ADIP unit of a different type is defined by inserting a modulation wobble (MSK mark) at a specific position in that ADIP unit (see FIG. 35). Eighty three ADIP units form one ADIP word. A minimum segment of data to be recorded on the disc accurately matches three continuous ADIP words. Each ADIP word includes 36 information bits (24 bits of which are address information bits).

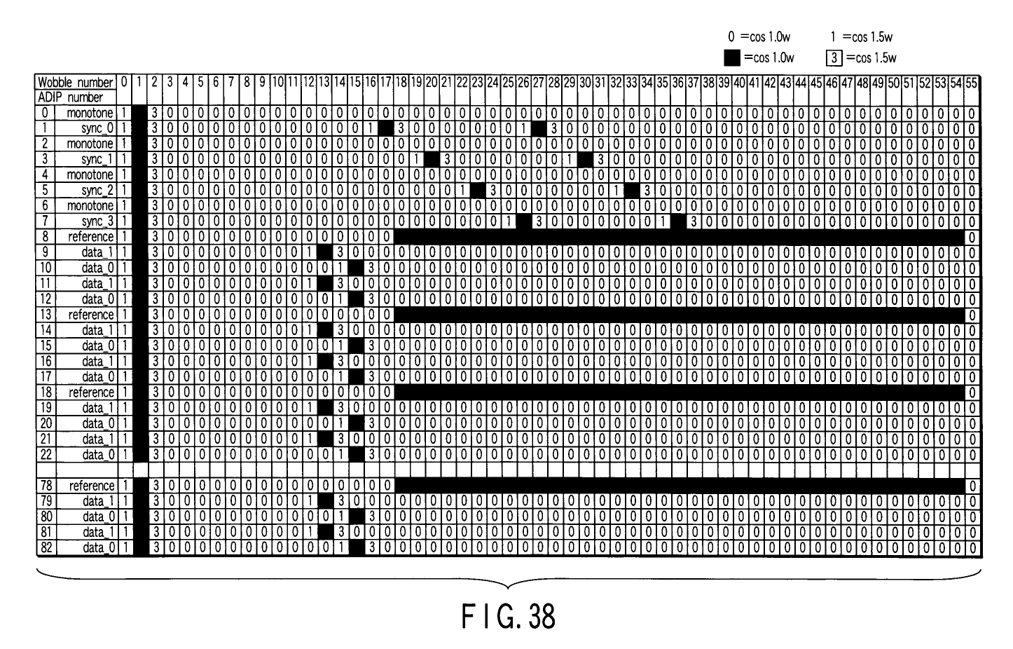

FIGS. 37 and 38 show the configuration of one ADIP word.

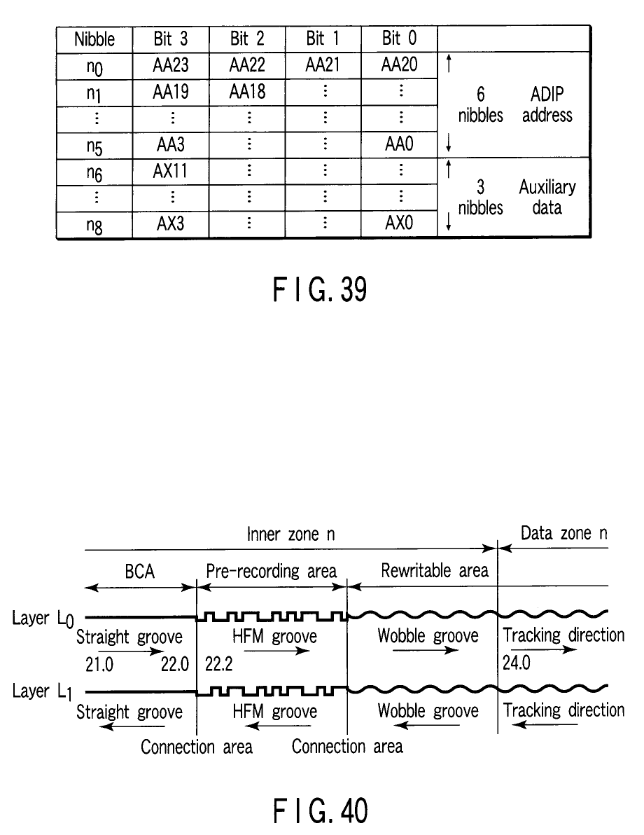

One ADIP word includes 15 nibbles, and nine nibbles are information nibbles, as shown in FIG. 39. The remaining nibbles are used for ADIP error correction. Fifteen nibbles form a codeword of Reed-Solomon codes [15, 9, 7].

The codeword consists of nine information nibbles: six information nibbles record address information, and three information nibbles record auxiliary information (e.g., disc information).

The Reed-Solomon codes [15, 9, 7] are non-systematic, and prior knowledge can increase a Hamming distance based on “informed decoding”. “Informed decoding” means that since all codewords have distance 7 and all codewords of nibble n0 commonly have distance 8, prior knowledge about n0 increases the Hamming distance. Nibble n0 includes a layer index (3 bits) and the MSB of a physical sector number. If nibble n0 is known, the distance increases from 7 to 8.

FIG. 40 shows a track structure. The track structure of the first layer (which is distant from a laser light source) and second layer of a disc having a single-sided, double-layer structure will be described below. A groove is formed to allow tracking in the push-pull system. A plurality of types of track shapes are used. The first layer L0 and second layer L1 have different tracking directions. In the first layer, the left-to-right direction in FIG. 40 is a tracking direction. In the second layer, the right-to-left direction is a tracking direction. The left side of FIG. 40 corresponds to the disc inner periphery, and the right side thereof corresponds to the outer periphery. A BCA area formed of a straight groove of the first layer, a pre-recording area formed of an HFM (High Frequency Modulated) groove, and a wobble groove area in a rewritable area correspond to the lead-in area of the H-format. A wobble groove area in a rewritable area of the second layer, a pre-recording area formed of an HFM (High Frequency Modulated) groove, and a BCA area formed of a straight groove correspond to the lead-out area of the H-format. However, in the H-format, the lead-in area and lead-out area are recorded by a pre-pit system in place of a groove system. The HFM grooves of the first and second layers have a phase lag so as not to cause inter-layer crosstalk.

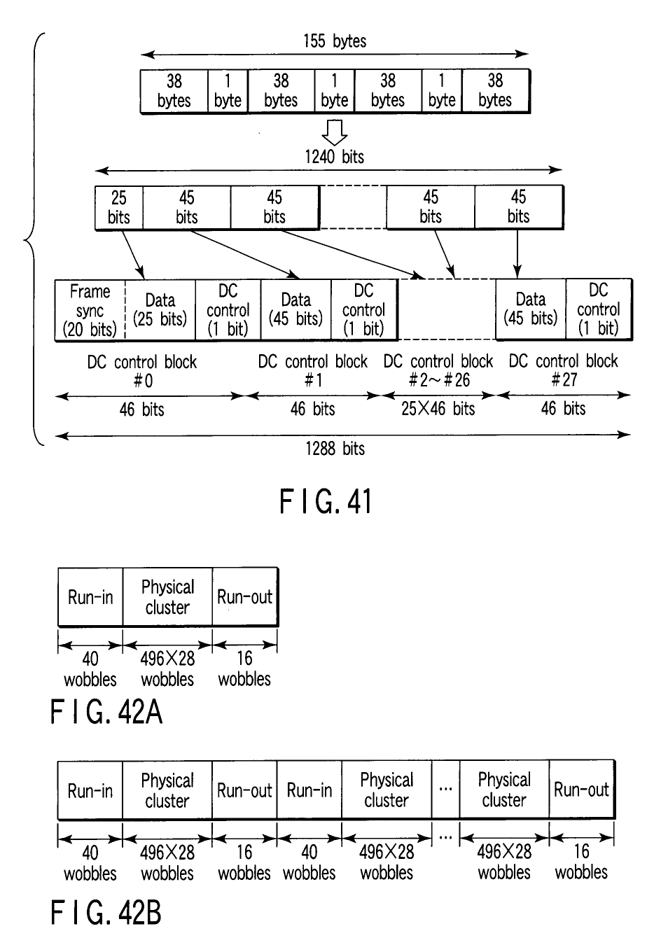

FIG. 41 shows a recording frame. As shown in FIG. 33, user data is recorded every 64 kbytes. Each row of an ECC cluster is converted into a recording frame by appending frame sync bits and DC control bits. A 1240-bit (155-byte) stream of each row is converted as follows. In the 1240-bit stream, 25-bit data is allocated at the head of the stream, and the subsequent stream is divided into 45-bit data. A 20-bit frame sync is appended before the 25-bit data, and one DC control bit is appended after 25-bit data. Likewise, one DC control bit is appended after 45-bit data. A block including the first 25-bit data is defined as DC control block #0, and blocks each including 45-bit data and one DC control bit are defined as DC control blocks #1, #2, . . . , #27. Four hundreds and ninety six recording frames are called a physical cluster.

A recording frame undergoes 1-7PP modulation at a rate of ⅔. A modulation rule is applied to 1268 bits except for the first frame sync to form 1902 channel bits, and a 30-bit frame sync is appended to the head of these channel bits. That is, 1932 channel bits (=28 NMLs) are formed. A channel bit undergoes NRZI modulation, and the modulated bit is recorded on the disc.

Frame Sync Structure

Each physical cluster includes 16 address units. Each address unit includes 31 recording frames. Each recording frame begins with a frame sync of 30 channel bits. The first 24 bits of the frame sync violate a 1-7PP modulation rule (including a runlength twice 9T). The 1-7PP modulation rule executes Parity Preserve/Prohibit PMTR (repeated minimum transition runlength) using a (1, 7) PLL modulation system. “Parity Preserve” makes control of so-called DC (direct current) components of a code (to reduce the DC components of the code). The remaining six bits of the frame sync change to identify one of seven frame syncs FS0, FS1, . . . , FS6. These 6-bit symbols are selected so that a distance associated with a transition amount is 2 or more.

Seven frame syncs allow to obtain detailed position information compared to only 16 address units. Of course, only the seven different frame syncs are not enough to identify 31 recording frames. Therefore, from the 31 recording frames, seven frame sync sequences are selected so that each frame can be identified by a combination of the self frame sync and a frame sync of any of four preceding frames.

FIGS. 42A and 42B show a structure of a recording unit block RUB. A recording unit is called an RUB. As shown in FIG. 42A, the RUB is made up of a data run-in of 40 wobbles, a physical cluster of 496×28 wobbles, and a data run-out of 16 wobbles. The data run-in and data run-out allow data buffering enough to facilitate completely random overwriting. The RUB may be recorded one by one or a plurality of RUBs may be continuously recorded, as shown in FIG. 42B.

The data run-in is mainly made up of a repetition pattern of 3T/3T/2T/2T/5T/5T, and includes two frame syncs (FS4, FS6), which are spaced from each other by 40 cbs as an indicator that indicates the next recording unit block.

The data run-out starts from FS0, which is followed by a pattern of 9T/9T/9T/9T/9T/9T indicating the end of data, and is mainly formed of a repetition pattern of 3T/3T/2T/2T/5T/5T.

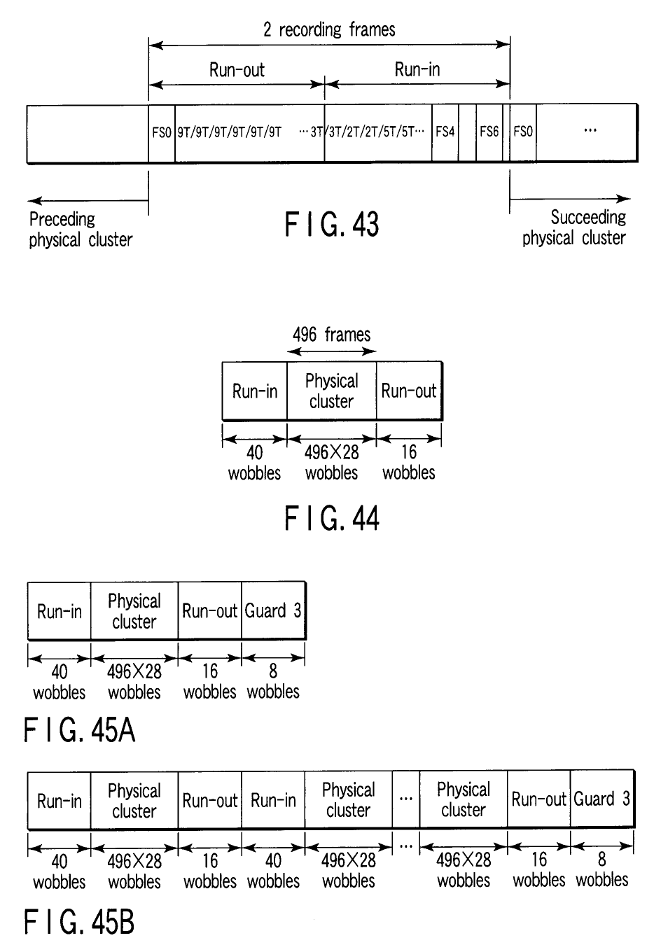

FIG. 43 shows the structure of the data run-in and data run-out.

FIG. 44 shows the data allocation associated with wobble addresses. A physical cluster includes 496 frames. A total of 56 wobbles (NWL) of the data run-in and data run-out are 2×28 wobbles, and amount to two recording frames.

One RUB=496+2=498 recording frames

One ADIP unit=56NMLs=two recording frames

Eighty three ADIP units=one ADIP word(including one ADIP address)

Three ADIP words=3×83ADIP units

Three ADIP words=3×83×2=498recording frames

Upon recording data on a write-once disc, the next data must be continuously recorded after the already recorded data. If a gap is formed between these data, playback is disabled. In order to record (overwrite) the first data run-in area of the succeeding recording frame on the last data run-out area of the preceding recording frame, a guard 3 area is allocated at the last of the data run-out area, as shown in FIG. 45A or 45B. FIG. 45A shows a case wherein only one physical cluster is recorded, and FIG. 45B shows a case wherein a plurality of physical clusters are continuously recorded, and the guard 3 area is allocated after the run-out of the last cluster. Each recording unit block which is recorded solely, or a plurality of recording unit blocks which are recorded continuously are terminated in the guard 3 area. The guard 3 area guarantees that there is no unrecorded area between the two recording unit blocks.

Note that the invention is not limited to the embodiments intact, and it can be embodied by modifying required constituent elements without departing from the scope of the invention when it is practiced. Also, various inventions can be formed by appropriately combining a plurality of required constituent elements disclosed in the respective embodiments. For example, some required constituent elements may be omitted from all required constituent elements disclosed in the respective embodiments. Furthermore, required constituent elements of different embodiments may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording medium in which
a data lead-in area, a data area, and a data lead-out area are allocated in turn from an inner periphery side,
a recording management zone that records recording management data is formed in the data lead-in area, and an extended area of the recording management zone is formed in the data area,
a recording management data duplication zone that manages a position of the extended area of the recording management zone is formed in the data lead-in area,
a laser beam used in recording/playback of information has a wavelength falling within a range from 390 nm to 420 nm (both inclusive),
the medium has, in turn from a light incidence side, a first substrate, a first recording layer, a second substrate, and a second substrate, on each of which grooves and lands of a concentric or spiral shape are formed,
the first recording layer has a first dye layer and a first reflecting layer from the light incidence side, and the second recording layer has a second dye layer and a second reflecting layer from the light incidence side, and
the first dye layer and the second dye layer have light absorbance for the laser beam within the wavelength range,
wherein letting H1 (nm) be a groove depth of the first substrate on which the first recording layer is formed, H2 (nm) be a groove depth of the second substrate on which the second recording layer is formed, H11 (nm) be a thickness of the first dye layer at a land area, H12 (nm) be a thickness of the first dye layer at a groove bottom area, H21 (nm) be a thickness of the second dye layer at a land area, H22 (nm) be a thickness of the second dye layer at a groove bottom area, α be an absolute value of H11−H12, and β be an absolute value of H11−H12,
the groove depth H1 of the first substrate and the groove depth H2 of the second substrate satisfy:

|H11−H12|=α (1)

|H21−H22|=β (2)
λ/8n≦H1−α≦λ/3n (3)
λ/8n≦H2−β≦λ/3n (4)
(λ: a laser beam wavelength, n: a refractive index of the substrate)

2. A medium according to claim 1, wherein the first substrate has a thickness falling within a range from 580 μm to 600 μm (both inclusive).

3. A medium according to claim 1, which further comprises an adhesive layer between the first recording layer and the second recording layer, and in which the adhesive layer has a thickness falling within a range from 20 μm to 35 μm (both inclusive).

4. A medium according to claim 1, wherein a full width at half-maximum of the grooves formed on the first recording layer and the second recording layer falls within a range from 0.1 μm to 0.3 μm (both inclusive).

5. A medium according to claim 1, wherein a reflectance from the first recording layer and a reflectance from the second recording layer fall within a range from 3% to 10% (both inclusive) with respect to the laser beam which has the wavelength within the range.

6. A medium according to claim 5, wherein the reflectance from the second recording layer is 0.8 times to 1.2 times the reflectance from the first recording layer.

7. A medium according to claim 1, wherein recording is made only on a land area on the first recording layer and the second recording layer.

8. A disc apparatus for playing back an information recording medium in which
a data lead-in area, a data area, and a data lead-out area are allocated in turn from an inner periphery side,
a recording management zone that records recording management data is formed in the data lead-in area, and an extended area of the recording management zone is formed in the data area,
a recording management data duplication zone that manages a position of the extended area of the recording management zone is formed in the data lead-in area,
a laser beam used in recording/playback of information has a wavelength falling within a range from 390 nm to 420 nm (both inclusive),
the medium has, in turn from a light incidence side, a first substrate, a first recording layer, a second substrate, and a second substrate, on each of which grooves and lands of a concentric or spiral shape are formed,
the first recording layer has a first dye layer and a first reflecting layer from the light incidence side, and the second recording layer has a second dye layer and a second reflecting layer from the light incidence side, and
the first dye layer and the second dye layer have light absorbance for the laser beam within the wavelength range,
wherein letting H1 (nm) be a groove depth of the first substrate on which the first recording layer is formed, H2 (nm) be a groove depth of the second substrate on which the second recording layer is formed, H11 (nm) be a thickness of the first dye layer at a land area, H12 (nm) be a thickness of the first dye layer at a groove bottom area, H21 (nm) be a thickness of the second dye layer at a land area, H22 (nm) be a thickness of the second dye layer at a groove bottom area, α be an absolute value of H11−H12, and β be an absolute value of H11−H12,
the groove depth H1 of the first substrate and the groove depth H2 of the second substrate satisfy:

|H11−H12|=α (1)

|H21−H22|=β (2)
λ/8n≦H1−α≦λ/3n (3)
λ/8n≦H2−β≦λ/3n (4)
(λ: a laser beam wavelength, n: a refractive index of the substrate)

9. An apparatus according to claim 8, wherein the first substrate has a thickness falling within a range from 580 μm to 600 μm (both inclusive).

10. An apparatus according to claim 8, which further comprises an adhesive layer between the first recording layer and the second recording layer, and in which the adhesive layer has a thickness falling within a range from 20 μm to 35 μm (both inclusive).

11. An apparatus according to claim 8, wherein a full width at half-maximum of the grooves formed on the first recording layer and the second recording layer falls within a range from 0.1 μm to 0.3 μm (both inclusive).

12. An apparatus according to claim 8, wherein a reflectance from the first recording layer and a reflectance from the second recording layer fall within a range from 3% to 10% (both inclusive) with respect to the laser beam which has the wavelength within the range.

13. An apparatus according to claim 12, wherein the reflectance from the second recording layer is 0.8 times to 1.2 times the reflectance from the first recording layer.

14. An apparatus according to claim 8, wherein recording is made only on a land area on the first recording layer and the second recording layer.
